(19) United States
(12) Patent Application Publication
(10) Pub. No.: US 2011/0283919 A1
(43) Pub. Date: Nov. 24, 2011

(54) NOVEL METHOD FOR MATRIX MINERALIZATION

(76) Inventor: Paul A. Price, La Jolla, CA (US)

(21) Appl. No.: 12/994,426

(22) PCT Filed: Jun. 4, 2009
(86) PCT No.: PCT/US09/46311

§ 371 Date: Aug. 4, 2011

Related U.S. Application Data
(60) Provisional application No. 61/059,579, filed on Jun. 6, 2008.

(51) Int. Cl. C09D 189/00; C09D 1/00; B65D 85/00

(52) U.S. Cl. 106/160.1; 206/438; 106/124.1; 106/287.29

(57) ABSTRACT

This invention provides novel methods for making mineralized matrices. In certain embodiments methods are provided for forming a crystalline phase within a defined liquid volume. The methods can involve combining a crystallization inhibitor; a solution that would, in the absence of the inhibitor, form the crystalline phase; and a semi-permeable barrier that excludes the inhibitor but allows the solution containing the constituents of the crystalline phase to enter, whereby a crystalline phase is formed within the liquid volume.

### CROSS-REFERENCE TO RELATED APPLICATIONS

This application claims benefit of and priority to U.S. Ser. No. 61/059,579, filed on Jun. 6, 2008, which is incorporated herein by reference in its entirety for all purposes.

### STATEMENT OF GOVERNMENTAL SUPPORT

This invention was made with government support under National Institutes of Health Grant No: HL58090. The government has certain rights in the invention.

### FIELD OF THE INVENTION

The present invention relates to the field of medicine and in certain embodiments, to methods of tissue engineering. More particularly methods are provided for the controlled mineralization of a matrix material.

### BACKGROUND OF THE INVENTION

The mineral in bone is located primarily within the collagen fibril, and during mineralization the fibril is formed first and then water within the fibril is replaced with mineral. In particular, most present evidence shows that the mineral in bone is located primarily within the type I collagen fibril (Tong et al. (2003) Calcif. Tiss. Internat. 72: 592-598; Katz and Li (1973) J. Mol. Biol. 80:1-15; Sasaki and Sudoh (1996) Calcif Tissue Int 60: 361-367; Jager and Fratzl (2000) Biophys J., 79: 1737-1748; Landis et al. (1993) J. Structural Biol., 110: 39-54; Rubin et al. (2003) Bone 33: 270-282), that the fibril is formed first and then mineralized (Robinson and Elliott (1957) J. Bone Joint Surg. 39A: 167-188; Boivin and Meunier (2002) Calcif. Tissue Int., 70: 503-511), and that mineralization replaces water within the fibril with mineral (Robinson and Elliott (1957) J. Bone Joint Surg. 39A: 167-188; Robinson (1958) Chemical analysis and electron microscopy of bone. In. Bone as a tissue; proceedings of a conference, Oct. 30-31, 1958., McGraw-Hill, New York; Blitz and Pellegrino (1969) J. Bone and Joint Surg. 51-A: 456-466). The collagen fibril therefore plays an important role in mineralization, providing the aqueous compartment in which mineral grows. Little is known however regarding the underlying mechanism of calcification.

### SUMMARY OF THE INVENTION

In certain embodiments methods are provided of forming a crystalline phase within a defined liquid volume. The methods typically involve combining a crystallization inhibitor; a solution that would, in the absence of the inhibitor, form the crystalline phase; and a semi-permeable barrier that excludes the inhibitor but allows the solution containing the constituents of the crystalline phase to enter, whereby a crystalline phase is formed within the liquid volume. In certain embodiments the solution is an aqueous solution. In certain embodiments the solution is a non-aqueous solution. In certain embodiments the solution is supersaturated with respect to the constituents of the crystalline phase. In certain embodiments the formation of the crystalline phase occurs spontaneously in the solution. In certain embodiments the formation of the crystalline phase occurs because the solution contains a catalyst of crystal formation (a ‘nucleator’). In various embodiments the defined volume is a volume of the solution that lies within a semi-permeable matrix. In various embodiments the matrix comprises a gel, a hydrogel, a fiber, a collection of particles (e.g., a fluidized bed of particles), a porous ceramic, a porous plastic, a porous mineral, a porous composite, and the like. In certain embodiments the defined volume is a volume of the solution that lies within a semi-permeable membrane sack. In various embodiments the semi-permeable barrier excludes the crystallization inhibitor based on the size of the inhibitor. In various embodiments the crystalline phase is a conductor, a non-conductor, or a semiconductor. In certain embodiments the crystalline phase absorbs electromagnetic radiation. In certain embodiments the crystalline phase contains calcium and phosphate. In certain embodiments the crystalline phase is an apatite. In certain embodiments the inhibitor prevents crystal growth by forming a complex with crystals of the final crystal phase and/or prevents crystal formation by binding to precursors of the final crystal phase.

In various embodiments methods are provided for mineralizing a matrix. The methods typically involve providing a modified matrix material comprising an interior aqueous compartment accessible to molecules of a size less than about 6 kDa and substantially inaccessible to molecules of a size greater than about 40 kDa; contacting the matrix material with a solution that generates mineral crystals, where the solution also comprises an inhibitor of the growth of crystals in the solution, where the inhibitor is of a size that is substantially excluded from the interior aqueous compartment of the matrix material; whereby crystals within the compartment grow resulting in the mineralization of the matrix material and the formation of a mineralized nanostructure, while crystals outside the compartment are substantially inhibited from growth and crystal formation. In certain embodiments the matrix material comprises a porous ceramic, a type I collagen (e.g., from bone or tendon), a type II collage (e.g., from cartilage), a synthetic collagen (e.g., synthetic type I and/or type II, poly(PHG), collagen-containing poloxamine hydrogel, and the like. In certain embodiments the formation of the crystal nuclei occurs spontaneously in the solution. In certain embodiments the solution comprises a catalyst of crystal formation (a ‘nucleator’). In various embodiments the solution comprises serum. In certain embodiments the solution comprises a high concentration of a mineral (e.g., the solution can be supersaturated with the mineral and/or mineral salt). In certain embodiments the solution comprises mineral crystals that are small enough to penetrate into the interior of the matrix. In certain embodiments the crystals are less than about 6,000 daltons in size. In certain embodiments the solution comprises an apatite and/or apatite salt. In certain embodiments the solution comprises calcium and/or a calcium salt and the mineralizing comprises calcifying the matrix. In certain embodiments the mineralizing comprises forming an apatite in the matrix. In certain embodiments the inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, poly glutamic acid, and poly aspartic acid.

Methods are also provided of preparing a bone graft (or graft for other calcified tissue). The methods typically involve forming a template in the desired shape of the graft from a matrix material, where the matrix material comprises an interior aqueous compartment accessible to small molecules and crystals, but substantially inaccessible to a larger crystallization inhibitor; contacting the template with a solution that generates crystals, where the solution also comprises an inhibitor of the growth of crystals in the solution, where the inhibitor is of a size that is substantially excluded from the interior aqueous compartment; whereby crystals within the compartment grow resulting in the mineralization of the template, while crystals outside the compartment are substantially inhibited from growth and crystal formation. In certain embodiments the matrix material comprises an inner compartment accessible to molecules of a size less than about 6 kDa and substantially inaccessible to molecules of a size greater than about 40 kDa. In certain embodiments the matrix material comprises a porous ceramic, a porous plastic, a type I collagen (e.g., from bone or tendon), a type II collage (e.g., from cartilage), a synthetic collagen (e.g., synthetic type I and/or type II, poly(PHG), collagen-containing poloxamine hydrogel, and the like. In certain embodiments the formation of the crystal nuclei occurs spontaneously in the solution. In certain embodiments the solution comprises a catalyst of crystal formation (a ‘nucleator’). In various embodiments the solution comprises serum. In certain embodiments the solution comprises a high concentration of a mineral (e.g., the solution can be supersaturated with the mineral and/or mineral salt). In certain embodiments the solution comprises mineral crystals that are small enough to penetrate into the interior of the matrix. In certain embodiments the crystals are less than about 6,000 daltons in size. In certain embodiments the solution comprises an apatite and/or apatite salt. In certain embodiments the solution comprises calcium and/or a calcium salt and the mineralizing comprises calcifying the matrix. In certain embodiments the mineralizing comprises forming an apatite in the matrix. In certain embodiments the inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, poly glutamic acid, and poly aspartic acid.

Methods are also provided for modifying a surface. The methods typically involve adsorbing or covalently linking a matrix material to the surface, where the matrix material comprises an interior aqueous compartment accessible to small molecules and crystals, but substantially inaccessible to a larger crystallization inhibitor contacting the matrix material with a solution that generates mineral crystals, where the solution also comprises an inhibitor of the growth of crystals in the solution, where the inhibitor is of a size that is substantially excluded from the interior aqueous compartment of the matrix material; whereby crystals within the compartment grow resulting in the mineralization of the matrix material and the formation of a mineralized layer on said surface, while crystals outside the compartment are substantially inhibited from growth and crystal formation. In certain embodiments the surface is a surface of a dental implant, a bone screw or pin, a bone fixation member, an artificial joint implant, and the like. In certain embodiments the matrix material comprises an inner compartment accessible to molecules of a size less than about 6 kDa and substantially inaccessible to molecules of a size greater than about 40 kDa. In certain embodiments the matrix material comprises a porous ceramic, a porous plastic, a type I collagen (e.g., from bone or tendon), a type II collage (e.g., from cartilage), a synthetic collagen (e.g., synthetic type I and/or type II, poly(PHG), collagen-containing poloxamine hydrogel, and the like. In certain embodiments the formation of the crystal nuclei occurs spontaneously in the solution. In certain embodiments the solution comprises a catalyst of crystal formation (a ‘nucleator’). In various embodiments the solution comprises serum. In certain embodiments the solution comprises a high concentration of a mineral (e.g., the solution can be supersaturated with the mineral and/or mineral salt). In certain embodiments the solution comprises mineral crystals that are small enough to penetrate into the interior of the matrix. In certain embodiments the crystals are less than about 6,000 daltons in size. In certain embodiments the solution comprises an apatite and/or apatite salt. In certain embodiments the solution comprises calcium and/or a calcium salt and the mineralizing comprises calcifying the matrix. In certain embodiments the mineralizing comprises forming an apatite in the matrix. In certain embodiments the inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, poly glutamic acid, and poly aspartic acid.

Methods are also provided for forming a nanoscale structure. The methods typically involve forming a nanoscale feature from a matrix material, where the matrix material comprises an interior aqueous compartment accessible to small molecules and crystals, but substantially inaccessible to a larger crystallization inhibitor; contacting the matrix material with a solution that generates mineral crystals, where the solution also comprises an inhibitor of the growth of crystals in the solution, where the inhibitor is of a size that is substantially excluded from the interior aqueous compartment of the matrix material; whereby crystals within the compartment grow resulting in the mineralization of the matrix material and the formation of a mineralized nanostructure, while crystals outside the compartment are substantially inhibited from growth and crystal formation. In certain embodiments the nanoscale structure is a nanowire, a nanotubes, a nanotorus, a nanocomposite, a nanofiber, a nanofoam, a nanomesh, a nanopillar, a nanopin, a nanoring, a nanorod, a nanoshell, a nanoceramic, a quantum dot, and the like. In certain embodiments forming the nanoscale feature comprises depositing the matrix material through a mask (e.g., a lithographic mask). In certain embodiments forming the nanoscale feature comprises etching matrix material away from a substrate. In certain embodiments the matrix material comprises an inner compartment accessible to molecules of a size less than about 6 kDa and substantially inaccessible to molecules of a size greater than about 40 kDa. In certain embodiments the matrix material comprises a porous ceramic, a porous plastic, a type I collagen (e.g., from bone or tendon), a type II collage (e.g., from cartilage), a synthetic collagen (e.g., synthetic type I and/or type II, poly(PHG), collagen-containing poloxamine hydrogel, and the like. In certain embodiments the formation of the crystal nuclei occurs spontaneously in the solution. In certain embodiments the solution comprises a catalyst of crystal formation (a ‘nucleator’). In various embodiments the solution comprises serum. In certain embodiments the solution comprises a high concentration of a mineral (e.g., the solution can be supersaturated with the mineral and/or mineral salt). In certain embodiments the solution comprises mineral crystals that are small enough to penetrate into the interior of the matrix. In certain embodiments the crystals are less than about 6,000 daltons in size. In certain embodiments the solution comprises an apatite and/or apatite salt. In certain embodiments the solution comprises calcium and/or a calcium salt and the mineralizing comprises calcifying the matrix. In certain embodiments the mineralizing comprises forming an apatite in the matrix. In certain embodiments the inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, poly glutamic acid, and poly aspartic acid.

In various embodiments kits are provided for practicing the methods described herein. In various embodiments the kits comprise a container containing a matrix material; and/or a container containing a crystal growth solution where the crystal growth solution contains a crystal growth inhibitor or the kit comprises another container containing a crystal growth inhibitor. In certain embodiments the matrix material comprises a porous ceramic, a type I collagen (e.g., from bone or tendon), a type II collage (e.g., from cartilage), a synthetic collagen (e.g., synthetic type I and/or type II, poly(PHG), collagen-containing poloxamine hydrogel, and the like. In various embodiments the solution spontaneously forms the mineral crystals and/or the solution comprises a catalyst of crystal formation (a ‘nucleator’). In certain embodiments the solution comprises serum. In certain embodiments comprises a high concentration of a mineral. In certain embodiments the solution comprises an apatite. In certain embodiments the solution comprises calcium and the mineralizing comprises calcifying the matrix. In various embodiments the inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, and/or other crystallization inhibitors. In certain embodiments the kit further comprises instructional materials detailing methods of mineralization by inhibitor exclusion.

### DEFINITIONS

The term “substantially excluded” when used with respect to a matrix material indicates that the concentration of the “excluded” material that enters the matrix is less than 40%, preferably less than about 30%, more preferably less than about 20%, most preferably less than about 10%, less than about 5%, less than about 1% of the concentration of the same material in the surrounding medium. In certain embodiments essentially all of the excluded material is prevented from entering the matrix “interior” compartment.

An “modified matrix material” refers to a material that has been modified by the “hand of man”. Thus, for example a purified collagen derived, for example from bone or tendon, a functionalized naturally occurring collagen, and the like are illustrative modified matrix materials. Modified matrix materials also include matrix materials that may not be purified or functionalized, but at one point were removed from the milieu in which they naturally occurred.

A “nanoscale structure” refers to a structure having a characteristic dimension (e.g., diameter) of less than about 1,000 nm, preferably less than about 800 nm or less than about 500 nm, more preferably less than about 300 nm, 200 nm, or less than about 100 nm or 50 nm.

### BRIEF DESCRIPTION OF THE DRAWINGS

FIG. 1 illustrates the separation of fetuin and glucose by passage over a column packed with purified type I collagen from bovine achilles tendon. Purified type I collagen from bovine achilles tendon (Einbinder and Schubert (1950)J. Biol. Chem., 188: 335-341) (Sigma) was fractionated by size to obtain particles between 0.83 mm and 2.36 mm. 14 g of this collagen was hydrated in 20 mM Tris pH 7.4 containing 2M NaCl, packed into a 2×50 cm column to a final volume of 91 ml, and washed extensively with 20 mM Tris pH 7.4 containing 2M NaCl. A 2 ml volume of equilibration buffer containing 20 mg bovine fetuin and 160,000 cpm of 1-¹⁴C-glucose was applied to the column, and buffer was pumped through the column at a constant flow rate of 6.7 ml/h. The fraction size was approximately 1 ml. The liquid volume in the packed column bed was obtained by subtracting the weight of dry collagen in the column from the wet weight of the packed column bed; the volume inside tendon collagen was estimated by multiplying the liquid content of hydrated tendon collagen, 2.12 ml/g (Table 1), times the weight of collagen in the column, 14 g. (See “Experimental Procedures, Example 1.”)

FIG. 2 illustrates the separation of fetuin and glucose by passage over a column packed with demineralized bovine bone collagen. The demineralized bovine bone sand column described in Table 3 was equilibrated with 20 mM Tris pH 7.4 containing 2M NaCl until the absorbance at 280 nm was <0.01. A 5 ml volume of equilibration buffer containing 50 mg bovine fetuin and 400,000 cpm of 1-¹⁴C-glucose was applied to the column. Flow rate, 18 ml/h; fraction size, 3 ml. The liquid volume in the packed column bed is from Table 5; the volume inside collagen was estimated by multiplying the liquid content of hydrated bone, 1.58 ml/g (Table 4), by the weight of collagen in the column, 51 g (Table 5). (See “Experimental Procedures in Example 1”).

FIG. 3 illustrates the separation of fetuin and glucose by passage over a column packed with non-demineralized bovine bone. The non-demineralized bovine bone sand column characterized in Table 5 was equilibrated at room temperature with 20 mM Tris pH 7.4 containing 2M NaCl. A 5 ml volume of equilibration buffer containing 50 mg bovine fetuin and 400,000 cpm of 1-¹⁴C-glucose was then applied to the column. Flow rate, 18 ml/h; fraction size, 3 ml. The liquid volume in the packed column bed is from Table 5. (See “Experimental Procedures in Example 1”).

FIG. 4 illustrates the effect of hydration on the packing of collagen molecules in the lateral plane of a collagen fibril. The collagen molecules in a cross section (overlap region) of a single collagen fibril are represented by 521 hard disks whose 1.1 nm diameter provides the scale factor of the model. The collagen molecules are arranged in a quasihexagonal lattice, the arrangement of collagen molecules seen in the lateral plane of the collagen fibril (Orgel et al. (2006) Proced. Natl. Acad. Sci. U.S.A. 103(24): 9001-9005). The hydrated fibril has a diameter of 44 nm and is 70% water by volume (Bragg spacing, 1.8 nm; packing fraction, ˜0.7). The dry fibril has a diameter of ˜30 nm (Bragg spacing, 1.1 nm; packing fraction, ˜0.3). The maximum hard disk cross section of albumin, BGP, and glucose are drawn to scale in order illustrate the size difference between molecules that can fully penetrate (BGP and glucose) or not penetrate (albumin) the hydrated fibril. The lower right diagram shows that albumin would interfere with collagen packing far more than BGP; these effects on packing may explain why albumin can't penetrate the fibril while BGP can. The fibril depicted here has the diameter (Tzaphlidou (2005) Micron 36: 593-601) and water content (Table 4) of a typical bone collagen fibril. Since tendon fibrils are 75% water by volume (Table 1), a hydrated tendon fibril with the same number of collagen molecules would have a diameter of 48 nm.

FIG. 5 shows a radioimmunoassay of bovine fetuin, and detection of bovine fetuin antigen in adult bovine serum. Relative fraction of ¹²⁵I labeled bovine fetuin bound to antibody (B/Bₒ) at increasing amounts of purified bovine fetuin, and at increasing volumes of adult bovine serum.

FIG. 6 illustrates the removal of Fetuin from bovine serum by antibody affinity chromatography. In order to prepare fetuin-depleted bovine serum for tests of the role of fetuin in serum-induced mineralization, adult bovine serum was dialyzed against a buffer suitable for calcification (DMEM) and then passed over a column that containing 7 mg of affinity purified rabbit anti bovine fetuin antibody attached covalently to 5 ml of Sepharose 4B. Elution buffer, DMEM; fraction volume, ˜0.8 ml; fetuin concentration was determined by radioimmunoassay (FIG. 5). Inset: Fractions 19-24 were pooled and 10 μg protein from this pool was electrophoresed on a 4-12% SDS polyacrylamide gel and stained with coomassie brilliant blue. Note that the major band is in the 59 kDa position expected for bovine fetuin.

FIG. 7 provides evidence that fetuin is required for the serum-induced re-calcification of demineralized bone: analysis for Ca and P. In order to evaluate the possible role of fetuin in the serum-induced re-calcification of bone, demineralized newborn rat tibias were separately incubated for 6 days at 37° C. in 1 ml DMEM containing 2 mM Pi and: no serum; 10% control bovine serum; 10% fetuin-depleted bovine serum; 10% fetuin depleted bovine serum plus 130 μg/ml of purified bovine fetuin. Tibias were removed, stained with Alizarin red, photographed, and then analyzed for calcium and phosphate. The media and any precipitate were removed from the well, centrifuged to pellet any precipitate, and the pellet fraction was analyzed for calcium and phosphate. This experiment was performed in triplicate. The data show the average calcium and phosphate in the tibia and the pellet fraction from each well; the error bars show the standard deviations. *=Ca or Pi in the extract is less than 0.01 μmol.

FIG. 8 provides evidence that fetuin is required for the serum-induced calcification of demineralized bone: Alizarin red and von Kossa staining. Demineralized newborn rat tibias were separately incubated for 6 days at 37° C. in 1 ml DMEM containing 2 mM Pi and: 10% control bovine serum; 10% fetuin depleted bovine serum; 10% fetuin depleted bovine serum containing 130 μg/ml of purified bovine fetuin. After incubation, the tibias were either stained for calcification with Alizarin red or fixed in ethanol, cut in 5 micron thick sections, stained for calcification with von Kossa (stains calcification black), and counter stained with nuclear-fast red.

FIG. 9 provides evidence that fetuin is required for the serum-induced calcification of rat tail tendon. To test the role of fetuin in the serum-induced calcification of tendon, a type I collagen matrix that does not normally calcify, rat tail tendons (dry weight, 3 mg) were separately incubated for 6 days at 37° C. in 1 ml DMEM containing 2 mM Pi and: no serum; 10% control bovine serum; 10% fetuin-depleted bovine serum; 10% fetuin-depleted bovine serum plus 130 μg/ml of purified bovine fetuin. Tendons were removed, stained with Alizarin red, photographed, and then analyzed for calcium and phosphate. The media and any precipitate were removed from the well, centrifuged to pellet any precipitate, and the pellet fraction was analyzed for calcium and phosphate. This experiment was performed in triplicate. The data show the average calcium and phosphate in the tendons and the pellet fraction from each well; the error bars show the standard deviations. *=Ca or Pi in the extract is less than 0.01 μmol.

FIG. 10 provides evidence that fetuin is required for the serum-induced calcification of purified bovine type I collagen. To assess the role of fetuin in the serum-induced calcification of collagen fibers, 3 mg amounts of purified bovine type I collagen were separately incubated for 6 days at 37° C. in 1 ml DMEM containing 2 mM Pi and: no serum; 10% control bovine serum; 10% fetuin-depleted bovine serum; 10% fetuin-depleted bovine serum plus 130 μg/ml of purified bovine fetuin. Collagen fibers were removed, stained with Alizarin red, photographed, and then analyzed for calcium and phosphate. The media and any precipitate were removed from the well, centrifuged to pellet any precipitate, and the pellet fraction was analyzed for calcium and phosphate. This experiment was performed in triplicate. The data show the average calcium and phosphate in the purified collagen and the pellet fraction from each well; the error bars show the standard deviations. *=Ca or Pi in the extract is less than 0.01 μmol.

FIG. 11 provides evidence that fetuin depletion unmasks a potent serum initiator of mineral formation. To determine whether a calcium phosphate mineral phase forms spontaneously in fetuin-depleted serum even in the absence of a collagen matrix, the following solutions were prepared that contained 1 ml DMEM with 2 mM Pi and: no serum; 10% control bovine serum; 10% fetuin depleted bovine serum; 10% fetuin depleted bovine serum containing 130 μg/ml of purified bovine fetuin. The solutions were incubated for 6 days at 37° C. in the absence of a collagen matrix. The media and any precipitate were removed from the well, centrifuged to pellet any precipitate, and the pellet fraction was analyzed for calcium and phosphate (see Examples for details). This experiment was performed in triplicate. The data show the average calcium and phosphate in the pellet fraction from each well; the error bars show the standard deviations. *=Ca or Pi in the extract is less than 0.01 μmol.

FIG. 12 shows that the powder X-ray diffraction spectrum of the mineral formed in fetuin-depleted serum is comparable to the spectrum of bone mineral. Serum-induced mineral was generated by incubating DMEM containing 10% fetuin-depleted serum at 37° C. (see Experimental Procedures), and bone crystals were prepared as described (Weiner and Price (1986) Calcif. Tiss. Intern. 39: 365-375). The X-ray diffraction spectrum of both powders was determined with a Rigaku Miniflex diffractometer.

FIG. 13 illustrates the re-calcification of bone by using fetuin to selectively inhibit mineral growth outside the collagen fibril: time course of supernatant calcium. The test matrix was a 1 cm segment cut from the midshaft region of a rat tibia and demineralized in EDTA for 72 hours (Price et al. (2004)J. Biol. Chem. 279(18): 19169-19180). The solutions for the calcification test were prepared as described (Price and Lim (2003)J. Biol. Chem. 278(24), 22144-22152) and contained 2 ml HEPES pH 7.4 with 5 mM calcium and phosphate and either 5 mg/ml fetuin or no fetuin. A single demineralized tibia was added immediately after mixing to create the 5 mM conditions and the solutions were mixed end over end at room temperature; there were three tubes per experimental group. Aliquots of each solution were removed at the indicated times and analyzed for calcium; each time point is the average calcium level in the 3 replicate solutions.

FIG. 14 illustrates the re-calcification of bone by using fetuin to selectively inhibit mineral growth outside the collagen fibril: analysis for mineral calcium and phosphate. The experiment described in the legend to FIG. 13 was terminated at 24 h, and the mineral that precipitated outside of the tibia was separated from the tibia. The mineral precipitate and tibia were then both analyzed for calcium and phosphate. The results show the mean and standard deviation of the measurements made on the 3 replicate bone samples at each condition.

FIG. 15 shows evidence that the capacity of bone collagen for mineral is limited. Either 4 mg of demineralized bone sand or an amount of non-demineralized bone sand with the same collagen content (18 mg) was added to a 50 ml volume of 0.2M HEPES pH 7.4 containing 5 mg/ml fetuin, 5 mM calcium, and 5 mM phosphate, and the solution was mixed end over end at room temperature for 2 days. For subsequent re-calcification cycles, the spent solution was replaced with fresh calcification solution and the bone sand was mixed for another 2 days. The bone sand was then analyzed for calcium and phosphate. The results show the mean and standard deviation of the measurements made on the 3 replicate bone samples at each condition.

FIG. 16 shows the Fourier Transform Infrared (FTIR) and powder X-ray diffraction (XRD) spectra of bone that has been re-calcified by using fetuin to selectively inhibit mineral growth outside the collagen fibril. Demineralized bovine bone sand was re-calcified with fetuin as described in the FIG. 15 legend, and samples of the recalcified bone and of nondemineralized bone were each ground to a fine powder. The graph shows the FT-IR spectrum of each sample, and the inset shows the powder X-ray diffraction spectrum. (see example 3 experimental procedures for details).

FIG. 17 shows the dependence of bone collagen calcification on fetuin concentration when homogeneous crystal formation is driven by 5 mM calcium and phosphate. Four mg of demineralized bone sand was added to a 2 ml volume of 0.2 M HEPES pH 7.4 containing 5 mM calcium, 5 mM phosphate, and the indicated concentration of fetuin. The solution was mixed end over end at room temperature for 2 days, and the bone sand was then analyzed for calcium and phosphate. (see Experimental Procedures for details).

FIG. 18 shows evidence that fetuin sustains conditions that calcify bone collagen. Two ml volumes of 0.2M HEPES pH 7.4 were prepared that contained 5 mM calcium, 5 mM phosphate, and 5 mg/ml fetuin. Four mg of demineralized bone sand was added at the indicated times after mixing calcium and phosphate. The solution was then mixed end over end at room temperature for 2 days, and the bone sand was analyzed for calcium and phosphate. The results show the mean and standard deviation of the measurements made on the three replicate bone samples at each condition (see example 3 experimental procedures for details).

FIG. 19 illustrates the calcification of tendon collagen by using fetuin to selectively inhibit mineral growth outside the collagen fibril: analysis for mineral calcium and phosphate. The solutions for the calcification test were prepared as described (Price and Lim (2003) J. Biol. Chem. 278(24), 22144-22152) and contained 2 ml HEPES pH 7.4 with 5 mM calcium and phosphate and either 5 mg/ml fetuin or no fetuin. Hydrated rat tail tendon (4 mg dry weight) was added immediately after mixing to create the 5 mM conditions and the solutions were mixed end over end for 24 h at room temperature; there were three tubes per experimental group. Mineral that precipitated in the solution outside of the tendon was separated from the tendon, and the mineral precipitate and tendon were both analyzed for calcium and phosphate. The results show the mean and standard deviation of the measurements made on the 3 tendon samples at each condition.

FIG. 20 provides scanning electron microscopy that shows that mineral is located within the collagen fibers of tendon that has been calcified using fetuin. The procedure described in the FIG. 15 legend was used to calcify 4 mg of rat tail tendon (dry weight). The calcified collagen was washed with 0.05% KOH, dehydrated in ethanol, and dried. Samples were then sputter coated with an ultra thin layer of gold/palladium and examined with a scanning electron microscope at 20 kV. The bottom two panels show the results of the elemental analysis performed on the 60,000 X field immediately above: carbon is green; calcium is blue; phosphorus is red; and areas containing calcium and phosphorus are purple. (The EDX spectra of these 60,000 X fields are shown in FIG. 26) Bars are 20 μm for the top image, and 1 μm for the bottom 4.

FIG. 21 shows the calcification of Sephadex G25 by using fetuin to selectively inhibit mineral growth outside the gel beads: time course of supernatant calcium. The solutions prepared for the calcification test contained 2 ml HEPES pH 7.4 with 5 mM calcium and phosphate and: fetuin only; Sephadex G25 only; fetuin plus Sephadex G25; and fetuin plus Sephadex G75. Each solution was placed into a 10×75 mm tube and mixed end over end at room temperature; there were three tubes per experimental group. Aliquots of each solution were removed at the indicated times and analyzed for calcium; each time point is the average calcium level in the 3 replicate solutions.

FIG. 22 shows the calcification of Sephadex G25 by using fetuin to selectively inhibit mineral growth outside the gel beads: analysis for mineral calcium and phosphate. The experiment described in the FIG. 19 legend was terminated at 24 h, the mineral that precipitated outside of the Sephadex was separated from the Sephadex using a 20 micron sieve, and the mineral precipitate and Sephadex were both analyzed for calcium and phosphate. The results show the mean and standard deviation of the measurements made on the 3 replicate Sephadex samples tested at each condition.

FIG. 23 illustrates the dependence of collagen calcification on fetuin concentration when homogeneous crystal formation is driven by 4 mM calcium and phosphate. Four mg of demineralized bone sand was added to a 2 ml volume of 0.2M HEPES pH 7.4 containing 4 mM calcium, 4 mM phosphate, and the indicated concentration of fetuin. The solution was mixed end over end at room temperature for 3 days, and the bone sand was then analyzed for calcium and phosphate. (see Experimental Procedures for details).

FIG. 24 shows a comparison of the ability of high molecular weight inhibitors of mineral formation to re-calcify bone by selectively inhibiting mineral growth outside the collagen fibril. Four mg of demineralized bone sand was added to a 2 ml volume of 0.2M HEPES pH 7.4 containing 5 mM calcium, 5 mM phosphate, and a 1 mg/ml concentration of fetuin, chondroitin sulfate (MW<100 kDa), poly-L-glutamic acid (MW<50 kDa), or bone Gla protein (BGP; MW˜6 kDa). The solution was mixed end over end at room temperature for 2 days, and the bone sand was then analyzed for calcium and phosphate. (see example 3 experimental procedures for details).

FIG. 25 shows the calcification of tendon collagen by using fetuin to selectively inhibit mineral growth outside the collagen fibril: Alizarin red and von Kossa staining. Rat tail tendons were calcified as described in the FIG. 19 legend. In brief, the calcification solutions contained 2 ml HEPES pH 7.4 with 5 mM calcium and phosphate and either 5 mg/ml fetuin or no fetuin. Hydrated rat tail tendon (4 mg dry weight) was added immediately after mixing to create the 5 mM conditions and the solutions were mixed end over end for 24 h at room temperature. Tendons were then either stained with Alizarin red or cut in 5 micron sections and stained by von Kossa (stains mineral dark brown). Note that the amount of calcium and phosphate in the 2 ml volume of calcifying solution used in this experiment is only sufficient to introduce a limited amount of mineral into tendon (about 4% of the amount introduced into tendon for the scanning electron microscope analysis shown in FIG. 20).

FIG. 26 shows Electron Dispersive X-Ray (EDX) spectra that demonstrate that calcium and phosphate are in the collagen fibers of tendon that has been calcified using fetuin. These EDX spectra were determined on the same fields shown in the bottom two panels of FIG. 8. The peak heights were normalized to Palladium.

FIG. 27 illustrates a poly(PHG) a synthetic collagen.

### DETAILED DESCRIPTION

This invention provides novel methods for controlled mineralization of a matrix on the basis of its size-exclusion properties. In various embodiments, methods are provided that use crystallization inhibitors in combination with a matrix with size exclusion properties to exclude the crystallization inhibitor to direct mineralization of the matrix. For example, in certain embodiments, the methods utilize fetuin (a crystallization inhibitor) to direct calcification of any matrix with size-exclusion properties similar to collagen. This method is referred to as “mineralization by inhibitor exclusion”.

As shown in Example 1 the role of inhibitors of calcification in mineralizing collagen was explored. Specifically, this work showed that the water within a collagen fibril was accessible to molecules as large as 6 kDa and inaccessible to molecules larger than 40 kDa. As shown in Example 2 it was discovered that the presence or absence of fetuin (48 kDa inhibitor of mineralization) determined whether mineral growth would occur inside the fibrils (fetuin present in medium) or outside the fibrils (fetuin depleted). Inventor asserts that this confirms the hypothesis of the first paper (that inhibition of calcification is relevant for mineralization of collagen).

As described in Example 3, herein, it was ultimately determined that serum-induced calcification requires 3 elements: 1) a matrix with an interior aqueous compartment that is accessible to small molecules but not large; 2) a molecule (or other method) that generates small crystal nuclei outside of the matrix—some of which diffuse into the matrix; and 3) a large molecule (e.g., a molecule substantially excluded from the matrix by size) (e.g. fetuin) that inhibits the growth of those crystal nuclei remaining in solution outside the matrix. In the presence of these elements, crystals form throughout the solution but only those that diffuse into the matrix grow.

In view of these discoveries, general methods of controlling mineralization of a matrix are provided. The methods involve combining a crystallization inhibitor, a solution that would, in the absence of the inhibitor, form the crystalline phase (or that already contains crystals small enough to enter the matrix); and a semi-permeable barrier (e.g., a matrix) that excludes the inhibitor but allows the solution containing the constituents of the crystalline phase and/or the crystals to enter, whereby a crystalline phase is formed within the liquid volume in the matrix.

In one illustrative embodiment, a matrix (e.g., collagen matrix) is provided in serum or a saturated or supersaturated solution of calcium or apatite salt, and an inhibitor that cannot substantially enter the collagen matrix (e.g., fetuin) whereby calcium or apatite mineral growth occurs in the collagen matrix, but not substantially outside of the matrix.

In certain illustrative embodiments, a matrix (e.g., a collcagen matrix) is provided in a solution that contains crystals small enough to enter the matrix material. In certain embodiments the crystals are less than botu 6,000 daltons, in certain embodiments, less than botu 5,000 daltons, and in certain embodiments, less than about 4,000 or 3,000 daltons.

The methods have a wide number of applications. For example, for medical applications, bones and teeth are the obvious substrates for application of the technology. In certain embodiments less soluble minerals (e.g., fluorapatite) might prolong implant life or that agents that promote growth or inhibit dissolution could be incorporated during re-calcification in order to enhance implant function.

Other uses involve forming a mineral coating on a prosthetic implant, creating bone grafts, and the like.

In certain embodiments the methods can be used to fabricate mineralized nano structures.

In various embodiments the methods provide materials for ligament, tendon muscular, orthopaedic, dermal, dental or cardiovascular repair with the morphological and bio-mechanical characteristics of the naturally occurring tissue.

### Matrix Materials.

Essentially any matrix material can be used as long as it maintains size exclusion properties that permit exclusion of the crystallization inhibitor(s) while permitting entry of the crystal nuclei and/or materials necessary for crystal formation and growth. Various matrix materials include, but are not limited to gels, fibers, particulates, and the like. In various embodiments the matrix material substantially admits molecules of less than about 15 kDA, preferably less than about 10 kDa, more preferably about 6 kDa or less. In various embodiments the matrix material substantially excludes molecules of greater than about 20 kDA, preferably of greater than about 30 kDa, and more preferably of about 40 kDa or above.

One suitable matrix material is collagen, especially type I collagen that is naturally occurring, purified, recombinantly expressed, or synthetic. Synthetic collagen strands have been created by making short triple collagen strands with a short peptide segment sticking out the top, acting as a ‘sticky-end’ to join the strands together. The synthetic strands naturally join together to form fibers as thick as natural collagen (0.5-1.0 nm) and up to 400 nm long (see, e.g., Kotch and Raines (2006) Proc. Natl. Acad. Sci., USA, 103: 3028-3033, which is incorporated herein by reference. The technique can be applied to other short strands, e.g., as described below, to create “modified” synthetic collagen fibers that are stronger than natural versions.

Illustrative collagen mimics suitable as matrix materials in the present methods are described, for example in U.S. Patent Publication No: 2007/0275897, which is incorporated herein by reference. Such mimics include for example, polymers of tripeptides where the tripeptides have the formula: (Xaa-Yaa-Gly)ₙ, where Xaa is a proline or proline derivative, where Yaa is a proline or proline derivative, where the proline derivative is a 4-substituted proline residue including any bulky and non-electron withdrawing or electron donating substituent, and where the substituent is capable of stabilizing through steric hinderance effects the collagen mimic relative to a native collagen, and n is a positive integer. In certain embodiments, Xaa is a (2S,4R)-4-alkyl proline or a (2S,4R)-4-thioproline, and an electronegative atom including N, O, F, Cl, or Br is not installed directly on C4 of the proline ring.

Illustrative mimics include, but are not limited to (Pro-Mep-Gly)ₙ, (mep-Pro-Gly)ₙ and (mep-Mep-Gly)ₙ, flp-Mep-Gly, mpe-Flp-Gly, (thp-Thp-Gly)ₙ, (thp-Mep-Gly)ₙ, (mep-Thp-Gly)ₙ, (Pro-Thp-Gly)ₙ, (thp-Pro-Gly)ₙ, (thp-Hyp-Gly)ₙ, (flp-Thp-Gly)ₙ, and (thp-Flp-Gly)ₙ, and the like, where n is greater than 1, preferably greater than 3, more preferably greater than 6, 7, 10, 20, 30, 50, 80, or 100, flp is (2S,4S)-4-fluoroproline, Flp is (2S,4R)-4-fluoroproline, mep is 2S,4R)-4-methylproline, Mep is (2S,4S)-4-methylproline, thp” refers to (2S,4R)-thioproline, and ‘Thp” is (2S,4S)-thioproline.

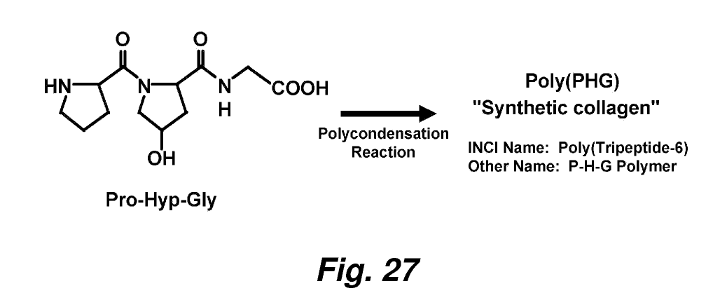

Another illustrative synthetic collagen is poly(PHG) (see, e.g., FIG. 27), which is commercially available from Chisso Corp., Japan.

Other illustrative matrix materials include, but are not limited to collagen-containing poloxamine hydrogels. These can be produced for example by functionalization of a four-arm PEO-PPO block copolymer (poloxamine, Tetronic™) with methcrylate groups and subsequent free radical polymerization of water solutions of the modified polymer in the presence of collagen (see, e.g., Sosnik and Sefton (2005) Biomaterials, 26: 7425-7435).

Bacterial and plant cell walls can also provide suitable matrix materials. Thus, for example, using the methods described herein with Staphylococcus Aureus cell walls as the matrix material, rigid mineralized structures having the dimensions of the original bacteria (˜1000 nm diameter) were formed.

The foregoing matrix materials are illustrative and not intended to be limiting. Essentially any matrix material can be used as long as it possesses the size exclusion properties described herein. Thus for example, SEPHADEX® beads are used as a model matrix material in the Examples described herein.

### Minerals

Essentially any mineral, salt, etc., that can enter the matrix material and grow a crystal in the medium provided is suitable for the methods of this invention. In various embodiments the mineral comprises calcium and/or phosphate. In various embodiments the crystal or salt is an apatite crystal or salt. Suitable apatites include, but are not limited to hydroxylapatite, fluorapatite, and chlorapatite, named for high concentrations of OH⁻, F⁻, or Cl⁻ ions, respectively, in the crystal. The formula of the admixture of the three most common endmembers is written as Ca₅(PO₄)₃(OH, F, Cl), and the formulae of these individual minerals are typically written as Ca₅(PO₄)₃(OH), Ca₅(PO₄)₃F and Ca₅(PO₄)₃Cl, respectively. Other suitable mineral salts include, but are not limited to carbonate apatite, strontium phosphate, strontium apatite, and calcium carbonate.

These minerals are illustrative and not limiting. Other minerals include, but are not limited to, for example, conducting and/or semiconducting and/or electromagnetic radiation-absorbing crystal materials. Other suitable minerals/salts will be readily recognized by one of skill in the art.

In certain embodiments, the minerals are provided in a solution. In certain embodiments the minerals can be provided as a supersaturated solution where in the absence of inhibitors the minerals crystallize or where the solution can be put under conditions in which the minerals crystallize. In certain embodiments the minerals are provided as crystals, e.g., in the solution. Preferably the crystals when present are small enough to enter the matrix. In certain embodiments such crystals are typically less than about 6,000 daltons. In certain embodiments such crystals are typically less than about 5,000 or 4,000 daltons. In certain embodiments such crystals are typically less than about 3,000 or 2,000 daltons.

Essentially any inhibitor of crystal nucleation and/or growth can be used in the methods described herein, as long as the inhibitor is sufficiently large that it is substantially excluded from the “interior” compartment of the matrix material. One illustrative inhibitor is fetuin, or a fetuin fragment of sufficient length to provide the inhibitor activity described herein. Fetuin analogues with similar activity are also suitable. Other suitable inhibitors include, but are not limited to, osteopontin, an osteopontin fragment or analogue, Tamm-Horsfall protein, Tam-Horsfall protein fragment or analogue, asprich mollusk shell protein (see, e.g., (Politi et al. (2007) Cryst. Engin. Comm., 9: 1171-1177), asprich mollusk shell protein or analogue, matrix-GLA protein, a matrix-GLA protein analogue, poly glutamic acid, and poly aspartic acid. Suitable fragments of such proteins are of sufficient length to provide the inhibitor activity described herein. Similarly mutants of these proteins having the inhibitor activity described herein are also suitable.

The foregoing inhibitors are illustrative and not intended to be limiting. Essentially any inhibitor can be used as long as it is substantially excluded from the matrix.

In this regard, it is noted that the discussion provided herein is based on size exclusion. However, exclusion of the inhibitor based on other properties (e.g., charge, hydrophobicity, etc.) can be similarly effective as long as the crystal nuclei and any reagents necessary for crystal growth are not substantially excluded.

### Tissue Engineering.

In various embodiments the methods described herein can be used in tissue engineering to provide, for example bone grafts, or other calcified tissues as might be required for ligament, tendon muscular, orthopaedic, dermal, dental or cardiovascular repair with the morphological and bio-mechanical characteristics of the naturally occurring tissue.

Typically a matrix material, e.g., a collagen is shaped into the desired shape (e.g., the shape of a replacement piece of bone (bone graft)). Then the matrix is mineralized (e.g., calcified) as described herein to form the desired mineralized structure.

Other mineralized structures can similarly be prepared. Any of them can be mineralized with the mineral typically found in nature (e.g., an apatite) or they can be mineralized with a non-naturally occurring mineral to provide additional desired properties (e.g., increased strength, hardness, durability, etc.). The process can also be used to incorporate cytokines, growth factors (e.g., BMP), and the like.

### Modified Materials and Nanoengineering.

The methods described herein can also be used in materials fabrication to make various modified devices and/or nano-scale devices. For example surfaces of devices for implantation in a subject can be mineralized to provide improved biocompatibility.

This is readily accomplished by adsorbing or covalently linking the matrix material (e.g., collagen) to the surface that is to be mineralized, and then mineralizing the matrix according to the methods described herein.

Means of covalently linking matrix materials to surfaces are well known to those of skill in the art. Where the matrix material contains naturally-occurring reactive species (e.g., —SH, —OH, —COOH, NH₂) the matrix can simply be reacted and bound to the surface itself or the surface can be functionalized to react with the species. Thus, for example, —SH will form covalent linkages with gold surfaces. Where the matrix material lacks reactive species, or simply where desired, the matrix material can also be functionalized to provide essentially any desired reactive species. In certain embodiments the matrix can be attached to the surface with a linker (e.g., a hetero- or homo-bifunctional linker).

Illustrative surfaces include, but are not limited to surfaces of bone screws, surfaces of bone pins or other fixation devices, surfaces of artificial joints, tooth implants, and the like.

The methods of this invention can also be used to form mineralized nanoscale structures. The structures are first formed by providing a matrix material of the desired size and shape. This is readily accomplished by methods well known to those of skill in the art. Such methods include, for example, depositing the matrix material through a mask (e.g., a lithographic mask), or depositing the matrix material and then etching away the undesired material using for example standard lithographic manufacturing techniques used in the electronic industry. The appropriately shaped matrix is then mineralized according to the methods described herein to form the desired nanoscale structure.

Where the mineralized structure is electrically conductive, the method can be used to form nanoscale wires and the like. Where the mineralized structure is semi-conductive the methods can be used to manufacture nanoscale semiconductors including, but not limited to transistors, diodes, and the like. The method can also be used to form quantum dots and the like.

### Kits.

In certain embodiments kits are provided for practice of the methods described herein. The kits typically comprise one or more containers containing the reagents for practicing the methods. Thus for example the container(s) can contain a matrix material, a crystal growth solution, a crystal growth inhibitor, and the like. The growth inhibitor can be provided in the crystal growth solution or can be provided in a separate container.

In addition, the kits optionally include labeling and/or instructional materials providing directions (i.e., protocols) for the practice of the methods described herein (e.g., methods of mineralization by inhibitor exclusion).

While the instructional materials typically comprise written or printed materials they are not limited to such. Any medium capable of storing such instructions and communicating them to an end user is contemplated by this invention. Such media include, but are not limited to electronic storage media (e.g., magnetic discs, tapes, cartridges, chips), optical media (e.g., CD ROM), and the like. Such media may include addresses to internet sites that provide such instructional materials.

### EXAMPLES

The following examples are offered to illustrate, but not to limit the claimed invention.

### Example 1

### The Size Exclusion Characteristics of Type I Collagen: Implications for the Role of Non-Collagenous Bone Constituents in Mineralization

The mineral in bone is located primarily within the collagen fibril, and during mineralization the fibril is formed first and then water within the fibril is replaced with mineral. The collagen fibril therefore provides the aqueous compartment in which mineral grows. Although knowledge of the size of molecules that can diffuse into the fibril to affect crystal growth is critical to understanding the mechanism of bone mineralization, there have been as yet no studies on the size-exclusion properties of the collagen fibril.

To determine the size-exclusion characteristics of collagen, we developed a gel filtration-like procedure that uses columns containing collagen from tendon and bone. The elution volumes of test molecules show the volume within the packed column that is accessible to the test molecules, and therefore reveal the size exclusion characteristics of the collagen within the column. These experiments show that molecules smaller than a 6 kDa protein diffuse into all of the water within the collagen fibril, while molecules larger than a 40 kDa protein are excluded from this water.

These studies provide an insight into the mechanism of bone mineralization. Molecules and apatite crystals smaller than a 6 kDa protein can diffuse into all water within the fibril and so can directly impact mineralization. Although molecules larger than a 40 kDa protein are excluded from the fibril, they can initiate mineralization by forming small apatite crystal nuclei that diffuse into the fibril, or can favor fibril mineralization by inhibiting apatite growth everywhere but within the fibril.

Most present evidence shows that the mineral in bone is located primarily within the type I collagen fibril (Tong et al. (2003) Calcif. Tiss. Internat. 72: 592-598; Katz and Li (1973) J. Mol. Biol. 80:1-15; Sasaki and Sudoh (1996) Calcif Tissue Int 60: 361-367; Jager and Fratzl (2000) Biophys J., 79: 1737-1748; Landis et al. (1993) J. Structural Biol. 110: 39-54; Rubin et al. (2003) Bone 33: 270-282), that the fibril is formed first and then mineralized (Robinson and Elliott (1957) J. Bone and Joint Surg. 39A: 167-188; Boivin and Meunier (2002) Calcif Tissue Int 70: 503-511), and that mineralization replaces water within the fibril with mineral (Robinson and Elliott (1957) J. Bone and Joint Surg. 39A: 167-188; Robinson (1958) Chemical analysis and electron microscopy of bone. In. Bone as a tissue; proceedings of a conference, Oct. 30-31, 1958., McGraw-Hill, New York; Blitz and Pellegrino (1969) J. Bone and Joint Surg. 51-A: 456-466). The collagen fibril therefore plays an important role in mineralization, providing the aqueous compartment in which mineral grows. Our working hypothesis is that the physical structure of the collagen fibril may also play a critical additional role in mineralization: the role of a gatekeeper that determines the size of the molecules that can penetrate the fibril to affect apatite crystal growth. The present experiments were carried out to test this hypothesis.

The physical structure of the type I collagen fibril can be viewed in two dimensions, the axial (or longitudinal) and lateral (or equatorial). The fibril is composed of collagen molecules, each 1.1×300 nm in size and formed by the association of two alpha 1 and one alpha 2 polypeptide chains to create a rope-like triple helical structure. The fibril assembles by the non-covalent association of collagen molecules, each offset by 67 nm with respect to its lateral neighbors (Ottani et al. (2002) Micron 33: 587-596; Wess (2005) Adv. Protein Chem. 70: 341-374; Hodge and Petruska (1963) Recent studies with the electron microscope on ordered aggregates of the tropocollagen molecule, Academic Press, New York). An axial repeat is 5×67=335 nm in length, which is longer than the 300 nm collagen molecule. This difference results in a 35 nm ‘gap’ between each collagen molecule and its nearest axial neighbors, and is responsible for the fact that the fibril has alternating differences in electron density (Hodge and Petruska (1963) Recent studies with the electron microscope on ordered aggregates of the tropocollagen molecule, Academic Press, New York) and diameter (Gutsmann et al. (2003) Biophys J 84: 2593-2598; Revenko et al. (1994) Biol Cell 80: 67-69) with a 67 nm repeat that corresponds to the gap and overlap regions of the fibril. The lateral structure of the collagen fibril consists of collagen molecules arranged in a quasihexagonal lattice (Wess (2005) Adv. Protein Chem. 70: 341-374; Fraser et al. (1983) J. Mol. Biol. 167: 497-521; Holmes et al. (2001) Proc. Natl. Acad. Sci. USA 98: 7307-7312; Hulmes and Miller (1979) Nature 282: 878-880; Lees et al. (1984) Int. J. Biol. Macromolecules 6, 133-136; Orgel et al. (2006) Proc. Natl. Acad. Sci., USA, 103(24): 9001-9005; Orgel et al. (2001) Structure 9: 1061-1069; Piez et al. (1981) Bioscience Reports 1: 801-810). The final fibril can be from 20 to 400 nm in diameter (Moeller et al. (1995) J. Anat 187: 161-167; Parry (1984) Growth and Development of Collagen Fibers in Connective Tissues) and is stabilized by four covalent cross links per collagen molecule, two at either end of the molecule (Reiser et al. (1992) FASEB 6: 2439-2449; Knott and Bailey (1998) Bone 22: 181-187).

A “microfibril” is thought to be the basic building block of the collagen fibril (Wess (2005) Adv. Protein Chem. 70: 341-374; Holmes et al. (2001) Proc. Natl. Acad. Sci., USA, 98: 7307-7312; Orgel et al. (2006) Proced. Natl. Acad. Sci. U.S.A. 103(24): 9001-9005; Orgel et al. (2001) Structure 9: 1061-1069; Piez and Trus (1981) Bioscience Reports 1: 801-810; Raspanti et al. (1989) Int. J. Biol. Macromol. 11: 367-371), but the relationship of the microfibril structure to the molecular packing of collagen molecules in the fibril is sometimes unclear (see Orgel et al. (2006) Proced. Natl. Acad. Sci. U.S.A. 103(24): 9001-9005 for references). A recent fiber x-ray crystallographic determination of the collagen type I supermolecular structure has clarified the role of the microfibril in collagen structure by examining for the first time the detailed packing arrangement of collagen molecules from their N- to C-termini (Orgel et al. (2006) Proced. Natl. Acad. Sci. U.S.A. 103(24): 9001-9005). This study shows that each collagen molecule associates with its packing neighbors to form a super-twisted, right-handed, pentameric microfibril that interdigitates with neighboring microfibrils.

At physiological levels of hydration, the type I collagen fiber is about 30% collagen and 70% water by volume (see Knott and Bailey (1998) Bone 22: 181-187 and references therein). Micro CT measurements have shown convincingly that the progressive hydration of a collagen fiber increases the diameter of the fiber but not its length. This observation shows that hydration affects the lateral structure of the fiber, but not the axial structure (Id.). X ray structural analyses support this conclusion. Hydration has no measurable impact on the axial structure of the fibril, which has the same 67 nm periodicity in dry and fully hydrated collagen fibrils (Raspanti et al. (1989) Int. J. Biol. Macromol. 11: 367-371). In contrast, hydration progressively increases the Bragg spacing between adjacent collagen molecules in the lateral plane, from 1.1 nm in the dry fibril to 1.8 nm when the fibril is fully hydrated (Fullerton and Amurao (2006) Cell Biology nNternational 30: 56-65). In the lateral plane, each collagen molecule is therefore separated from its neighbors by a water layer 6 to 7 Å thick (Knott and Bailey (1998) Bone 22: 181-187).

We have recently shown that the chemically identical type 1 collagen fibrils of tendon and demineralized bone calcify when incubated in rat or bovine serum for 6 days at 37° C. (Price et al. (1997) Int J Biol Macromol 20: 23-33; Fratzl et al. (1993) Biophys J 64: 260-26; Hamlin and Price (2004) Calcif. Tiss. Internat. 75: 231-242; Price et al. (2004) J. Biol. Chem. 279(18): 19169-19180; Jahnen-Dechent et al. (1997) J. Biol. Chem. 272: 31496-315036). Among the more puzzling aspects of the serum induced calcification of collagen fibrils is that calcification occurs in spite of the presence of potent serum calcification inhibitors, the best characterized and most abundant of which is fetuin (Id.). A possible explanation for this observation is that fetuin (and other large calcification inhibitors) may not be able to penetrate into the interior of the type I collagen fibril where serum-initiated calcification occurs (Fratzl et al. (1993) Biophys J 64: 260-266). Our general working hypothesis is that the physical structure of the collagen fibril determines the size of the molecules that can diffuse into the water that lies within the fibril and thereby affect apatite crystal growth.

In the course of evaluating our working hypothesis, we became aware that there is no experimental evidence that shows what types of molecules can and cannot penetrate the type I collagen fibril. We accordingly developed the first experimental technique that can be used to investigate the size exclusion characteristics of the collagen fibril. This novel, gel filtration-like procedure uses columns packed with type I collagen from different bovine tissues. The elution volumes of the test molecules show the volume within the packed column that is accessible to the test molecules, and therefore reveal the size exclusion characteristics of the collagen in the column.

The results of these experiments provide the first experimental evidence that the collagen fibril has size exclusion characteristics. Small molecules such as bone Gla protein (BGP; a 5.7 kDa vitamin K-dependent protein also called osteocalcin), calcium, phosphate, citrate, pyrophosphate, and etidronate have free access to the aqueous compartment within the collagen fibril where mineral is deposited, while macromolecules such as fetuin (48 kDa), albumin (66 kDa), and dextran (≧5,000 kDa) are excluded from this aqueous compartment.

The size exclusion characteristics of collagen defined in this study reveal some of the ways that molecules of different size might function in bone mineralization (see Discussion). The other examples show how the size exclusion characteristics of collagen explain the observed effects of fetuin depletion on serum-induced collagen mineralization.

### Experimental Procedures

Materials.

Purified type I collagen from bovine Achilles tendon, bovine serum albumin, bovine fetuin, ovalbumin, rabbit immunoglobulin, soy bean trypsin inhibitor, cytochrome c, low molecular weight dextran, anthrone, and heptaose were purchased from Sigma. Methemoglobin and riboflavin were obtained from Calbiochem; and high molecular weight dextran, and 1-¹⁴C-glucose were obtained from ICN. BGP was purified from bovine bone as described (Price and Lim (2003) J. Biol. Chem. 278(24): 22144-22152).

Determination of Water Content of Bovine Achilles Tendon.

Bovine achilles tendon fibers were dissected from a steer, thoroughly cleaned of all adhering non-collagenous tissue, and separated into two approximately equal masses. Both masses of tendon fibers were treated to remove non-collagenous constituents as described (Schinke et al. (1996) J. Biol. Chem. 271: 20789-20796) and then dried in a lyophilizer at ≦50 milli Torr and weighed. The purified collagen fibers were rehydrated overnight at room temperature in 20 mM Tris pH 7.4 containing 2M NaCl, briefly blotted with a paper towel to remove excess liquid, and immediately weighed. This procedure was repeated twice, with a 20 minute equilibration in 20 mM Tris pH 7.4 containing 2M NaCl between measurements. Liquid weight in the fibers is determined by subtracting the dry weight from the wet weight; liquid volume in the fibers is the liquid weight divided by 1.07 g/cc, the buffer density.

Gel Filtration Procedures: Tendon Collagen.

Purified type I collagen from bovine achilles tendon (Sigma) was fractionated by size to obtain particles between 0.833 mm and 2.36 mm. 14 g of this collagen was hydrated, degassed under vacuum, and packed into a 2×50 cm column to a final volume of 91 ml. The column was then washed extensively with a 20 mM Tris pH 7.4 equilibration buffer that contained 2M NaCl in order to minimize non-specific ionic interactions between test molecules and the collagen matrix; the final effluent absorbance at 280 nm was less than 0.01. Samples were dissolved in 2 ml of equilibration buffer containing about 160,000 cpm of 1-¹⁴C-glucose as an internal reference; the load was 20 mg of albumin or fetuin, 10 mg of bone Gla protein, or 30 mM phosphate. A constant flow rate of 6.7 ml/h was maintained using a Fisher Variable Speed Peristaltic Pump, and the fraction size was approximately 1 ml. The true volume of each effluent fraction was determined from the weight of the fraction contents and the density of the column buffer (1.07 g/ml). The elution position of test substances was determined as follows: proteins, absorbance at 280 nm; 1-¹⁴C-glucose, liquid scintillation counting; phosphate, as described (Price et al. (1976) Proc. Natl. Acad. Sci., USA, 73: 1447-1451).

Effect of Demineralization on the Shape, Mineral Volume, and Water Volume in Bovine Bone Segments.

To obtain the data shown in Table 3, a cylindrical bone segment was cut from the midshaft of a two-year-old steer's femur and cleaned of marrow and non-mineralized connective tissue. The mean length, thickness, and wet weight of the resulting bone ring were measured, and the ring was freeze dried and weighed. The ring was then demineralized in 840 ml of 0.6 N HCl at room temperature; the 0.6 N HCl was replaced with fresh solution daily. The wet weight, physical properties of the ring, and the calcium and phosphate released into the demineralization solution were determined periodically in order to monitor the progress of demineralization. The demineralized bone ring was photographed and X rayed. The bone ring was extensively washed with water, its mean length and thickness were determined and its wet and dry weights were measured.

To determine the volume of water within the collagen of demineralized bone (Table 4), two cylindrical steer bone segments were demineralized as described above. Three equilibration solutions were tested: water, 20 mM Tris pH 7.4 with 0.15M NaCl (density, 1.016 g/ml), and 20 mM Tris pH 7.4 with 2 M NaCl (density, 1.07 g/ml). For each solution, the bone wet weight was measured three times with a two hour equilibration in the solution between measurements and the length and thickness of each segment was determined. Bone was then washed in 50 mM HCl and lyophilized to determine dry weight. The volume of each liquid in bone was determined using the difference between the wet and dry weights, and the liquid densities.

Preparation of Columns Packed with Demineralized and Non-Demineralized Bovine Bone.

To obtain the data shown in Table 5, bovine bone sand with a median diameter of 0.5 mm was prepared from the midshaft of tibias from 2-year-old steers as described (Einbinder and Schubert (1950) J. Biol. Chem., 188: 335-341) and divided into two portions of 242 g each. One portion was demineralized with a 10-fold excess of 10% (v/v) formic acid for 72 h at 4° C., washed with water and dried; the final dry weight was 51 g. High temperature ashing of this acid-extracted bone sand demonstrated that these procedures removed all traces of calcium and phosphate from the collagenous bone matrix (data not shown). Empty 2×100 cm columns were weighed, packed with the 51 g of demineralized bovine bone sand or the 242 g of non-demineralized bovine bone sand, and equilibrated with water. Excess water was removed to the surface of the packed matrix, the height of the packed sand was measured (for volume calculation), and the columns were re-weighed. The wet weight of the column contents is the difference between the weights of the packed and empty columns; the amount of water in the packed column is the difference between the wet and dry weights of the column contents; the amount of mineral in the bone sand is the difference between the dry weights before and after demineralization; and the volume of the packed column was determined by measuring the volume of water needed to fill an empty column to the same height as the packed column (see Table 5).

Gel Filtration Procedures: Bone Collagen.

The 227 ml columns of non-demineralized and demineralized bone sand prepared for the measurements shown in Table 5 were equilibrated with a 20 mM Tris pH 7.4 buffer that contained 2M NaCl in order to minimize non-specific ionic interactions between test molecules and the collagen matrix; the final effluent absorbance at 280 nm was less than 0.01. A constant flow rate of 18 ml/h was maintained and the fraction size was approximately 3 ml. Samples were dissolved in 5 ml of column buffer containing about 400,000 cpm of 1-¹⁴C-glucose as an internal reference; the load was 50 mg of the test protein or carbohydrate, 10 mg dimethyl sulfoxide, or 30 mg calcium chloride. The volume of each effluent fraction was determined from the weight of the fraction contents and the density of the column buffer (1.07 g/ml).

In experiments using a column containing 23 ml of demineralized bovine bone sand, the sample volume was reduced to 0.5 ml, the flow rate to 7.2 ml/h and the fraction volume to 0.5 ml. The amounts of sample loaded were: 5 mg protein; 40,000 cpm of 1-¹⁴C-glucose; 0.5 mg riboflavin; 10 mg sodium citrate; 4 mg disodium etidronate; and 30 mM phosphate or pyrophosphate. Certain samples were also run over the column at a flow rate of 0.72 ml/hr (Table 8).

The elution position of test substances was determined as follows: proteins, absorbance at 280 nm; 1-¹⁴C-glucose, liquid scintillation counting; high and low molecular weight dextrans, heptaose, and triose, as described (Chen et al. (1956) Anal. Chem. 28(11): 1756-1758; Hale et al. (1991) J. Biol. Chem. 266: 21145-21149); dimethyl sulfoxide and citrate, absorbance at 220 nm; calcium, cresolphthalein complexone (JAS Diagnostic, Miami, Fla.); phosphate, as described (Price et al. (1976) Proc. Natl. Acad. Sci., USA, 73: 1447-1451); pyrophosphate, enzymatic assay with NADH (Sigma); riboflavin, absorbance at 450 nm; and etidronate, by Ceric IV sulfate assay (Hemmelder et al. (1998) J. Lab Clin. Med. 132, 390-403).

TABLE 1
The water content of bovine achilles tendon fibers. Bovine achilles
tendon fibers were dissected from a steer, and thoroughly cleaned of
all adhering tissue. Fibers were extracted to remove non collagenous
constituents, and then dried, weighed, and re-hydrated in 20 mM
Tris pH 7.4 containing, 2M NaCl. The fibers' wet weights were
measured three times with a 20 minute equilibration in 20 mM
Tris pH 7.4 containing 2M NaCl between measurements. Liquid volume
in fibers is the liquid weight divided by 1.07 g/cc, the buffer density.
(See Experimental Procedures for details.)

| | Bovine achilles tendon | | | |
|---|---|---|---|---|
| | Sample 1 | | Sample 2 | |
| Wet weight of tendon | 1.330 ± 0.003 | g | 1.251 ± 0.008 | g |
| fibers | | | | |
| Dry weight of tendon | 0.408 | g | 0.381 | g |
| fibers | | | | |
| Weight of liquid in | 0.922 | g | 0.870 | g |
| tendon fibers | | | | |
| Volume of liquid in | 0.862 | ml | 0.813 | ml |
| tendon fibers | | | | |
| Volume liquid: Dry | 2.11 | ml/g | 2.13 | ml/g |
| weight tendon fibers | | | | |

### Results

The Size Exclusion Characteristics of Tendon Collagen.

The initial experiment was carried out to determine whether there is a measurable volume of liquid in hydrated tendon collagen. Purified type I collagen fibers were prepared from bovine Achilles tendon as described (29), and their dry and hydrated weights were measured. When equilibrated in 20 mM Tris pH 7.4 containing 2 M NaCl, purified bovine achilles tendon collagen fibers took up 2.12 ml liquid per gram dry collagen (Table 1). Essentially identical hydration values were found for fibers equilibrated in 20 mM Tris pH 7.4 containing 0.15 M NaCl (data not shown). These observations show that hydrated tendon collagen fibers are about ⅔ liquid by weight.

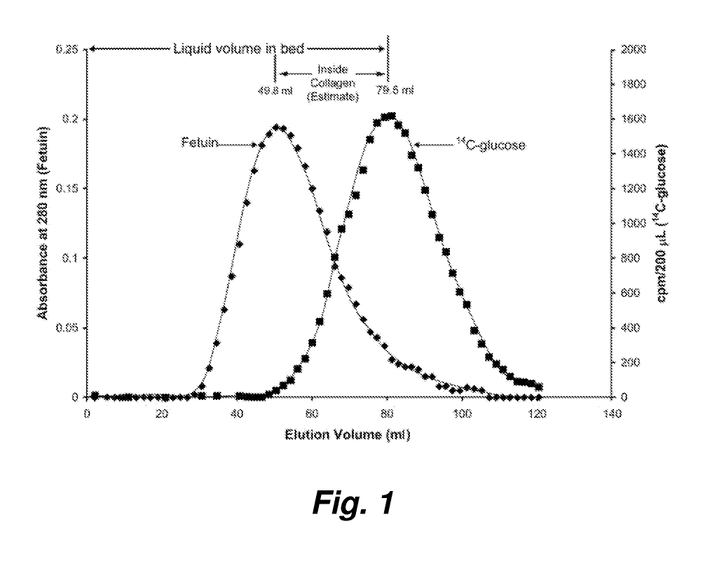

A novel, gel filtration-like method was developed to determine which molecules can access the liquid in tendon collagen. Purified type I collagen from bovine achilles tendon (Schinke et al. (1996)J. Biol. Chem. 271: 20789-20796) was purchased from Sigma, hydrated in column buffer, and packed in a 2 by 50 cm glass column. The size exclusion characteristics of this tendon collagen were then evaluated by filtering a mixture of glucose and fetuin (a 48 kDa glycoprotein) over this column. As can be seen in FIG. 1, ¹⁴C-labeled glucose eluted at a volume of about 80 ml, which is comparable to the 79.5 ml volume of liquid in the column bed. This observation shows that glucose has free access to essentially all liquid within the packed column. Fetuin eluted at a volume of about 51 ml, which is 29 ml less than the elution volume of glucose. This shows that fetuin is excluded from a 29 ml volume of liquid in the packed column that glucose is able to freely access. Because this 29 ml volume is comparable to the 29.7 ml liquid estimated to lie within collagen (14 g collagen×2.12 ml/g tendon fibers, Table 1), the simplest explanation for the lower elution volume of fetuin is that the protein cannot access the liquid within tendon collagen while glucose can.

Additional filtration experiments were carried out to further characterize the molecular exclusion characteristics of tendon collagen. As seen in Table 2, phosphate and bone Gla protein (BGP; osteocalcin) co-elute with glucose, while albumin co-elutes with fetuin. These observations indicate that there may be a molecular weight cut off for access to the liquid inside tendon collagen, a cut off that lies between the 5.7 kDa BGP and the 48 kDa fetuin.

TABLE 2
The size exclusion properties of purified bovine achilles tendon collagen.
The packed column whose preparation is described in the FIG. 1 legend
was equilibrated with 20 mM Tris pH 7.4 and 2M NaCl. A 2 ml volume of
equilibration buffer containing the test molecule, and 160,000 cpm of
1-¹⁴C glucose was then applied to the column. Flow rate,
6.7 ml/hour; fraction size, 1 ml. The elution volume of glucose for these
4 runs was 80 ± 0.95 ml (Mean ± SD). The results show the elution
volume of each test molecule. (See Experimental Procedures for details).

| Test molecule | MW (Da) | Elution volume, ml |
|---|---|---|
| Albumin | 66,000 | 52 |
| Fetuin | 48,000 | 51 |
| Bone Gla Protein | 5,700 | 80 |
| Glucose | 180 | 80 |
| Phosphate | 95 | 80 |

Evidence that the Demineralization of Bone Replaces Mineral with a Comparable Volume of Water.

Bone and tendon are composed of essentially identical type I collagen fibrils (Hulmes and Miller (1979) Nature 282, 878-880), and it therefore seemed likely that bone collagen would have size exclusion properties that are similar to those observed with tendon collagen. The goal of our next experiments was to test this hypothesis. Bone is 70% mineral by weight, however, and it was apparent that the presence of mineral in collagen will have a profound effect on its size exclusion characteristics. Any study of the size exclusion characteristics of bone collagen would therefore require comparison of bone before and after removal of mineral.

Several experiments were first carried out to determine the impact of demineralization on the water content and shape of bone. In the initial experiment, a cylindrical bone segment was cut from the midshaft of a two year old steer's femur and demineralized in 0.6 N HCl at room temperature for 10 days. The gross shape of the resulting demineralized bone ring was comparable to the same bone ring prior to demineralization (Table 3), its radiographic density was dramatically and uniformly reduced, and the bone ring was flexible (personal observations). The data in Table 3 also show that the demineralization of the bone ring is accompanied by a 9.7 ml increase in the volume of water in the bone, and that this increased water volume is comparable to the 9.4 ml volume originally occupied by mineral in the bone prior to demineralization. Demineralization therefore replaces mineral with a comparable volume of water.

TABLE 3
Effect of demineralization on the gross dimensions and water content
of bovine bone. A cylindrical bone segment was cut from the midshaft
region of a femur from a two-year-old steer, and was then cleaned of
marrow and connective tissue. The length, thickness and wet and dry
weights were obtained before demineralization for 10 days at room
temperature in 0.6N HCl. After demineralization, the bone was washed
with 20 mM Tris, 0.15M NaCl pH 7.4, and equilibrated in this buffer
overnight. The length, thickness, wet and dry weights were again
determined. The weight of mineral in bone is the difference in dry
weights due to demineralization.
(See Experimental Procedures for details.)

| | | | The same | | | |
|---|---|---|---|---|---|---|
| | Bovine bone | | segment after | | | |
| | segment before | | deminera- | | Change due to | |
| | demineralization | | lization | | demineralization | |
| | (A) | | (B) | | (B − A) | |
| Mean Thickness | 2.03 | cm | 2.05 | cm | +0.02 | cm |
| Mean Length | 1.77 | cm | 1.74 | cm | −0.03 | cm |
| Wet Weight of bone | 40.50 | g | 21.16 | g | −19.34 | g |
| Dry weight of bone | 37.30 | g | 8.10 | g | −29.2 | g |
| Weight of liquid in bone | 3.20 | g | 13.06 | g | 9.86 | g (+9.70 ml)^{a} |
| (Wet minus dry weight) | | | | | | |
| Weight of mineral in | 29.20 | g | 0.0 | g | −29.20 | g (−9.42 ml)^{b} |
| bone | | | | | | |

^{a}Assuming a density of 1.016 g/cc
^{b}Assuming a density of 3.1 g/cc

An additional experiment was carried out to examine the impact of the composition of the hydration liquid on the shape and water content of demineralized bone rings. As seen in Table 4, demineralized bone retains its shape and water content when equilibrated in water, in 20 mM Tris pH 7.4 containing 0.15 NaCl, and in 20 mM Tris pH 7.4 containing 2 M NaCl. The average liquid content of demineralized bone is 1.58±0.02 ml/g dry ring; essentially all of this water lies within collagen¹.

TABLE 4
The water content of demineralized bovine bone. To determine the volume of water within
the collagen of demineralized bone, two cylindrical bone segments were demineralized
for 10 days at room temperature in 0.6N HCl, then washed extensively in water. Three
equilibration solutions were tested: water, 20 mM Tris, pH 7.4 with 0.15M NaCl
(density 1.016 g/ml), and 20 mM Tris pH 7.4 with 2M NaCl (density, 1.07 g/ml). For each
solution, the bone wet weight was measured three times with a two hour equilibration in the
solution between measurements, and the length and thickness of each segment was
determined. Bone was then washed in 50 mM HCl and lyophilized to determine dry weight.
The volume of each liquid in bone was determined using the difference between the wet and
dry weights, and the liquid densities.

| | Equilibration Solution | | | | | |
|---|---|---|---|---|---|---|
| | | | 20 mM Tris, 2M | | 20 mM Tris, | |
| | Water | | NaCl | | 0.15M NaCl | |
| Segment 1: | | | | | | |
| Mean Thickness | 2.10 | cm | 2.02 | cm | 2.05 | cm |
| Mean Length | 1.69 | cm | 1.72 | cm | 1.74 | cm |
| Wet Weight of bone | 21.03 ± 0.03 | g | 21.81 ± 0.03 | g | 21.16 ± 0.03 | g |
| Dry Weight of bone | 8.10 | g | 8.10 | g | 8.10 | g |
| Weight of liquid in bone | 12.93 | g | 13.71 | g | 13.06 | g |
| (wet minus dry weight) | | | | | | |
| Volume of liquid in bone | 12.93 | ml | 12.81 | ml | 12.85 | ml |
| Liquid volume: Dry Weight | 1.60 | ml/g | 1.58 | ml/g | 1.59 | ml/g |
| Segment 2: | | | | | | |
| Mean Thickness | 2.23 | cm | 2.24 | cm | 2.25 | cm |
| Mean Length | 1.54 | cm | 1.58 | cm | 1.59 | cm |
| Wet Weight of bone | 20.53 ± 0.03 | g | 20.97 ± 0.01 | g | 20.58 ± 0.02 | g |
| Dry Weight of bone | 7.90 | g | 7.90 | g | 7.90 | g |
| Weight of liquid in bone | 12.60 | g | 13.07 | g | 12.68 | g |
| (wet minus dry weight) | | | | | | |
| Volume of liquid in bone | 12.60 | ml | 12.21 | ml | 12.48 | ml |
| Liquid volume: Dry | 1.59 | ml/g | 1.55 | ml/g | 1.58 | ml/g |
| Weight | | | | | | |

The Size Exclusion Characteristics of Bovine Bone Before and after Demineralization.

The size exclusion characteristics of bovine bone before and after demineralization were evaluated using the gel filtration-like procedure developed with bovine tendon collagen. Bone from the midshaft region of steer tibias was ground to the consistency of coarse sand (median diameter 0.5 mm) as described (Einbinder and Schubert (1950)J. Biol. Chem., 188: 335-341) and divided into two portions of 242 g each. One portion was then demineralized with 10% formic acid for 3 days at 4° C. (Id.), washed with water, dried, and weighed. The demineralized and non-demineralized bone portions were hydrated in water and separately packed into 2×100 cm columns. The final packed volumes of the two columns were the same, which indicates that demineralization does not alter the shape or volume of the bone sand particles. As can be seen in Table 5, demineralization of bovine bone sand replaced mineral (62 ml) with a comparable volume of water (67 ml).

TABLE 5
Characterization of columns packed with demineralized and non-
demineralized bovine bone. Bone from the midshaft region of steer tibias
was ground to the consistency of coarse sand and divided into two portions
of 242 grams each; one portion was then demineralized with 10% formic
acid for 3 days at 4° C., dried and weighed. Both materials were
hydrated in water and separately packed into 2 × 100 cm glass columns.
The volume of each packed column was then determined. The wet weight
of the column contents is the difference between the weights of the packed
and empty columns. Weight of mineral in packed column is the difference
in the dry weight of column contents due to demineralization.
(See Experimental Procedures for details)

| | Non-de- | | Demi- | | | |
|---|---|---|---|---|---|---|
| | mineralized | | neralized | | Change due to | |
| | bone sand | | bone sand | | demineralization | |
| | (A) | | (B) | | (B − A) | |
| Total volume of | 227 | ml | 227 | ml | — | |
| packed column | | | | | | |
| Wet weight of | 367 | g | 243 | g | −124 | g |
| column contents | | | | | | |
| Dry weight of | 242 | g | 51 | g | −191 | g |
| column contents | | | | | | |
| Weight of water in | 125 | g | 192 | g | +67 | g (+67 ml) |
| packed column | | | | | | |
| (Wet minus dry | | | | | | |
| weight) | | | | | | |
| Weight of mineral in | 191 | g | 0 | g | −191 | g (−62 ml)^{a} |
| packed column | | | | | | |

^{a}Assuming a density of 3.1 g/cc

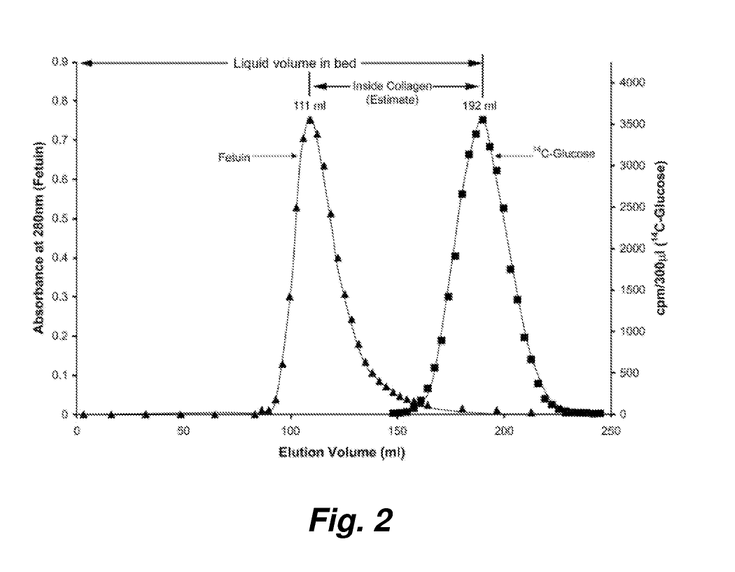

FIG. 2 shows the result obtained when a mixture of ¹⁴C-labeled glucose and fetuin are filtered over the column of demineralized bovine bone sand. As can be seen, ¹⁴C-labeled glucose eluted from the demineralized bone sand column at a volume of 191 ml, which is comparable to the 192 ml volume of liquid in the column bed. This observation shows that glucose has free access to essentially all liquid within the packed column. In contrast, fetuin eluted at a volume of 111 ml, which is approximately 80 ml less than the elution volume of glucose. This shows that fetuin is excluded from an 80 ml volume of liquid in the packed column that glucose is able to freely access. Because the volume of liquid inside bone collagen is estimated to be about 81 ml (51 g collagen×1.58 ml/g collagen; Tables 4 and 5), the simplest explanation for the lower elution volume of fetuin is that the protein cannot access the aqueous solution within bone collagen while glucose can. The type I collagen matrices of tendon and demineralized bone are therefore comparably accessible to glucose and inaccessible to fetuin.

Additional experiments were carried out to further characterize the molecular exclusion characteristics of the demineralized bone sand column. As can be seen in Table 6, glucose, dimethyl sulfoxide, and calcium elute at approximately the bed volume, and therefore have access to essentially all liquid within the packed column. In contrast, fetuin, ovalbumin, albumin, and high molecular weight dextran elute at the approximate volume of liquid estimated to lie outside of collagen (the excluded volume), and therefore are probably equivalently unable to access the volume of liquid within collagen. Trypsin inhibitor (21.5 kDa), low molecular weight dextran (10.2 kDa), and heptaose (1.15 kDa) elute from the demineralized bone sand column between glucose and fetuin, and consequently appear to have partial access to the volume of liquid in collagen.

TABLE 6
The size exclusion properties of demineralized bovine bone collagen.
The demineralized packed bone sand column whose preparation is
described in the Table 3 legend was equilibrated at room temperature
with 20 mM Tris pH 7.4 containing 2M NaCl. A 5 ml volume of
equilibration buffer containing the test molecule and 400,000 cpm of
1-¹⁴C-glucose was then applied to the column. Flow rate, 18 ml/hour;
fraction size, 3 ml. The elution volume for glucose for these nine runs was
191 ± 2.5 ml (Mean ± SD). The results show the elution volume of
the indicated test molecule. (See Experimental Procedures for details).

| | MW (Da) | Elution volume, ml |
|---|---|---|
| Molecules eluting at excluded volume | | |
| High MW Dextran | 5-40 × 10⁶ | 110 |
| Albumin | 67,000 | 113 |
| Fetuin | 48,000 | 110 |
| Ovalbumin | 43,000 | 119 |
| Molecules eluting in fractionation range | | |
| Trypsin inhibitor | 21,500 | 154 |
| Low MW Dextran | 10,200 | 130 |
| Heptaose | 1,152 | 160 |
| Molecules eluting at bed volume | | |
| Glucose | 180 | 191 |
| Dimethylsulfoxide | 78 | 191 |
| Calcium | 40 | 191 |

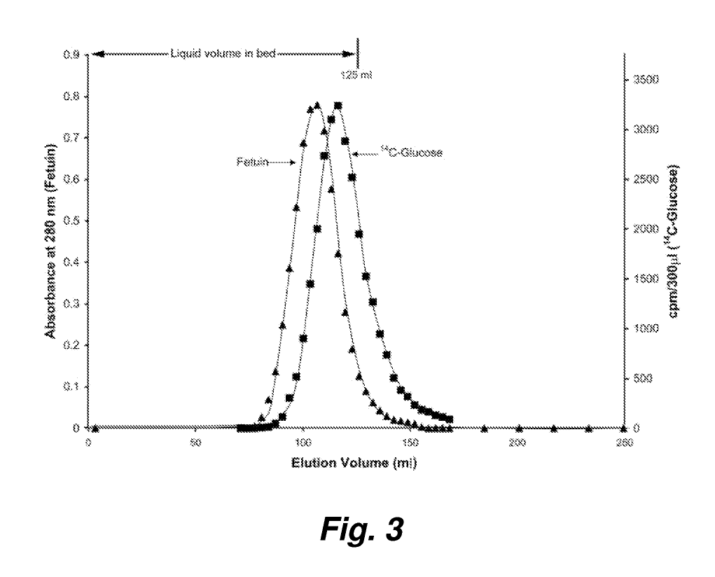

We next examined the size-exclusion characteristics of a column made with non-demineralized bone sand. Comparison of FIGS. 2 and 3 shows that the presence of mineral in the same amount of collagen dramatically reduces the elution volume of glucose but does not comparably affect the elution volume of fetuin. The reduced separation volume between glucose and fetuin on the two columns, 71 ml, is therefore a direct measure of the impact of mineral on the volume in collagen that glucose can access. Table 7 shows that the reduced separation between glucose and test molecules due to the presence of mineral is comparable for fetuin, albumin, and high molecular weight dextran. The average reduced separation due to the presence of mineral, 70 ml, is comparable to the reduced volume of water in the column bed (67 ml, Table 7), and the reduced volume of water is comparable to the increased volume occupied by mineral (62 ml, Table 7). Mineral therefore occupies a space in bone collagen that is occupied by water in demineralized bone collagen, and this water compartment is accessible to glucose but not fetuin, albumin, or high molecular weight dextran.

TABLE 7
The impact of mineral on the size exclusion properties of bone collagen.
The packed bone sand columns whose preparation is described in the
Table 5 legend were equilibrated at room temperature with 20 mM Tris
pH 7.4 containing 2M NaCl. A 5 ml volume of equilibration buffer
containing 50 mg of the test protein or carbohydrate and 400,000 cpm of
1-¹⁴C-glucose was then applied to each column. Flow rate, 18 ml/hour;
fraction size, 3 ml. The results show the elution volume separating
glucose from the indicated test molecule for each column.
(See Experimental Procedures for details).

| | | Volume separating test molecule | | |
|---|---|---|---|---|
| | | from glucose, ml | | Difference |
| | | | Non- | due to |
| Test | | Demineralized | demineralized | deminerali- |
| molecule | MW (Da) | Bone Sand | Bone Sand | zation (ml) |
| High MW | 5-40 × 10⁶ | 81 | 10 | 71 |
| dextran | | | | |
| Albumin | 66,000 | 78 | 11 | 67 |
| Fetuin | 48,000 | 81 | 10 | 71 |

| | | | |
|---|---|---|---|
| Volume of liquid in | 192 | 125 | 67 |
| column bed, ml (Table 5) | | | |
| Volume of mineral, ml | 0 | 62 | −62 |
| (Table 5) | | | |

The Size Exclusion Characteristics of Demineralized Bovine Bone Sand: 23 ml Column Experiments.

Additional experiments were carried out to determine whether a smaller bone sand column could be used to obtain information on the size exclusion characteristics of bone collagen without the need for the large sample amounts and long filtration times required for the 227 ml column. The volume of demineralized bone sand in the column was reduced by about 1/10 (to 23 ml from 227 ml), the sample volume was reduced by 1/10 (to 0.5 ml from 5 ml), and the flow rate was reduced to 7.2 ml/h in order to give an equivalent flow per unit of cross sectional column area. This 23 ml demineralized bone sand column gave a 7.6 ml separation volume between glucose and fetuin, which is about 1/10 of the 81 ml separation volume previously found using the 227 ml bone sand column (Table 7). The filtration time required for a single determination with this 23 ml column was 3 h compared to about a day with the 227 ml column. The size exclusion characteristics of bone collagen were further evaluated by passing a number of additional substances over this 23 ml demineralized bone sand column (see Table 8). The most significant new information obtained in these experiments is the discovery that the 5.7 kDa bone Gla protein (BGP; osteocalcin) is able to penetrate bone collagen to the same extent as glucose, calcium, phosphate, pyrophosphate, and citrate.

TABLE 8
The size exclusion properties of demineralized bovine bone collagen:
23 ml column experiments. Demineralized bovine bone sand
(4.3 g dry weight) was hydrated and packed into a 1.25 cm diameter
column to a volume of 23 ml and equilibrated at room temperature with
20 mM Tris pH 7.4 containing 2M NaCl until the absorbance at 280 nm
was <0.01. A 0.5 ml volume of equilibration buffer containing the test
molecule and 40,000 cpm of 1-¹⁴C glucose was then applied to the
column. Flow rate, 7.2 ml/h; fraction size, 0.5 ml. The results show the
elution volume separating glucose from the indicated test molecule. The
elution volume of glucose for these 14 runs was 18.9 ± 0.4 ml
(Mean ± SD). (See Experimental Procedures for details.)

| | | Volume separating test |
|---|---|---|
| Test molecule | MW (Da) | molecule from glucose, ml |
| Rabbit IgG | 152,000 | 7.4 |
| Hemoglobin | 64,000 | 8.0 |
| Fetuin | 48,000 | 7.6 |
| Cytochrome C | 12,300 | 4.3 |
| BGP | 5,700 | 0 |
| Riboflavin | 376 | 0.5 |
| Etidronate | 192 | 0 |
| Citrate | 189 | 0.9 |
| Pyrophosphate | 174 | 0.6 |
| Phosphate | 95 | 0 |

Because of the reduced filtration times needed with the 23 ml bone sand column, it was feasible to use this column to explore the effect of reducing the buffer flow rate on the size exclusion characteristics of bone collagen. These experiments showed that reducing the flow rate from 7.2 ml/h to 0.72 ml/h did not significantly affect the elution volumes of fetuin, cytochrome C, BGP, riboflavin, or glucose (not shown). The elution volumes obtained using the standard flow rates (Tables 6 and 8) therefore reflect differences in the absolute ability of molecules to penetrate the bone collagen, not differences in the time needed to diffuse into collagen. A final experiment was carried out to evaluate the effect of salt concentration on elution volume. This experiment showed that reducing the NaCl content of the equilibration buffer from 2M to 0.15M did not significantly affect the elution volume of fetuin or glucose (not shown).

### Discussion

Our study is the first to demonstrate that the chemically identical type I collagen matrices of tendon and demineralized bone have the ability to exclude large molecules but not small, and it is important to examine the results of our study from an empirical as well as a theoretical perspective. For clarity, the sections below begin with the simpler case of the size exclusion characteristics of tendon collagen, proceed to a discussion of the impact of demineralization on the shape and water content of the bone collagen, and then to a discussion of the more complex case of the size exclusion properties of bone collagen and the impact of mineralization on these properties. The Discussion ends with a brief analysis of the implications of the size exclusion characteristics of the collagen fibril for the possible functions of non-collagenous bone constituents in bone mineralization.

The Size Exclusion Characteristics of Tendon Collagen.

The method we developed to investigate the size exclusion characteristics of tendon collagen is an adaptation of the biochemical procedure used to separate macromolecules by size, a procedure termed gel filtration chromatography. It is useful to briefly review this biochemical procedure before discussing the empirical interpretation of our results. In gel filtration chromatography, a cylindrical column is packed with an insoluble matrix that consists of minute, spherical beads with a porous skin that encloses an interior aqueous compartment. The packed column therefore has two aqueous volumes, one outside the beads and the other inside. In a typical gel filtration experiment, a solution containing molecules of different size is applied to the column, and the elution volume of each molecule is measured. The results of these experiments show that some molecules are sufficiently small that they can rapidly penetrate the skin of the beads and so achieve the same concentration in the water inside the bead as they do outside. These small molecules elute at the liquid volume in the column bed (volumes outside plus inside the beads). Other molecules are sufficiently large that they cannot penetrate the skin of the beads; these large molecules elute at the smaller volume of liquid outside the beads (Scott and Melvin (1953) Anal. Chem. 25: 1656-1661).

In the initial study, we packed a column with purified type I collagen from bovine tendon and then determined the elution volume of different test molecules from this collagen column. The results of this experiment show that molecules that range in size from the 95 dalton phosphate to the 5,700 dalton bone Gla protein elute at an ˜80 ml volume that is identical to the liquid volume in the column bed. As they pass through the column, each of these molecules is therefore able to access all of the water in the column bed. In contrast, molecules the size of fetuin (48,000 daltons) and albumin (66,000 daltons) both elute at 51 ml, which is 29 ml less than the elution volume of the small molecule group. The simplest explanation for these observations is that the type I collagen in the column contains 29 ml of water that is accessible to BGP, glucose, and phosphate, and inaccessible to fetuin and albumin.

Where in the ˜80 ml volume of water in the collagen column is the 29 ml water that is freely accessible to small molecules but not to large? Two observations indicate that this 29 ml volume lies within the collagen fibril: 1. A comparable, 29.7 ml volume of water was calculated to lie in the 14 g of collagen fibers in the column bed (see Table 1). 2. Collagen fibers consist of densely packed collagen fibrils (Holmes et al. (2001) Proc. Natl. Acad. Sci., USA, 98: 7307-7312; Hulmes and Miller, A. (1979) Nature 282, 878-880), and it has been demonstrated that most or all of the water in collagen fibers lies within the individual collagen fibrils (Knott and Bailey (1998) Bone 22: 181-187 and references therein).

Why do small molecules such as phosphate, glucose, and the 5,700 dalton BGP elute at the 80 ml volume of total liquid in the column, in spite of the fact that 29 ml of this water lies within the collagen fibrils? Each of these molecules must be able to attain the same concentration in the water that lies inside the collagen fibrils of the packed column (˜29 ml, FIG. 1) as it does in the water that lies outside of the fibrils (˜50 ml, FIG. 1); each molecule therefore elutes at the same volume it would from a 80 ml column of water with no collagen. This result is surprising, as it indicates that the collagen molecules in the fibril have no influence on the ability of small molecules in the buffer to attain the same concentration in the entire aqueous volume that lies within the collagen fibril. This result is even more surprising when one considers that these small molecules must attain this equivalent concentration in the <10 millisecond interval in which a given concentration of solute is in contact with the fibril (Assuming the diameter of a typical fibril is 50 nm. At a flow rate of 6.7 ml/h, it takes 8 milliseconds for a layer of water to travel 50 nm in the 2 cm diameter column).

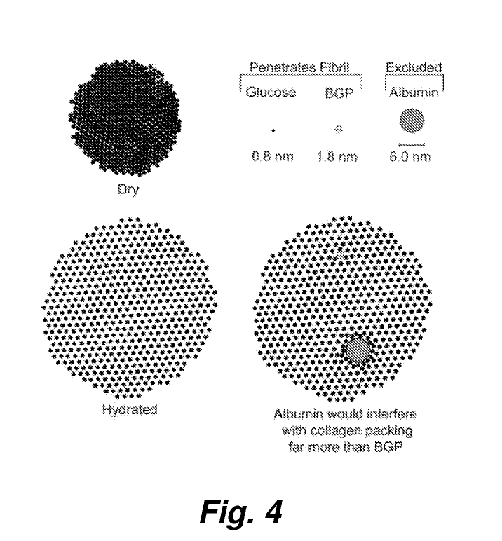

As a first step to understanding the molecular basis for the ability of small molecules to reach concentration equilibrium with all of the water within the collagen fibril, we have constructed a model of the lateral structure of a typical collagen fibril in the fully hydrated and dry states (FIG. 4). In this model, collagen molecules are represented by 1.1 nm hard disks that are arranged in a quasihexagonal lattice (Orgel et al. (2006) Proc. Natl. Acad. Sci., USA, 103(24): 9001-9005) at packing densities corresponding to those seen for fully hydrated and dry collagen fibrils (Fratzl et al. (1993) Biophys J., 64: 260-266; Fullerton and Amurao (2006) Cell Biology International 30: 56-65). It is readily apparent from this model that molecules the size of glucose can freely diffuse into all of the water in the lateral plane of the hydrated fibril. In contrast, the water in the hydrated fibril appears to be inaccessible to BGP. How then are both glucose and BGP able to attain equilibrium concentration in all of the water within the fibril? The likely explanation is that the quasihexagonal packing of collagen molecules observed in x-ray crystallographic studies (and reproduced in FIG. 4) is the average position of these molecules in the lateral plane of the fibril structure, and that the actual position of a collagen molecule varies rapidly in time. As reviewed in the Introduction, hydration of the collagen fibril separates adjacent collagen molecules in the lateral plane by a water layer 7 Å thick (see FIG. 4). The thickness of this water layer argues against non-covalent lateral associations along the full length of adjacent collagen molecules in the fibril, and suggests that collagen molecules have the flexibility to move relative to their neighbors to create aqueous cavities of rapidly fluctuating size within the fibril. As can be seen in FIG. 4, minimal movements of collagen molecules are sufficient to accommodate BGP within the quasihexagonal lattice of the fibril.

Several studies support the hypothesis that collagen molecules have substantial freedom to move within the fibril. ¹³C nuclear magnetic resonance studies have shown that the polypeptide backbone of the collagen molecule is free to reorient within a fully hydrated collagen fibril in less than 0.1 milliseconds (Taha and Youssef (2003) Chem. Pharm. Bull. 51(12): 1444-1447). These motions are not observed in dry fibrils or in mineralized collagen fibrils, and are not affected by covalent cross links at the N and C termini of the collagen molecule (Id.). Atomic force microscopy studies further show that collagen molecules are free to move relative to their neighbors when the fibril is bent or folded (Orgel et al. (2006) Proc. Natl. Acad. Sci., USA, 103(24): 9001-9005). Finally, recent studies show that a 3 kDa fluorescently labeled dextran can diffuse along the length of the collagen fibril (Voet and Voet (2004) Biochemistry, 3rd Ed., John Wiley & Sons Inc., New York). Diffusion of such a relatively large molecule within the fibril is consistent with the present observation that BGP can freely access all of the water within the collagen fibril, and further supports the hypothesis that individual collagen molecules have substantial freedom to move in the lateral plane of the fibril.

Why are fetuin and albumin completely excluded from the volume of water that lies within the collagen fibril? As is apparent in the model shown in FIG. 4, molecules the size of albumin (˜60 Å diameter) and fetuin (probably >60 Å diameter, owing to the fact that it is 25% carbohydrate) are far too large to be accommodated within the collagen fibril without crowding collagen molecules in the lateral plane (see FIG. 4) and substantially reducing their freedom of motion (entropy).

Impact of Demineralization on the Size, Shape, and Water Content of Bone.

Our next objective was to determine the size exclusion characteristics of the collagen matrix of bone, and to accomplish this goal it was clear that it would be first necessary to remove mineral from bone collagen, since the presence of mineral is an obvious barrier to the penetration of molecules into collagen. Experiments were accordingly carried out to determine the effect of demineralization on the water content and shape of bone. These experiments showed that bone shape and volume are not affected when an intact steer bone segment is demineralized in 0.6 N HCl at 20° C., or when a sample of ground steer bone sand is demineralized in 10% formic acid at 4° C. (Table 5). These experiments also showed that demineralization of bone consistently replaced mineral with a comparable volume of water (Tables 3 and 5). These observations are logically connected, since the absence of a change in bone volume associated with the removal of mineral requires that the volume occupied by mineral be replaced with an equivalent volume of water. To our knowledge, the present study is the first to show that demineralization of bone replaces mineral with a comparable volume of water.

Several investigators have studied the effects of the reverse process, normal bone mineralization, on bone structure. In his seminal studies on bone, Robinson presented evidence that the collagenous matrix is first formed in its final shape and volume, and then mineralized, and that the deposition of mineral is associated with the loss of a comparable volume of water from the collagenous bone matrix (Hodge and Petruska (1963) Recent studies with the electron microscope on ordered aggregates of the tropocollagen molecule, Academic Press, New York; Revenko et al. (1994) Biol Cell 80: 67-69). Subsequent studies of bones with differing degrees of mineralization further showed that, for a fixed amount of bone collagen matrix, there is an inverse correlation between mineral content and water content (Fraser et al. (1983) J. Mol. Biol. 167: 497-521).

The mineralization and demineralization of bone therefore appear to be reciprocal processes; one replaces water in collagen with mineral and the other mineral with water. The volume of water in collagen prior to mineralization is comparable to the volume of mineral in after demineralization, and the volume and shape of the bone prior to mineralization are comparable to the volume and shape of the collagen matrix after demineralization. Demineralized bone is therefore likely to be a good model for investigating the size exclusion characteristics of bone collagen prior to mineralization.

The Size Exclusion Characteristics of Demineralized Bone Collagen.

The same biochemical procedures used to determine the size exclusion characteristics of tendon collagen were also used for demineralized bone collagen. The results of these experiments show that tendon and demineralized bone collagen have essentially identical size exclusion characteristics. Small molecules that range in size up to the 5,700 dalton bone Gla protein elute at the same volume as glucose. With the 227 ml column, this glucose elution volume is 191 ml, which is identical to the liquid volume in the column bed (FIG. 2). In contrast, molecules the size of fetuin (48,000 daltons), albumin (66,000 daltons), and high molecular weight dextran (5−40×10⁶ daltons) elute at about 111 ml, which is 80 ml less than the elution volume of glucose, BGP, and other small molecules. The simplest explanation for these observations is that the demineralized bone collagen in the column contains 80 ml of water that is accessible to molecules the size of the 5.7 kDa BGP or smaller, and inaccessible to molecules the size of the 48 kDa fetuin or larger.

The 80 ml volume of water in the demineralized bone collagen column that can be freely accessed by small molecules but not by large probably lies within the collagen fibril. The collagen location of this water is supported by the fact that an 80 ml volume of water is calculated to lie within the collagen of the demineralized bone column (see Results and Table 4). The fibril location of this collagen water is in turn supported by X ray diffraction studies that show that hydration produces a comparable increase in the Bragg spacing of collagen molecules in the lateral plane of tendon and demineralized bone collagen fibrils (Torchia (1982) Methods in Enzymology 82: 174-186).

The comparable Bragg spacing in the fully hydrated fibrils in tendon and demineralized bone shows that both have a comparable layer of water separating adjacent collagen molecules in the lateral plane of the fibril. Because the internal structure of the collagen fibrils in both tissues are therefore essentially identical (Ekani-Nkodo and Fygenson (2003) Phys Rev E Stat Nonlin Soft Matter Phys 67: 021909), the fibrils in both tissues would be expected to impose a comparable barrier to the penetration of large molecules but not small and give rise to indistinguishable size exclusion properties (FIG. 4).

The Size Exclusion Characteristics of Non-Demineralized Bone Collagen.

In order to evaluate the impact of mineral on the size exclusion properties of bone collagen, we prepared a column of non-demineralized bone that contained the same amount of collagen as the demineralized bone column (see Table 5). We then compared the elution volume of different test molecules on the columns packed with non-demineralized and demineralized bone collagen. The results of these experiments showed that the presence of mineral in the same amount of collagen dramatically reduces the elution volume of glucose but does not comparably affect the elution volume of fetuin, albumin, and high molecular weight dextran. The average reduced separation due to the presence of mineral, 70 ml, is comparable to the reduced volume of water in the column bed (67 ml, Table 7), and the reduced volume of water is due to the volume occupied by mineral (62 ml, Table 7). Mineral therefore occupies a space in bone collagen that is occupied by water in demineralized bone collagen, and this water compartment is accessible to glucose but not fetuin, albumin, or high molecular weight dextran.

The Size Exclusion Characteristics of the Collagen Fibril: Insights into the Function of Non-Collagenous Bone Constituents in Bone Mineralization.

The type I collagen fibril plays several critical roles in bone mineralization. The mineral in bone is located primarily within the fibril (Robinson and Elliott (1957) J. Bone and Joint Surg. 39A: 167-188; Boivin and Meunier (2002) Calcif Tissue Int 70: 503-511; Robinson (1958) Chemical analysis and electron microscopy of bone. In. Bone as a tissue; proceedings of a conference, Oct. 30-31, 1958., McGraw-Hill, New York; Blitz and Pellegrino (1969) J. Bone and Joint Surg. 51-A: 456-466; Ottani et al. (2002) Micron 33: 587-596; Wess (2005) Adv. Protein Chem. 70: 341-374), and during mineralization the fibril is formed first and then water within the fibril is replaced with mineral (Hodge and Petruska (1963) Recent studies with the electron microscope on ordered aggregates of the tropocollagen molecule, Academic Press, New York; Gutsmann et al. (2003) Biophys J., 84: 2593-2598)). The collagen fibril therefore provides the aqueous compartment in which mineral grows. The present study shows that the physical structure of the collagen fibril plays an important additional role in mineralization: the role of a gatekeeper that allows molecules smaller than a 6 kDa protein to freely access the water within the fibril while preventing molecules larger than a 40 kDa protein from entering the fibril. Molecules smaller than a 6 kDa protein can therefore interact directly with apatite crystals growing within the fibril while molecules larger than a 40 kDa protein cannot.

Proteins that are too large to penetrate the collagen fibril can still have important roles in bone mineralization. Some large bone proteins, such as osteopontin (Bonar et al. (1985) J. Mol. Biol. 181: 265-270; Ottani et al. (2001) Micron 32: 251-260) and fetuin (Hamlin and Price (2004) Calcif. Tiss. Internat. 75: 231-242; Price et al. (2004) J. Biol. Chem. 279(18): 19169-19180; Jahnen-Dechent et al. (1997) J. Biol. Chem. 272: 31496-31503; Boskey et al. (1993) Bone Miner. 22: 147-159), potently inhibit apatite formation or growth in vitro. We propose that such large protein inhibitors of calcification may paradoxically promote mineralization of the collagen fibril by selectively inhibiting apatite growth everywhere but within the fibril. The companion paper in the Journal tests this hypothesis by examining the impact of fetuin-depletion on the serum-induced calcification of the collagen fibril. The results of this test show that the presence of fetuin in serum determines the location of serum-induced mineralization: in the presence of fetuin, mineral forms within the collagen fibril; in the absence of fetuin, a comparable amount of mineral forms outside the fibril.

Other proteins that are too large to penetrate the fibril may nucleate mineral formation, proteins such as bone sialoprotein (Hunter et al. (1994) Biochem. J. 300: 723-728; Midura et al. (2004) J. Biol. Chem. 279(24): 25464-25473) and the recently discovered serum nucleator of collagen calcification (Fratzl et al. (1993) Biophys J 64: 260-266) as well as large structures such as matrix vesicles (Tye et al. (2003) J. Biol. Chem. 278(10): 7949-7955). We propose that such proteins generate apatite crystal nuclei outside of the collagen fibril, and that some of these small crystals can then diffuse into the interior of the fibril and grow. Since BGP diffuses into all of the water within the collagen fibril, it seems likely that apatite crystals up to the size of BGP (about 12 hydroxyapatite unit cells) can also diffuse throughout the fibril. (Because the volume of BGP (˜6500 A³) is over 12 times greater than the volume of a hydroxyapatite unit cell (529.2 A³ (Skedros, J. (2005) Cells Tissues Organs 181, 23-37), a hydroxyapatite crystal the size of BGP contains about 12 hydroxyapatite unit cells) The other examples demonstrate that the serum nucleator of collagen calcification does indeed generate crystal nuclei outside of the fibril, and provides evidence that some of these crystal nuclei subsequently diffuse into the collagen fibril and grow.

### Example 2

### The Essential Role of Fetuin in the Serum-Induced Calcification of Collagen

### Summary

The mineral in bone is located primarily within the collagen fibril and during mineralization the fibril is formed first and then water within the fibril is replaced with mineral. Our goal is to understand the mechanism of fibril mineralization, and as a first step we recently determined the size exclusion characteristics of the fibril. This study indicates that apatite crystals up to 12 unit cells in size can access the water within the fibril while molecules larger than a 40 kDa protein are excluded.

We proposed a novel mechanism for fibril mineralization based on these observations, one that relies exclusively on agents excluded from the fibril. One agent generates crystals outside the fibril, some of which diffuse into the fibril and grow, and the other selectively inhibits crystal growth outside of the fibril.

We have tested this mechanism by examining the impact of removing the major serum inhibitor of apatite growth, fetuin, on the serum-induced calcification of collagen. The results of this test show that fetuin determines the location of serum-driven mineralization: in fetuin's presence, mineral forms only within collagen fibrils; in fetuin's absence, mineral forms only in solution outside the fibrils. The X-ray diffraction spectrum of serum-induced mineral is comparable to the spectrum of bone crystals. These observations show that serum calcification activity consists of an as yet unidentified agent that generates crystal nuclei, some of which diffuse into the fibril, and fetuin, which favors fibril mineralization by selectively inhibiting the growth of crystals outside the fibril.

### Introduction

Type I collagen fibril plays several critical roles in bone mineralization. The mineral in bone is located primarily within the fibril (Tong et al. (2003) Calcif. Tiss. Internat. 72: 592-598; Katz and Li (1973) J. Mol. Biol. 1973: 1-15; Sasaki and Sudoh (1996) Calcif Tissue Int 60: 361-367; Jager and Fratzl (2000) Biophys J 79: 1737-1748; Landis et al. (1993) J. Structural Biol. 110: 39-54; Rubin et al. (2003) Bone 33: 270-282), and during mineralization the fibril is formed first and then water within the fibril is replaced with mineral (Robinson and Elliott (1957) J. Bone and Joint Surg. 39A: 167-188; Boivin and Meunier (2002) Calcif Tissue Int 70: 503-511). The collagen fibril therefore provides the aqueous compartment in which mineral grows. We have recently shown that the physical structure of the collagen fibril plays an important additional role in mineralization: the role of a gatekeeper that allows molecules smaller than a 6 kDa protein to freely access the water within the fibril while preventing molecules larger than a 40 kDa protein from entering the fibril (Toroian et al. (2007) J. Biol. Chem. 282: 22437-22447). Molecules smaller than a 6 kDa protein can therefore enter the fibril and interact directly with mineral to influence crystal growth. Molecules larger than a 40 kDa protein cannot enter the fibril and so have no ability to act directly on the apatite crystals growing within the fibril.

Molecules too large to enter the collagen fibril can still have important effects on mineralization within the fibril. We have suggested that large inhibitors of apatite growth can paradoxically favor mineralization within the fibril by selectively preventing apatite growth outside of the fibril (Id.). We have also proposed that large nucleators of apatite formation may generate small crystal nuclei outside of the collagen fibril and that some of these nuclei subsequently diffuse into the fibril and grow (Id.). Because the size exclusion characteristics of the fibril allow rapid penetration of molecules the size of a 6 kDa protein, apatite crystals up to 12 unit cells in size should in principle be able to freely access all of the water within the fibril (Id.). The present study tests these hypotheses for the possible function of large molecules in mineralization.

The calcification assay we have employed to test the function of large proteins in collagen mineralization is based on our discovery that the type I collagen fibrils of tendon and demineralized bone calcify when incubated in serum (or plasma) for 6 days at 37° C. and pH 7.4 (Hamlin and Price (2004) Calcif. Tiss. Internat. 75: 231-242; Price et al. (2004) J. Biol. Chem. 279: 19169-19180). The calcification activity responsible for collagen mineralization in serum consists of one or more proteins that are 50 to 150 kDa in size (Price et al. (2004) J. Biol. Chem. 279: 19169-19180). Because these molecules are too large to penetrate the collagen fibril, they must be able to act outside the fibril to cause calcification within the fibril. The serum-driven calcification of a collagen fibril is therefore an excellent model system to explore the mechanisms by which molecules too large to penetrate the collagen fibril can nonetheless cause the fibril to calcify.

Although serum-driven collagen calcification is an in vitro, cell-free assay, there are several reasons to believe that it could be relevant to understanding mechanisms by which collagen fibrils are mineralized in normal bone formation. 1. The assay conditions are physiologically relevant: collagen added to serum calcifies when incubated at the temperature and pH of mammalian blood, without the need to add anything to serum to promote mineralization, such as β glycerophosphate or phosphate (see Hamlin and Price (2004) Calcif. Tiss. Internat. 75: 231-242, and references therein). 2. Serum is relevant to bone mineralization: osteoblasts form bone in a vascular compartment (Parfitt (2000) Bone 26: 319-323), and proteins in serum have direct access to the site of collagen fibril formation and mineralization while proteins secreted by the osteoblast appear rapidly in serum. 3. Serum-driven calcification is evolutionarily conserved: the serum calcification activity appeared in animals at the time vertebrates acquired the ability to form calcium phosphate mineral structures, with no evidence for a similar activity in the serum of invertebrates (Hamlin et al. (2006) Calcif: Tissue Int. 76: 326-334). 4. Serum-driven calcification is specific: calcification is restricted to those structures that were calcified in bone prior to demineralization, with no evidence of calcification in cartilage at the bone ends or in cell debris (Hamlin and Price (2004) Calcif. Tiss. Internat. 75: 231-242; Price et al. (2004)J. Biol. Chem. 279: 19169-19180). 5. Serum-driven calcification can achieve the total re-calcification of demineralized bone: serum-driven calcification progresses until the re-calcified bone is comparable to the original bone prior to demineralization in mineral content and composition, radiographic density, and powder X-ray diffraction spectrum (Price et al. (2004)J. Biol. Chem. 279: 19169-19180).

The initial goal of the present experiments was to examine the possible function of the 48 kDa protein fetuin in the serum-driven calcification of collagen matrices. Our working hypothesis was that fetuin promotes calcification within the collagen fibril by selectively inhibiting apatite growth outside of the fibril. This hypothesis is supported by the observation that fetuin is the most abundant serum inhibitor of apatite crystal growth (Jahnen-Dechent et al. (1997)J. Biol. Chem. 272: 31496-31503; Schinke et al. (1996) J. Biol. Chem. 271: 20789-20796), and by the observation that fetuin is too large to penetrate the interior of the collagen fibril (Toroian et al. (2007) J. Biol. Chem. 282: 22437-22447) where serum-induced collagen calcification occurs (Price et al. (2004) J. Biol. Chem. 279: 19169-19180). The present study tests this hypothesis by examining the impact of removing fetuin from serum on the ability of serum to mineralize the collagen fibril. The results of this test show that the presence of fetuin in serum determines the location of serum-driven mineralization: in the presence of fetuin, mineral forms only within the collagen fibril; in the absence of fetuin, mineral forms only in the solution outside the fibril.

Because fetuin is the subject of this study, it is useful to review briefly its structure, occurrence, and calcification-inhibitory activity. Fetuin is a 48 kDa glycoprotein that consists of 2 N-terminal cystatin domains and a smaller C-terminal domain. The five oligosaccharide moieties of the protein account for ˜25% of fetuin's mass and, because of their disordered structures, give fetuin an apparent size in SDS gel electrophoresis and Sephacryl gel filtration of about 59 kDa. Fetuin is synthesized in the liver and is found at high concentrations in mammalian serum (Pedersen (1944) Nature 154: 575-580; Brown et al. (1992) BioEssays 14: 749-755) and bone (Ashton et al. (1974) Eur. J. Biochem. 45: 525-533; Ashton et al. (1976) Calcif. Tiss. Res. 22: 27-33; Quelch et al. (1984) Calcif: Tissue Int. 36: 545-549; Mizuno et al. (1991) Bone and Mineral 13: 1-21; Ohnishi et al. (1991) J. Biol. Chem. 266: 14636-14645; Wendel et al. (1993) Matrix 13: 331-339). The serum fetuin concentration in adult mammals ranges from 0.5 to 1.5 mg/ml, while the serum fetuin concentration in the fetus and neonate is typically far higher (Brown et al. (1992) BioEssays 14: 749-755). Fetuin is also one of the most abundant non-collagenous proteins found in bone (Ashton et al. (1974) Eur. J. Biochem. 45: 525-533; Ashton et al. (1976) Calcif: Tiss. Res. 22: 27-33; Quelch et al. (1984) Calcif. Tissue Int. 36: 545-549; Mizuno et al. (1991) Bone and Mineral 13: 1-21; Ohnishi et al. (1991) J. Biol. Chem. 266: 14636-14645; Wendel et al. (1993) Matrix 13: 331-339), with a concentration of about 1 mg fetuin per g bone in rat (Ohnishi et al. (1991) J. Biol. Chem. 266: 14636-14645), bovine (Ashton et al. (1974) Eur. J. Biochem. 45: 525-533), and human (Quelch et al. (1984) Calcif. Tissue Int. 36: 545-549; Dickson et al. (1975) Nature 256: 430-432) bone. In spite of the abundance of fetuin in bone, however, it has not been possible to demonstrate the synthesis of fetuin in calcified tissues, and it is therefore presently thought that the fetuin found in bone arises from hepatic synthesis via serum (Mizuno et al. (1991) Bone and Mineral 13: 1-21; Wendel et al. (1993) Matrix 13: 331-339). This view is supported by the observation that fetuin binds strongly to apatite, the mineral phase of bone, and is selectively concentrated from serum onto apatite in vitro (Ashton et al. (1976)Calcif Tiss. Res. 22: 27-33).

In vitro studies have demonstrated that fetuin is an important inhibitor of apatite growth and precipitation in serum containing increased levels of calcium and phosphate (Schinke et al. (1996)J. Biol. Chem. 271: 20789-20796), and that targeted deletion of the fetuin gene reduces the ability of serum to arrest apatite formation by over 70% (Jahnen-Dechent et al. (1997)J. Biol. Chem. 272: 31496-31503). More recent studies have shown that a fetuin-mineral complex is formed in the course of the fetuin-mediated inhibition of apatite growth and precipitation in serum containing increased calcium and phosphate (Price and Lim (2003) J. Biol. Chem. 278: 22144-22152). Purified bovine fetuin has also been shown to be a potent inhibitor of the growth and precipitation of a calcium phosphate mineral phase from supersaturated solutions of calcium phosphate ( ) Schinke et al. (1996) J. Biol. Chem. 271: 20789-20796, and recent studies have shown that a fetuin mineral complex is formed in the course of this inhibition (Price and Lim (2003)J. Biol. Chem. 278: 22144-22152).

### Experimental Procedures

Materials.

Forty-day-old and newborn albino rats (Sprague-Dawley derived) were purchased from Harlan Labs. Adult bovine serum was purchased from Invitrogen. Each 500 ml volume of Dulbecco's modified eagle medium (DMEM; Gibco) was supplemented with 5 ml of penicillin-streptomycin (Gibco) and 1 ml of 10% sodium azide to prevent bacterial growth. Unless otherwise stated, the concentration of phosphate in DMEM was increased from the basal 0.9 mM to a final 2 mM by the addition of 0.5 M sodium phosphate buffer pH 7.4. When prepared as described (Price et al. (2006) Arterioscler. Thromb. Vasc. Biol. 26: 1079-1085), DMEM containing 2 mM phosphate is stable for at least 3 weeks at 37° C., with no evidence for loss of calcium or phosphate from the medium or formation of a mineral phase. Bovine fetuin, purified type I collagen from bovine achilles tendon, and Alizarin red S were purchased from Sigma.

Rats were killed by exsanguination while under isoflurane anesthetic; the UCSD Animal Subjects Committee approved all animal experiments. Tail tendons were dissected from 40-day-old rats and tibias were dissected from newborn rats. Both tissues were extracted with a 1000-fold excess (v/w) of 0.5 M EDTA pH 7.5 for 72 h at room temperature to kill cells and remove any mineral that might be present; the tissues were then washed exhaustively with ultra pure water to remove all traces of EDTA and stored at −20° C. until use.

Calcification Procedures.

Experiments to examine the calcification of collagen matrices were carried out using 24-well cell culture clusters (Costar 3524, Corning) in a humidified incubator at 37° C. and 5% CO₂. Each well contained a 1 ml volume of DMEM alone or of DMEM containing 10% bovine serum or fetuin-depleted bovine serum. The amount of matrix added to each 1 ml volume was: a single hydrated, demineralized newborn rat tibia; a portion of tail tendon (3 mg dry weight; hydrated before use); or a portion of type I collagen (3 mg dry weight; hydrated before use). Each tissue was then incubated for 6 days.

Biochemical Analyses.

The procedures used for Alizarin red staining have been described (Price et al. (2006) Kidney Internat. 70: 1577-1583). For histological analyses, tibias were fixed in 100% ethanol for at least 1 day at room temperature; San Diego Pathology Inc. (San Diego, Calif.) sectioned and von Kossa stained the tibias. For quantitative assessment of the extent of calcification, Alizarin red stained matrices and precipitates formed outside the matrix were extracted for 24 h at room temperature with 1 ml of 0.15 M HCl, as described (Price et al. (2006) Kidney Internat. 70: 1577-1583). Calcium levels in culture media and in the acid extracts of tissues and precipitates were determined colorimetrically using cresolphthalein complexone (JAS Diagnostics, Miami Fla.) and phosphate levels were determined colorimetrically as described (Chen et al. (1956) Anal. Chem. 28: 1756-1758).

Powder X-ray diffraction was used to compare the mineral phase formed in fetuin-depleted serum with the crystals isolated from rat bone (Weiner and Price (1986) Calcif. Tiss. Intern. 39: 365-375). The mineral was generated by incubating 2 ml DMEM containing 10% fetuin-depleted bovine serum for 48 h at 37° C. The mineral suspension was diluted to 20 ml with fresh DMEM and incubated for another 48 hours, and the resulting 20 ml of mineral suspension was subsequently diluted to 200 ml with fresh DMEM and incubated for a final 48 hours. The mineral was collected by centrifugation, washed with ethanol, and dried to give 23 mg of mineral. The XRD spectrum of this mineral was measured with Cu Kα X-rays (λ=1.54 Å) using a Rigaku Miniflex diffractometer.

### Immunological Procedures

Rabbits were immunized against purified bovine fetuin. The procedures employed for the bovine fetuin radioimmunoassay used this antiserum at a final 1:2000 dilution. The radioimmunoassay diluent, sample volumes, and procedures are identical to those used in the rat fetuin radioimmunoassay (Price et al. (2003)J. Biol. Chem. 278: 22153-22160). For affinity purification of anti fetuin antibody, 16 mg of purified bovine fetuin were covalently attached to 5 ml of cyanogen bromide activated Sepharose 4B (Amersham Biosciences) and packed into a column. 10 ml of anti fetuin antiserum was than passed over this fetuin affinity column, and the bound antibody was eluted with 100 mM glycine pH 2.5. An anti-fetuin antibody column was subsequently prepared by covalently attaching 7 mg of purified anti fetuin antibody to 5 ml of CNBr-activated Sepharose 4B. The anti-fetuin antibody column was then equilibrated with the DMEM calcification buffer, and bovine serum was dialyzed against the same buffer. Adult bovine serum was freed of fetuin by passing 0.85 ml aliquots of dialyzed serum over the column at room temperature. The absorbance at 280 nm of each 0.8 ml fraction was then determined, and the fetuin content of the fractions was measured by radioimmunoassay. The 4 fractions with the highest absorbance were pooled, and then diluted with DMEM until the absorbance at 280 nm equaled that of 10% bovine serum. Protein bound to the column was removed by washing the column with 100 mM glycine pH 2.5 and collecting 1 ml fractions in tubes that contained 0.1 ml of 0.1 M Tris pH 8. The desorbed protein was dialyzed against 5 mM ammonium bicarbonate and dried; a portion of the desorbed protein was electrophoresed using a 4 to 12% polyacrylamide gel, as described (Price et al. (2003)J. Biol. Chem. 278: 22153-22160).

The 10% control serum used in these studies was prepared by the same procedures, with the sole exception being that the control column was prepared by covalently attaching 7 mg of purified rabbit IgG (Sigma) to 5 ml of CNBr-activated Sepharose 4B rather than 7 mg of rabbit anti-bovine fetuin antibody. 0.85 ml aliquots of dialyzed adult bovine serum were passed over the control column at room temperature, and the 4 fractions with the highest absorbance were pooled and diluted with DMEM until the absorbance at 280 nm equaled that of 10% bovine serum.

### Results

Removal of Fetuin from Bovine Serum by Antibody Affinity Chromatography.

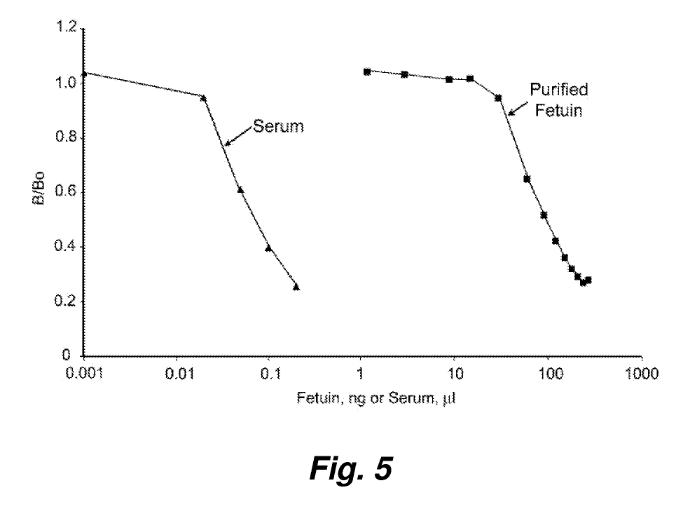

We developed procedures to remove fetuin from bovine serum by antibody affinity chromatography in order to evaluate the possible role of the protein in serum-induced calcification. Rabbits were immunized with purified bovine fetuin, and the resulting antisera were used to construct a radioimmunoassay for bovine fetuin that could be used to monitor the effectiveness of fetuin depletion procedures (FIG. 5). Polyclonal anti fetuin antibodies were purified from the rabbit antiserum using Sepharose 4B with covalently attached bovine fetuin, and the resulting purified anti fetuin antibodies were then attached covalently to Sepharose 4B and packed into a column.

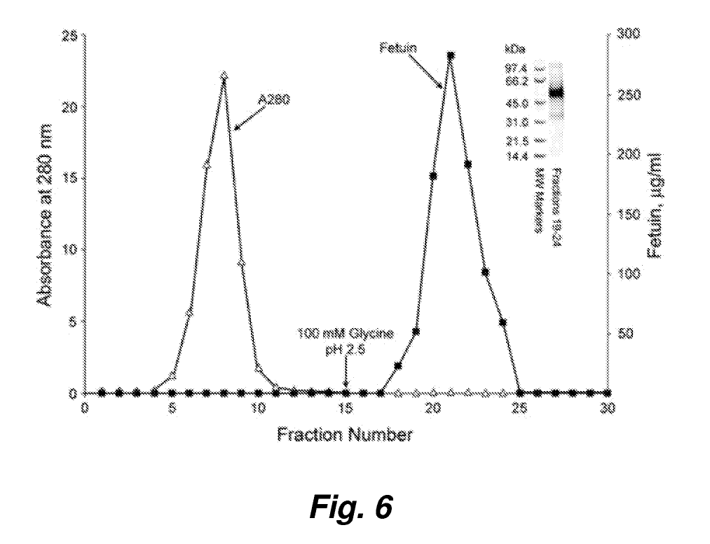

Because the goal of fetuin removal from serum was to test its role in serum-induced calcification, we used a suitable buffer for study of serum-induced calcification (Hamlin and Price (2004) Calcif. Tiss. Internat. 75: 231-242; Price et al. (2004)J. Biol. Chem. 279: 19169-19180), DMEM culture medium, to equilibrate the anti fetuin antibody column. Adult bovine serum was then dialyzed against DMEM and passed over this column to remove fetuin. The results of a typical experiment are shown in FIG. 6. As can be seen, there is a massive peak of unbound serum protein absorbance that elutes at the column volume; this unbound protein peak accounts for about 98% of the A280 applied to the column and is devoid of fetuin. The four fractions with the highest absorbance were pooled; calcification solutions containing fetuin-depleted bovine serum were then prepared by diluting these pooled fractions with DMEM to yield a final serum concentration of 10% by absorbance. The 10% control bovine serum used in these studies was prepared by a similar procedure, with the sole difference being that the control column was prepared by covalently attaching purified normal rabbit IgG to Sepharose rather than rabbit anti-bovine fetuin antibody. Table 9 shows that the fetuin content of the resulting fetuin-depleted 10% bovine serum is over 1000-fold lower than the fetuin content of the 10% control bovine serum.

TABLE 9
The concentration of fetuin in the experimental calcification solutions
used in these studies. The concentrations of bovine fetuin were
determined by radioimmunoassay in each of the experimental solutions
employed in this study: 10% control bovine serum in DMEM culture
medium; 10% fetuin-depleted bovine serum in DMEM; and 10% fetuin-
depleted bovine serum in DMEM containing 130 μg/ml of purified
bovine fetuin. Each sample was assayed in triplicate.

| Additions to DMEM | Fetuin (μg/ml) |
|---|---|
| 10% Control bovine serum | 126.0 ± 3.2 |
| 10% Fetuin depleted serum | <0.1 |
| 10% Fetuin depleted serum, supplemented | 139.8 ± 9.9 |
| with purified fetuin | |

After elution of those proteins that did not bind to the column, the anti fetuin antibody column was washed with DMEM until the absorbance at 280 nm was less than 0.01, and bound fetuin was then eluted from the column by washing with acid (FIG. 6). The resulting small peak of A280 nm absorbance (not evident in the scale used for FIG. 6) accounted for about 1% of the initial serum absorbance. The amount of fetuin immunoreactivity in this peak corresponded to the fetuin content of the serum applied to the column, and the SDS gel of the bound protein fraction revealed a single major component in the 59 kDa position expected for fetuin (Price et al. (2003)J. Biol. Chem. 278: 22153-22160).

Evidence that Fetuin is Required for the Serum-Induced Re-Calcification of Demineralized Bone.

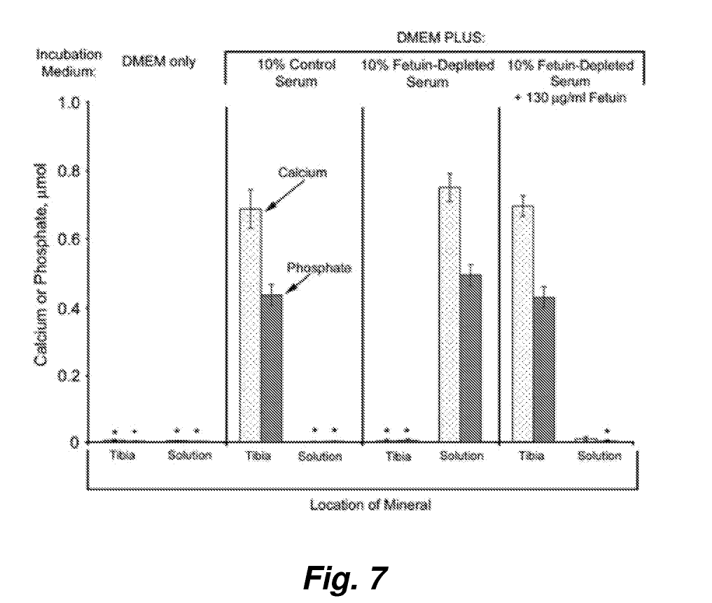

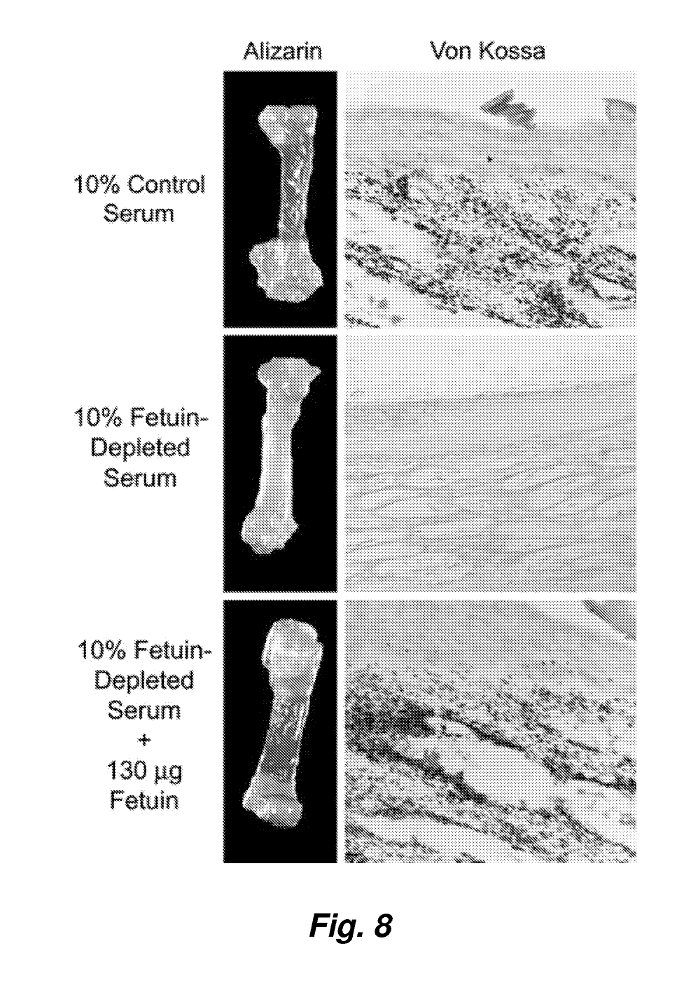

In the initial study, the impact of fetuin depletion on serum-induced calcification was evaluated by incubating demineralized newborn rat tibias for 6 days at 37° C. in DMEM alone, in DMEM containing 10% control bovine serum, or in DMEM containing 10% fetuin-depleted bovine serum. In agreement with earlier studies (Hamlin and Price (2004)Calcif. Tiss. Internat. 75: 231-242; Price et al. (2004)J. Biol. Chem. 279: 19169-19180), demineralized tibias calcified after incubation in DMEM containing 10% serum but did not calcify after incubation in DMEM alone (FIGS. 7 and 8). The pattern of Alizarin red staining in the tibias incubated in DMEM containing 10% control serum matches that seen in the original tibia prior to demineralization (not shown; see (Id.) for examples).

In contrast to tibias incubated in 10% control serum, tibias incubated in 10% fetuin-depleted serum did not have significant incorporation of calcium and phosphate (FIG. 7) and did not stain for calcification by Alizarin red (FIG. 8); histological sections of these tibias also revealed no von Kossa staining for calcification (FIG. 8). Removal of fetuin from serum therefore eliminates the serum-induced re-calcification of demineralized bone.

To confirm the essential role of fetuin in serum-induced calcification, we added sufficient purified bovine fetuin to the fetuin-depleted bovine serum in order to attain a final fetuin concentration comparable to that found in the original serum prior to fetuin depletion and in the 10% bovine serum control (see Table 9). The calcification of tibias incubated in this fetuin-repleted serum was indistinguishable from the calcification of tibias incubated in the 10% bovine serum control: the pattern of Alizarin red staining was identical (FIG. 8), the amount of calcium and phosphate incorporated was comparable (FIG. 7), and the von Kossa staining was restricted to the collagen matrix (FIG. 8). Comparable results were obtained when fetuin purified during the course of the preparation of fetuin-depleted serum (see FIG. 6 inset) was substituted for commercial fetuin (data not shown). The addition of purified fetuin therefore fully restores the ability of fetuin-depleted serum to induce the re-calcification of a demineralized tibia.

In the course of these experiments, we noticed the presence of a fine precipitate coating the entire bottom of each culture well that contained a tibia incubated in DMEM plus 10% fetuin-depleted serum (not shown); no precipitate could be detected in wells that contained a tibia incubated in DMEM alone, in wells that contained a tibia incubated in DMEM plus 10% control bovine serum, or in wells that contained a tibia incubated in DMEM plus 10% fetuin-depleted serum supplemented with purified bovine fetuin. To assess the nature of this precipitate, the precipitate was collected, stained with Alizarin red, and analyzed for calcium and phosphate. This analysis showed that the precipitate isolated from the wells containing 10% fetuin-depleted serum stained intensely with Alizarin red and that the amounts of calcium and phosphate recovered from the precipitate were comparable to the amounts incorporated into tibias that had been incubated in DMEM containing 10% serum or 10% fetuin-repleted serum (FIG. 7). This result suggests that the role of fetuin in the serum-induced re-calcification of demineralized bone is to direct mineral formation into the collagen matrix of bone.

In order to determine the dependence of collagen calcification on fetuin dose, we repeated the above experiments using fetuin-depleted serum containing different added fetuin concentrations (data not shown). The results of this experiment showed that tibias incubated with 130 and 100 μg/ml fetuin stained with Alizarin red and contained amounts of calcium and phosphate comparable to the values shown in FIG. 7, while there was no detectable mineral precipitate outside the tibia. In contrast, tibias incubated with 0, 10, and 40 μg/ml fetuin did not stain with Alizarin red and did not contain detectable calcium or phosphate, and there was a mineral precipitate outside the tibia that contained calcium and phosphate comparable to the values shown in FIG. 7. The tibia incubated with 70 μg/ml fetuin was stained with Alizarin red and there was also a detectable mineral precipitate outside the tibia; chemical analysis of the tibia and precipitate showed that 73% of the mineral was in the tibia and 27% of the mineral was in the precipitate.

A final experiment was carried out to evaluate the effect of reducing the phosphate concentration of the DMEM medium from 2 mM to 0.9 mM (Hamlin and Price (2004) Calcif. Tiss. Internat. 75: 231-242). This experiment showed that tibias do not calcify when incubated in DMEM (0.9 mM Pi) containing 10% control bovine serum, 10% fetuin-depleted bovine serum, or 10% fetuin-depleted serum plus added fetuin (not shown). There was also no evidence for a mineral precipitate in any condition. These results demonstrate that the serum-induced formation of a mineral phase in DMEM will not occur unless the phosphate content of the DMEM medium is at the 2 mM concentration found in bovine serum.

Evidence that Fetuin is Required for the Serum-Induced Calcification of Tendons and Purified Collagen.

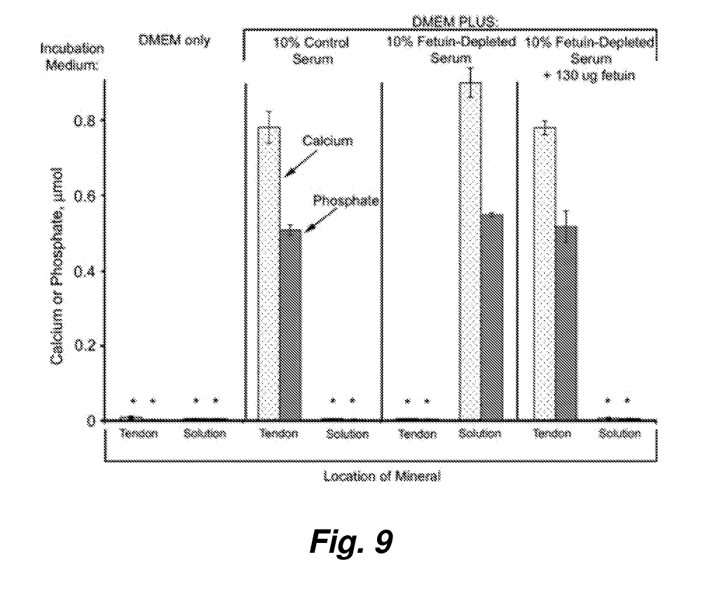

Additional experiments were carried out to further explore the role of fetuin in the serum-induced calcification of collagenous matrices. One test examined the role of fetuin in the serum-induced calcification of rat tail tendon, a type I collagen matrix that is chemically identical to the type I collagen matrix of bone but does not normally calcify in rats. Tendons incubated in 10% control bovine serum calcified; tendons incubated in 10% fetuin-depleted serum did not calcify, and tendons incubated in 10% fetuin-depleted serum containing purified fetuin calcified (FIG. 9). There was again a fine precipitate coating the bottom of all wells containing fetuin-depleted serum, and the amount of calcium and phosphate in this precipitate was comparable to that found in tendons incubated in 10% serum that contained fetuin (FIG. 9).

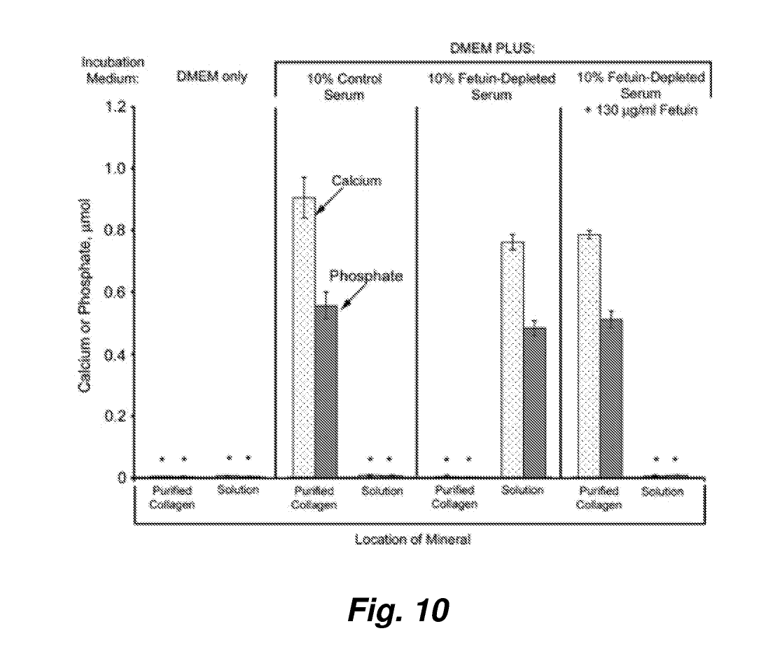

Another test examined the role of fetuin in the serum-induced calcification of purified type I collagen fibers from bovine Achilles tendon. Purified collagen fibers incubated in 10% control bovine serum calcified; fibers incubated in 10% fetuin-depleted serum did not calcify, and fibers incubated in 10% fetuin-depleted serum containing purified fetuin calcified (FIG. 10). There was a fine precipitate coating the entire bottom of all wells containing fetuin-depleted serum, and the amount of calcium and phosphate in this precipitate was comparable to that found in collagen fibers incubated in 10% serum containing fetuin (FIG. 10).

The Ca/Pi ratio was calculated for the mineral phase formed in each of the above experiments. The Ca/Pi ratio of the mineral phase formed within a collagen matrix after incubation in 10% serum was 1.59±0.15 (mean±SD; n=9: combined data for FIGS. 3, 5, and 6); the Ca/Pi ratio for the mineral phase precipitated outside of a matrix after incubation in 10% fetuin-depleted serum was 1.56±0.09 (n=9); and the Ca/Pi ratio for the mineral phase formed within collagen after incubation in 10% fetuin-depleted serum with added fetuin was 1.58±0.10 (n=9). These Ca/Pi ratios are not significantly different from one another, and are comparable to the Ca/Pi ratio previously found for the mineral phase deposited in collagen after incubation in serum (Hamlin and Price (2004) Calcif. Tiss. Internat. 75: 231-242; Hamlin et al. (2006) Calcif. Tissue Int. 76: 326-334; Price et al. (2004)J. Biol. Chem., 279(18): 19169-19180), and to the ratio found in bone (Driessens and Verbeeck (1990) Biominerals. CRC Press, Boca Raton; Elliott (1994) Structure and chemistry of the apatites and other calcium orthophosphates. Elsevier, The Netherlands).

Taken together, these results show that fetuin plays a similar essential role in the serum-induced calcification of the type I collagen fibers in a tissue that was once calcified (demineralized bone), a tissue that does not normally calcify (tendon), and in purified collagen. In each case the essential role of fetuin in the serum-induced calcification is to direct mineral formation into the collagen matrix, and it appears to do this by preventing mineral precipitation outside of this matrix.

Evidence that the Removal of Fetuin from Serum Unmasks a Potent Serum Nucleator of Mineral Formation.

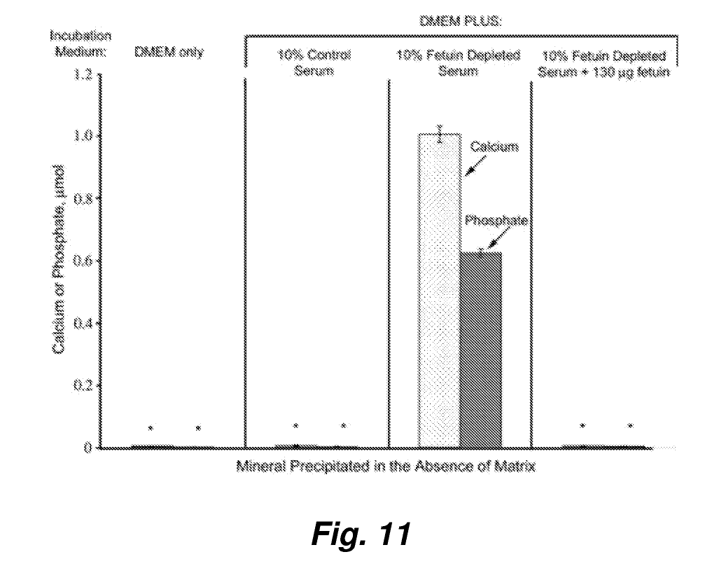

In each of the above experiments, the removal of fetuin from serum prevented the calcification of the collagen matrix, but led to the formation of a fine precipitate of a calcium phosphate mineral on the bottom of the well. In order to see if the formation of this precipitate is dependent on the presence of a matrix, this experiment was repeated using the same calcification solutions but no matrix. A fine precipitate coated the entire bottom of all wells that contained DMEM plus 10% fetuin-depleted serum, while no precipitate could be detected in the wells that contained DMEM alone, DMEM plus 10% control bovine serum, or DMEM with 10% fetuin-depleted serum plus added purified fetuin. This precipitate stained intensely with Alizarin red and chemical analysis showed that it contained calcium and phosphate (FIG. 11) in amounts comparable to those previously seen in wells that contained fetuin-depleted serum and a collagen matrix. This result demonstrates that the formation of a precipitate in DMEM containing 10% fetuin-depleted serum is not dependent on the presence of a collagen matrix. The removal of fetuin from serum therefore appears to unmask a potent serum initiator of calcium phosphate mineral formation.

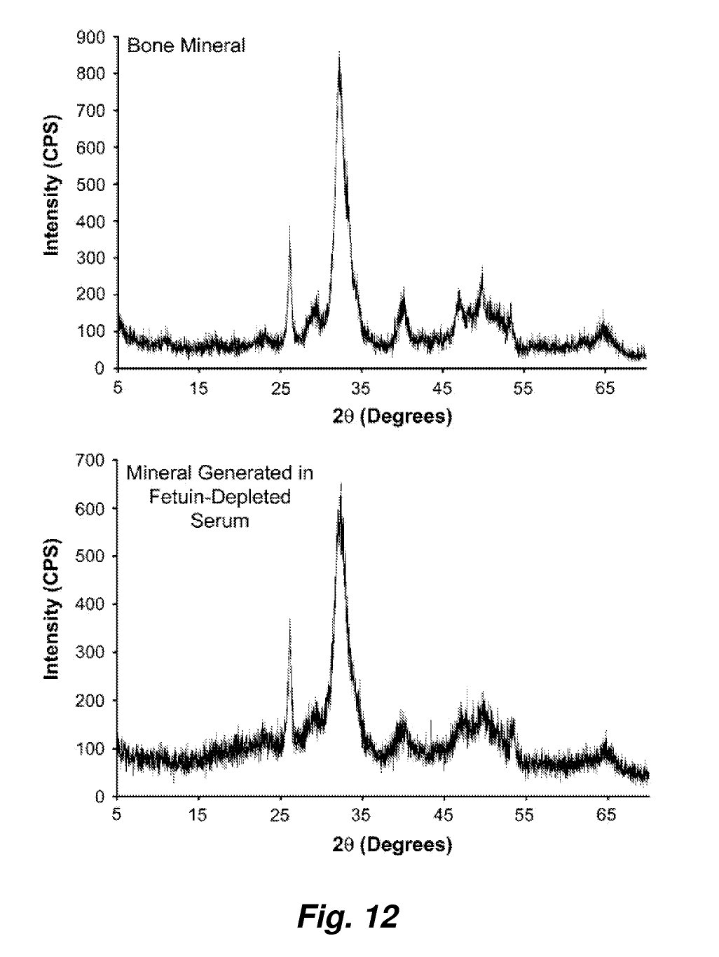

Powder X-ray diffraction was used to characterize the mineral that forms during incubation of DMEM containing fetuin-depleted serum. As can be seen in FIG. 12, the diffraction spectrum of this mineral is comparable to the spectrum of the apatite-like crystals isolated from rat bone. Both diffraction spectra are also comparable to the spectrum previously found for the mineral phase formed in a type I collagen matrix during incubation in DMEM containing fetuin-replete serum (Hamlin and Price (2004) Calcif. Tiss. Internat. 75: 231-242; Price et al. (2004)J. Biol. Chem., 279(18): 19169-19180). The diffraction peaks seen in these spectra are in the positions expected for synthetic hydroxyapatite crystals, with no evidence for the presence of other calcium phosphate mineral phases (Elliott (1994) Structure and chemistry of the apatites and other calcium orthophosphates. Elsevier, The Netherlands). The diffraction peaks are far broader than observed for synthetic hydroxyapatite crystals. For bone, this peak broadening has been attributed to smaller crystal size and/or reduced crystallinity (Bonar et al. (1983)Calcif Tissue Int 35: 202-209; Meneghini et al. (2003) Biophysical J., 84: 2021-2029). Because the diffraction peaks for the crystals generated in fetuin-depleted serum appear to be slightly broader than the peaks for bone crystals, it is possible that the crystals generated in serum may be smaller or less ordered than those found in bone.

### Discussion

The present investigation and our recently published study were both carried out with the goal of understanding the biochemical basis for the ability of serum to induce the calcification of a type I collagen fibril. The published study demonstrates that the physical structure of the collagen fibril is such that molecules smaller than a 6 kDa protein can freely access all of the water within the fibril while molecules larger than a 40 kDa protein cannot enter the fibril. This study therefore shows that molecules smaller than a 6 kDa protein can enter the fibril and interact directly with mineral to influence crystal growth, while molecules larger than a 40 kDa protein cannot enter the fibril and so have no ability to act directly on the apatite crystals growing within the fibril.

The serum calcification activity that induces calcification of the collagen fibril consists of one or more proteins that are 50 to 150 kDa in molecular weight. Since these molecules are too large to penetrate the collagen fibril, there must be mechanisms by which proteins that act only outside the fibril can cause calcification to occur specifically within the fibril. One possibility is that large inhibitors of apatite growth favor mineralization within the fibril by selectively preventing apatite growth outside of the fibril. In addition, large nucleators of apatite formation may generate small crystal nuclei outside of the collagen fibril that subsequently diffuse into the fibril and grow. The present study tests these hypotheses for the possible function of large molecules in mineralization.

Our working hypothesis was that the serum protein fetuin promotes calcification within the collagen fibril by selectively inhibiting apatite growth outside of the fibril, and we tested this hypothesis by examining the impact of removing fetuin from serum on the ability of serum to mineralize the collagen fibril. The results of this study reveal that removing fetuin from serum completely prevents the serum-driven calcification of a type I collagen matrix. Removing fetuin from serum does not prevent the serum-driven formation of mineral, however, because a comparable amount of apatite-like mineral consistently forms on the bottom of all wells that contain fetuin-depleted serum (FIG. 12). The results of these experiments therefore support our working hypothesis, namely that large protein inhibitors of apatite growth such as fetuin can favor mineralization of the collagen fibril by selectively preventing apatite growth outside of the fibril. The net effect of this fetuin activity is extraordinary: all of the calcium and phosphate ions that, in the absence of fetuin, are incorporated into a mineral that forms throughout the ˜1 ml volume that lies outside the fibril are, in the presence of fetuin, incorporated into a mineral that forms within the ˜5 ul volume of water that lies within the 3 mg collagen in the well.

Previous in vitro studies using pure fetuin in solutions containing high levels of calcium and phosphate provide an insight into how fetuin may act to direct apatite growth within the collagen fiber. In these experiments, solutions were prepared that substantially exceed the calcium phosphate ion product required for homogeneous formation of an apatite-like mineral phase, and in the absence of fetuin a mineral phase forms in minutes (Price and Lim (2003)J. Biol. Chem. 278: 22144-22152). When fetuin is added to these solutions, no mineral phase precipitates, no mineral phase can be sedimented by high speed centrifugation, and the solution remains clear for about 24 hours. At this time the solution becomes opalescent and a fetuin-mineral complex can, for the first time, be sedimented from the solution by centrifugation (Id.). Measurement of ionic calcium and phosphate levels during the first 24 hours further show that small amounts of a mineral phase still form in the presence of fetuin, and that the role of fetuin is to form a complex with these nascent mineral nuclei that retards their growth and prevents their precipitation (or sedimentation in a centrifuge) (Id.). Purified fetuin therefore does not prevent mineral nuclei from forming in this homogeneous nucleation system. It traps the nascent mineral nuclei and dramatically retards their growth.

We believe that the role of fetuin in serum-driven calcification of a type I collagen matrix is similar to its action on a homogeneous apatite nucleation system: fetuin traps mineral nuclei and retards their growth. The major difference is that mineral nuclei are generated by the serum nucleator activity, not by a high calcium phosphate ion product. The serum nucleator elutes from a gel filtration column in the position expected for proteins 50 to 150 kDa in size, and is therefore clearly too large to physically penetrate the collagen fibril. The products of nucleator action outside the fibril are presumably small crystal nuclei, however, and even apatite crystals up to 12 unit cells in size should in principle be able to freely access all of the water within the fibril (see Introduction). Since fetuin can only trap those nuclei that it can access, the crystal nuclei that penetrate the fibril are free to grow far more rapidly than those nuclei trapped by fetuin outside of the fibril, and the collagen fibril therefore selectively calcifies. When fetuin is removed from serum, the same number of mineral nuclei still form, and some of these no doubt still penetrate the fibril. All crystal nuclei are now free to grow, however. Because the vast majority of the nuclei are in the solution outside of the fiber, the only mineral formed in amounts that can be detected is the mineral precipitate found on the bottom of the well, not mineral within the fibril.

The phenotype of the fetuin deficient mouse is consistent with the effects of fetuin depletion on serum found in the present study. Fetuin knockout mice have multiple calcium phosphate mineral deposits in a variety of soft tissues, particularly those involved in the transport or filtration of blood; these deposits are not within collagen fibrils (14. Jahnen-Dechent et al. (1997)J. Biol. Chem. 272: 31496-31503; Schafer et al. (2003) J. Clin. Invest. 112: 357-366; Westenfeld et al. (2007) Nephrol Dial Transplant 22(6):1537-1546). Our results demonstrate that the removal of fetuin from serum results in the formation of calcium phosphate crystals throughout serum and the absence of mineral formation within collagen. The close parallel between the effects of fetuin depletion in vivo and in vitro suggests that the serum nucleator of mineral formation unmasked by fetuin depletion in vitro may be responsible for the formation of the soft tissue mineral deposits seen in the fetuin knock out mouse.

### Summary and Conclusion: a Hypothesis for the Mechanism of Normal Bone Mineralization.

The present study was carried out to understand the mechanism by which a serum calcification factor activity consisting of proteins 50 to 150 kDa in size is able to drive the calcification of a collagen fibril. The results of this study show that serum calcification factor activity consists of at least two large proteins, neither of which can penetrate the collagen fibril. One as yet unidentified protein generates crystal nuclei outside of the fibril, some of which then diffuse into the fibril. The other protein, fetuin, inhibits the growth of crystal nuclei that remain in the solution outside of the fibril, thereby freeing calcium and phosphate ions for crystal growth within the fibril. We propose the term ‘Shotgun Mineralization’ for this calcification mechanism: Crystals form throughout the solution, and only those that diffuse into a mineralizable matrix grow.

It is possible that mineralization of the collagen fibril occurs by a similar mechanism in vivo. Nucleators too large to penetrate the fibril may generate small crystals near the mineralization front, some of which penetrate the fibril, and large crystal growth inhibitors may bind to crystals that remain in the solution outside of the fibril, thereby ensuring that only crystals within the fibril can grow. As with many other critical processes in biochemical physiology, there are probably multiple layers of redundancy in the process of normal bone mineralization. Bone is known to contain a number of large inhibitors of apatite crystal growth in addition to fetuin, a redundancy in function that could account for the apparently normal calcification of the collagen fibril in the fetuin knock out mouse (Jahnen-Dechent et al. (1997)J. Biol. Chem. 272: 31496-31503). In addition to the serum nucleator activity, nucleators may include large proteins such as bone sialoprotein (Tye et al. (2003)J. Biol. Chem. 278: 7949-7955; Midura et al. (2004)J. Biol. Chem 279: 25464-25473) as well as large structures such as matrix vesicles (Anderson (1995) Clinical Orthopaedics and Related Research 314: 266-280).

The fetuin-depleted serum assay developed here can be used to search for other bone macromolecules that, when added to fetuin-deficient serum, restore the serum-driven calcification of the collagen fibril and prevent the growth and precipitation of mineral outside of the fibril. DMEM plus purified fetuin can be used as a test system to evaluate the ability of different bone macromolecules to generate crystal nuclei outside of the fibril that are small enough to penetrate the fibril and grow. Other studies will be needed to determine whether the initial serum-induced mineral forms within the hole region of the collagen fibril (the location of initial crystal formation in vivo), to compare the size and shape of the crystals within the fibril with the crystals found in normal bone, and to see if the mechanical properties of demineralized bone that has been fully re-calcified by incubation in serum (Price et al. (2004)J. Biol. Chem., 279(18): 19169-19180) are comparable to those of the original bone prior to demineralization.

### Example 3

### Mineralization by Inhibitor Exclusion: the Calcification of Collagen with Fetuin

One of our goals is to understand the mechanisms that deposit mineral within collagen fibrils, and as a first step we recently determined the size exclusion characteristics of the fibril. This study revealed that apatite crystals up to 12 unit cells in size can access the water within the fibril while molecules larger than a 40 kDa protein are excluded. We proposed a novel mechanism for fibril mineralization based on these observations: that macromolecular inhibitors of apatite growth favor fibril mineralization by selectively inhibiting crystal growth in the solution outside of the fibril.

To test this mechanism, we developed a system in which crystal formation is driven by homogeneous nucleation at high calcium phosphate concentration and the only macromolecule in solution is fetuin, a 48 kDa inhibitor of apatite growth. Our experiments with this system demonstrate that fetuin determines the location of mineral growth: in fetuin's presence mineral grows exclusively within the fibril while in its absence mineral grows in solution outside the fibril. Additional experiments show that fetuin is also able to localize calcification to the interior of synthetic matrices that have size exclusion characteristics similar to those of collagen, and that it does so by selectively inhibiting mineral growth outside of these matrices. We term this new calcification mechanism ‘mineralization by inhibitor exclusion’: the selective mineralization of a matrix using a macromolecular inhibitor of mineral growth that is excluded from that matrix.

The type I collagen fibril plays several critical roles in bone mineralization. The mineral in bone is located primarily within the fibril (Tong et al. (2003)Calcif. Tiss. Internat. 72: 592-598; Katz and Li (1973) J. Mol. Biol. 1973: 1-15; Sasaki and Sudoh (1996)Calcif. Tissue Int., 60: 361-367; Jager and Fratzl (2000) Biophys. J., 79, 1737-1748; Landis et al. (1993) J. Structural Biol. 110, 39-54; Rubin et al. (2003) Bone 33: 270-282), and during mineralization the fibril is formed first and then water within the fibril is replaced with mineral (Robinson and Elliott (1957)J. Bone and Joint Surg. 39A: 167-188; Boivin and Meunier (2002) Calcif Tissue Int. 70: 503-511). The collagen fibril therefore provides the aqueous compartment in which mineral grows. We have recently shown that the physical structure of the collagen fibril plays an important additional role in mineralization: the role of a gatekeeper that allows molecules smaller than a 6 kDa protein to freely access the water within the fibril while preventing molecules larger than a 40 kDa protein from entering the fibril (Toroian et al. (2007)J. Biol. Chem. 282: 22437-22447).

Molecules too large to enter the collagen fibril can have important effects on mineralization within the fibril. We have suggested that large inhibitors of apatite growth can paradoxically favor mineralization within the fibril by selectively preventing apatite growth in the solution outside of the fibril (Id.). We have also proposed that large nucleators of apatite formation may generate small crystals outside the collagen fibril and that some of these crystals can subsequently diffuse into the fibril and grow (Id.). Because the size exclusion characteristics of the fibril allow rapid penetration of molecules the size of a 6 kDa protein, apatite crystals up to 12 unit cells in size should in principle be able to freely access all of the water within the fibril (Id.).

We subsequently tested these hypotheses for the role of large molecules in fibril mineralization by determining the impact of removing fetuin on the serum-driven calcification of collagen fibrils (Toroian and Price (2008) Calcified Tiss. Internat. 82: 116-126). Fetuin is the most abundant serum inhibitor of apatite crystal growth (Jahnen-Dechent et al. (1997)J. Biol. Chem. 272, 31496-31503; Schinke et al. (1996)J. Biol. Chem. 271: 20789-20796), and with a molecular weight of 48 kDa fetuin is too large to penetrate the collagen fibril (Toroian et al. (2007)J. Biol. Chem. 282: 22437-22447).

Fetuin is also termed fetuin-A (to distinguish it from a recently discovered homologue, fetuin-B (Olivier et al. (2000) Biochem. J. 350: 589-597)) and is sometimes called α2-HS glycoprotein in humans. Our working hypothesis was that fetuin is required for the serum driven calcification of a collagen fibril, and that its role is to favor calcification within the collagen fibril by selectively preventing apatite crystal growth in the solution outside the fibril.

The results of this study demonstrate that removing fetuin from serum eliminates the ability of serum to induce the calcification of a type I collagen matrix, and that adding purified fetuin to fetuin-depleted serum restores this activity. This study further shows that a massive mineral precipitate forms during the incubation of fetuin-depleted serum, but not during the incubation of serum containing fetuin.

These observations are consistent with the hypothesis that a large serum nucleator generates apatite crystals in the solution outside of the collagen fibril, some of which penetrate into the aqueous interior of the fibril. Since fetuin can only trap those nuclei that it can access, the crystal nuclei that penetrate the fibril grow far more rapidly than those nuclei trapped by fetuin outside of the fibril, and the collagen fibril therefore selectively calcifies.

The goal of the present experiments was to further understand the role of fetuin in the calcification of type 1 collagen fibrils. To accomplish this goal, we developed a system in which crystal formation is driven by homogeneous nucleation at high calcium phosphate concentrations, and the only macromolecule in the solution is fetuin. This system allowed us to probe the impact of fetuin and only fetuin on the location and extent of collagen calcification.

Because fetuin is the subject of this study, it is useful to review briefly its occurrence and calcification-inhibitory activity. Fetuin is a 48 kDa glycoprotein that is synthesized in the liver and is found at high concentrations in mammalian serum (Pedersen (1944) Nature 154: 575-580; Brown et al. (1992) BioEssays 14: 749-755) and bone (Ashton et al. (1974) Eur. J. Biochem. 45: 525-533; Ashton et al. (1976)Calcif. Tiss. Res. 22: 27-33; Quelch et al. (1984)Calcif. Tissue Int. 36: 545-549; Mizuno et al. (1991) Bone and Mineral 13: 1-21; Ohnishi et al. (1991)J. Biol. Chem. 266(22): 14636-14645; Wendel et al. (1993) Matrix 13: 331-339). The serum fetuin concentration in adult mammals ranges from 0.5 to 1.5 mg/ml, while the serum fetuin concentration in the fetus and neonate is typically far higher (Brown et al. (1992) BioEssays 14: 749-755). Fetuin is also one of the most abundant non-collagenous proteins found in bone (Ashton et al. (1974) Eur. J. Biochem. 45: 525-533; Ashton et al. (1976)Calcif. Tiss. Res. 22: 27-33; Quelch et al. (1984)Calcif. Tissue Int. 36: 545-549; Mizuno et al. (1991) Bone and Mineral 13: 1-21; Ohnishi et al. (1991)J. Biol. Chem. 266(22): 14636-14645; Wendel et al. (1993) Matrix 13: 331-339), with a concentration of about 1 mg fetuin per g bone in rat (Ohnishi et al. (1991)J. Biol. Chem. 266(22): 14636-14645), bovine (Ashton et al. (1974) Eur. J. Biochem. 45: 525-533), and human (Quelch et al. (1984)Calcif. Tissue Int. 36: 545-549; Dickson et al. (1975) Nature 256: 430-432) bone. In spite of the abundance of fetuin in bone, however, it has not been possible to demonstrate the synthesis of fetuin in calcified tissues, and it is therefore presently thought that the fetuin found in bone arises from hepatic synthesis via serum (Mizuno et al. (1991) Bone and Mineral 13: 1-21; Wendel et al. (1993) Matrix 13: 331-339).

This view is supported by the observation that fetuin binds strongly to apatite, the mineral phase of bone, and is selectively concentrated from serum onto apatite (Ashton et al. (1976)Calcif. Tiss. Res. 22: 27-33).

In vitro studies have demonstrated that fetuin is an important inhibitor of apatite growth and precipitation in serum containing increased levels of calcium and phosphate (Schinke et al. (1996)J. Biol. Chem. 271: 20789-20796), and that targeted deletion of the fetuin gene reduces the ability of serum to arrest apatite formation by over 70% (Jahnen-Dechent et al. (1997)J. Biol. Chem. 272, 31496-31503). More recent studies have shown that a fetuin-mineral complex is formed in the course of the fetuin-mediated inhibition of apatite growth and precipitation in serum containing increased calcium and phosphate (Price and Lim (2003)J. Biol. Chem. 278(24), 22144-22152; Heiss et al. (2008) J. Biol. Chem. 283(21): 14815-14825).

Purified fetuin also potently inhibits the growth of apatite crystals from supersaturated solutions of calcium phosphate (Schinke et al. (1996)J. Biol. Chem. 271: 20789-20796; Price and Lim (2003)J. Biol. Chem. 278(24), 22144-22152). In solutions in which a decline in calcium occurs within minutes due to spontaneous formation of apatite crystals, the presence of added fetuin sustains elevated calcium levels for at least 24 hours (Price and Lim (2003)J. Biol. Chem. 278(24), 22144-22152).

### Experimental Procedures

Materials.

Male albino rats (Sprague-Dawley derived) were purchased from Harlan Labs; Alizarin red S, bovine fetuin, acrylamide, and bisacrylamide were purchased from Sigma; and Sephadex G25 and G75 were obtained from Pharmacia (Piscataway, N.J.).

Tibias were dissected from 22-day-old rats and cut to obtain a 1 cm section of the tibia midshaft as described (Price et al. (2004)J. Biol. Chem. 279(18): 19169-19180). Bovine bone sand was prepared from the midshaft region of bovine tibias using procedures that have been described previously (Hale et al. (1991)J. Biol. Chem. 266: 21145-21149); the median diameter of the bone sand was 0.5 mm. Rat tibias and bovine bone sand were both demineralized for 72 h at room temperature in 0.5M EDTA pH 7.5 using a 300 fold molar excess of EDTA to mineral calcium, washed exhaustively with ultra pure water, dried, and stored at −20° C. until use. Tendons were obtained from the tails of 40-day-old rats as described (Price et al. (2004)J. Biol. Chem. 279(18): 19169-19180). Four mg samples of dry tendon or demineralized bone were re-hydrated by overnight equilibration in ultra pure water before use. Chondroitin sulfate A (Bovine trachea) was purchased from Calbiochem, dialyzed extensively against 50 mM NH₄HCO₃ using a 100 kDa MWCO dialysis membrane (Spectra/Por Biotech), and freeze dried. Poly-L-glutamic acid (50-100 kDa) was obtained from Sigma. The UCSD Animal Subjects Committee approved all animal experiments.

Biochemical Analyses.

The procedures used for Alizarin red staining have been described (Hamlin et al. (2006) Calcif. Tissue Int. 76: 326-334). For histological analyses, tibias were fixed in 100% ethanol for at least 1 day at room temperature; San Diego Pathology Inc. (San Diego, Calif.) sectioned and von Kossa stained the tibias. For quantitative assessment of the extent of calcification, Alizarin red stained matrices and precipitates formed outside the matrix were extracted for 24 h at room temperature with 1 ml of 0.15 M HCl, as described (Price et al. (2006) Kidney Internat. 70: 1577-1583). Calcium levels in calcification solutions and in the acid extracts of tissues and precipitates were determined colorimetrically using cresolphthalein complexone (JAS Diagnostics, Miami Fla.) and phosphate levels were determined colorimetrically as described (Chen et al. (1956) Anal. Chem. 28(11), 1756-1758).

In order to compare the ability of fetuin to penetrate synthetic matrices, each matrix was equilibrated overnight with a 5 mg/ml solution of fetuin and then stained for protein with Coomassie Brilliant Blue. Sephadex G75 beads and 4% acrylamide gels stained intensely blue, showing that fetuin penetrated both matrices. In contrast, Sephadex G25 beads and 40% acrylamide gels did not stain.

Calcification Procedures.

The typical solution used for investigating matrix calcification was prepared at room temperature using a procedure designed to achieve the near instantaneous mixing of calcium and phosphate and to thereby ensure that subsequent mineral formation occurred by homogenous nucleation in the resulting unstable solution (Price and Lim (2003)J. Biol. Chem. 278(24), 22144-22152).

One ml of 0.2M HEPES pH 7.4 containing 10 mM CaCl₂ was placed into one 10×75 mm test tube, and a second 1 ml of 0.2M HEPES pH 7.4 containing 10 mM sodium phosphate (also pH 7.4) was placed into a second tube. A disposable pipette was then used to withdraw the phosphate solution and to then expel this solution with force into the calcium solution.

All HEPES buffer solutions contained 0.02% sodium azide to prevent bacterial growth; the HEPES buffer for all fetuin-containing calcification solutions also contained 5 mg bovine fetuin per ml buffer. Unless otherwise stated, the matrices tested using this procedure were added immediately after mixing to achieve the final 5 mM calcium and phosphate conditions, and included: a 1 cm segment of hydrated, demineralized tibia midshaft from a weanling rat (dry weight about 4 mg); hydrated, demineralized bovine bone sand (4 mg dry weight); hydrated rat tail tendons (4 mg dry weight); hydrated Sephadex G25 or G75 (4 mg dry weight); and single 1×5×5 mm segments of 4 or 40% polyacrylamide slab gels (40% is 39.33 g acrylamide and 0.67 g bisacrylamide per 100 ml). To monitor the decrease in calcium due to the formation of mineral, aliquots of the calcification solution were removed at the desired times and centrifuged for 10 seconds to sediment mineral; the supernatant was then diluted 1:4 with 0.2 M HEPES pH 7.4 and analyzed for calcium.

To determine the capacity of bone for mineral, 4 mg of demineralized bovine bone sand (dry weight) was added to a 50 ml volume of fetuin calcification solution (5 mM calcium and phosphate, 0.2M HEPES pH 7.4, 45 mM NaHCO₃, 5 mg/ml fetuin, and 0.02% azide) and mixed end over end at room temperature for 2 days. For subsequent re-calcification cycles, the spent solution was replaced with fresh calcification solution and the bone sand was mixed for another 2 days. To determine the importance of demineralization to the capacity of bone for mineral, this experiment was repeated using 18 mg of non-demineralized bone sand, an amount that yields 4 mg of demineralized bone matrix.

For preparation of re-calcified bone matrix for spectroscopic analysis, 4 mg of demineralized bovine bone sand (dry weight) was again added to each of three 50 ml volumes of fetuin calcification solution and mixed end over end at room temperature for 2 days. The re-calcified bone sand was dried and ground in an agate mortar; an equivalent amount of non-demineralized bovine bone sand served as a control. The resulting powders were first analyzed using a Scintag SDF 2000 X-ray diffractometer, and a portion of this powder was then analyzed at 4 cm⁻¹ resolution for 256 scans using a Nicolet Magna IR 550 FTIR Spectrometer.

To prepare calcified tendon collagen for scanning electron microscopy, 4 mg of rat tail tendon (dry weight) was added to a 50 ml volume of fetuin calcification solution and mixed end over end at room temperature for 2 days. Samples of calcified and non-calcified tendon collagen were washed with 0.05% KOH, dehydrated in ethanol, and dried. The samples were then sputter coated with an ultra thin layer of gold/palladium and examined at 20 kV with an FEI Quanta 600 scanning electron microscope with an Oxford energy dispersive X-ray spectrometer (EDX).

### Results

Bone can be Re-Calcified by Using Fetuin to Selectively Inhibit Mineral Growth Outside the Collagen Fibril.

We first determined whether fetuin is able to selectively favor the re-calcification of the type I collagen fibrils in demineralized bone when crystal nuclei are generated by homogeneous nucleation at high calcium phosphate ion product. The high ion product solution was generated by rapidly mixing equal 1 ml volumes of 10 mM phosphate and 10 mM calcium in order to obtain a homogenous solution containing 5 mM of each ionic component in a pH 7.4 buffer. Previous studies have shown that a calcium phosphate mineral forms throughout this solution within minutes of mixing, while if fetuin is added prior to mixing there is no visible evidence of mineral formation (Schinke et al. (1996)J. Biol. Chem. 271: 20789-20796; Price and Lim (2003)J. Biol. Chem. 278(24), 22144-22152). A 1 cm segment of demineralized rat tibia midshaft was added immediately after mixing. In this 2 ml volume, there is only sufficient calcium and phosphate to restore approximately 5% of the mineral that was present in the tibia prior to demineralization.

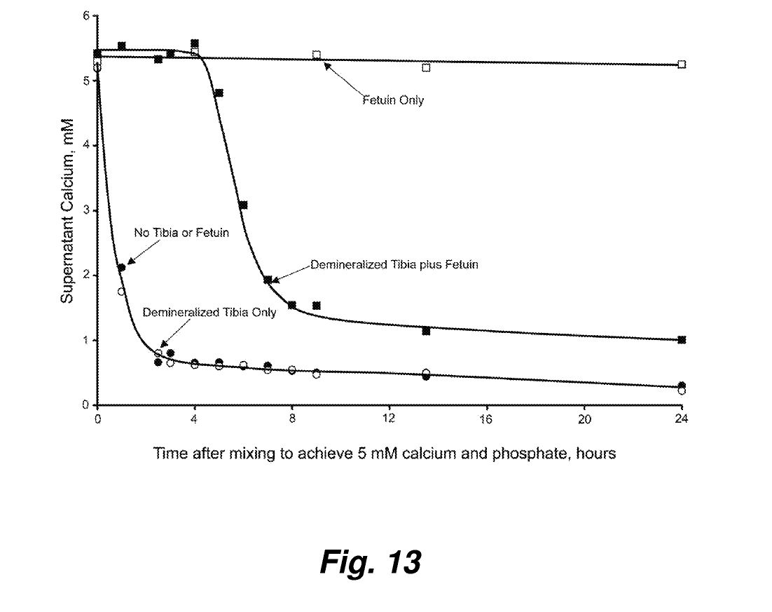

The rate of mineral formation was monitored by the decline in calcium remaining in solution. As seen in FIG. 13, there was no decrease in calcium in solutions containing fetuin but no tibia. This result is consistent with earlier studies (Price et al. (2004)J. Biol. Chem. 279(18): 19169-19180) and illustrates the ability of fetuin to potently inhibit mineral growth and precipitation. As also seen in FIG. 13, if both fetuin and a demineralized tibia are present there is a decrease in solution calcium that begins about 5 hours after addition of the tibia, and solution calcium is reduced by about 4 fold at 8 hours.

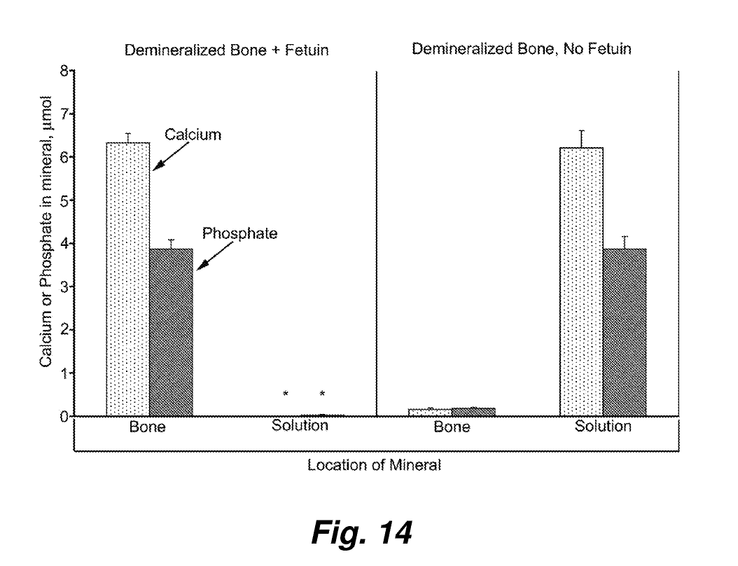

Chemical analysis showed that the amount of calcium and phosphate incorporated into the tibia at 24 h accounted for the decrease in solution calcium and phosphate, and there was no evidence for a calcium phosphate precipitate in the solution outside of the tibia (FIG. 14). The re-calcified tibias stained uniformly for calcification with Alizarin red, and von Kossa staining of tibia sections showed that calcification foci are found throughout the bone matrix (not shown).

These experiments were repeated using solutions of the same composition but lacking fetuin in order to confirm the role of fetuin in the re-calcification of demineralized tibias. In agreement with earlier studies (Price and Lim (2003)J. Biol. Chem. 278(24), 22144-22152), in the absence of fetuin a finely dispersed mineral precipitate formed within minutes of mixing to create 5 mM calcium and phosphate, and solution calcium levels fell 5 fold within 2 hours of mixing (FIG. 13). The presence of a demineralized tibia had no significant impact on the rate of calcium loss from solution in this experiment (FIG. 13).

After 24 hoursbincubation in the solution lacking fetuin, chemical analysis showed that most of the mineral present was in a precipitate in the solution outside of the tibia, not within the tibia (FIG. 14), and the tibia did not stain with Alizarin red or von Kossa (not shown).

These observations clearly show that the presence of fetuin in an unstable, supersaturated solution containing 5 mM calcium and phosphate determines the location of the calcium phosphate mineral growth: in the absence of fetuin, mineral growth occurs primarily in the solution outside bone collagen while in the presence of fetuin, mineral growth occurs almost exclusively within bone collagen.

Determination of the Amount of Mineral that can be Deposited in Bone Collagen by Using Fetuin to Selectively Inhibit Mineral Growth Outside the Collagen Fibril.

We next investigated the capacity of bone collagen to take up mineral using the fetuin re-calcification procedure. Ground bone was used for this test rather than a tibia in order to increase the ratio of matrix surface to volume and thereby enhance the diffusion of calcium, phosphate, or small crystals into collagen. The volume of the fetuin-containing re-calcification solution was increased to 50 ml so that calcium in the re-calcification solution (250 μmol) would exceed the calcium originally found in the bone matrix (114 μmol). Finally, some of the samples were subjected to as many as three consecutive re-calcification cycles, each in fresh 50 ml volumes of re-calcification solution.

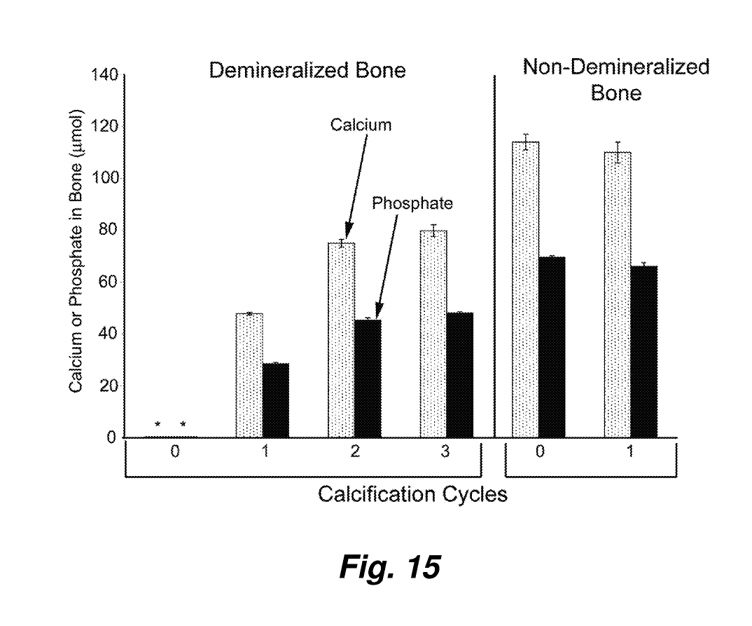

The first experiment examined the capacity of demineralized bone to take up mineral during three successive re-calcification cycles. As can be seen in FIG. 15, the greatest increase in mineral occurred in the first re-calcification cycle, and declined markedly by the third. At this point, the amount of calcium and phosphate introduced into demineralized bone was about 70% of that found in the adult bovine bone prior to demineralization.

The second experiment showed that a single re-calcification cycle does not significantly increase the mineral content of non-demineralized bone (FIG. 15). This observation shows that the incorporation of mineral into bone using this procedure requires prior demineralization.

Evidence that the Mineral in Re-Calcified Bone Collagen is Similar to Bone Mineral.

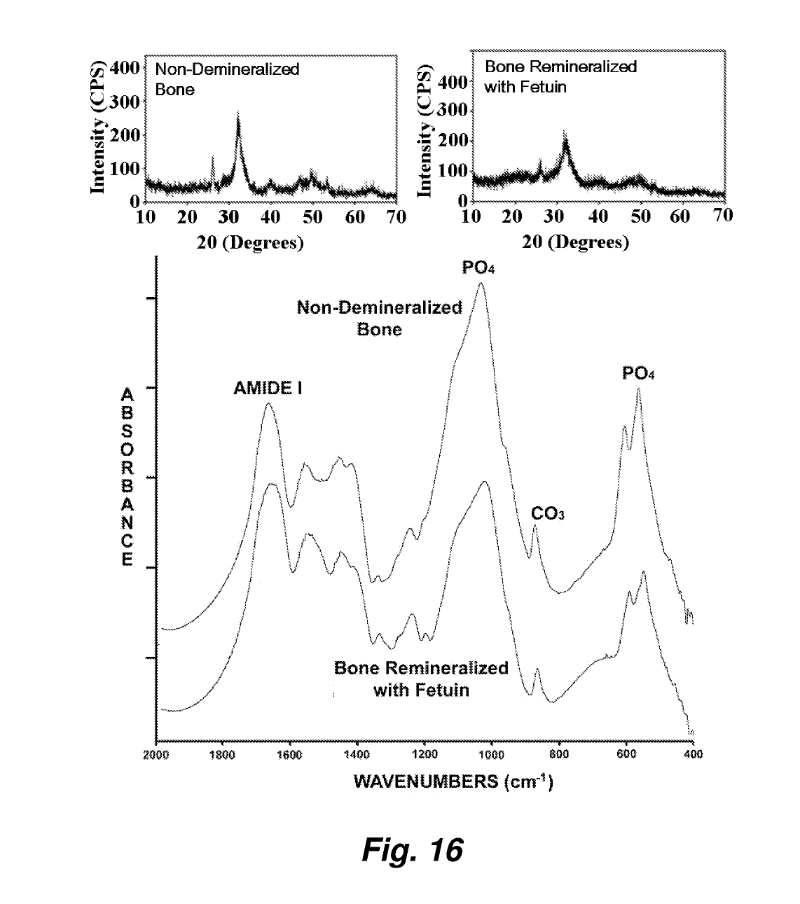

We used several methods to assess the nature of the calcium phosphate mineral incorporated into demineralized bone by this procedure. The results of these measurements revealed that the mineral in re-calcified bone is similar to the mineral found in bone prior to demineralization: 1. The molar calcium to phosphate ratios calculated from the data in FIG. 15 range from 1.68±0.03 for the first re-calcification cycle to 1.66±0.03 for the second and third cycles. These ratios are not significantly different from the ratios calculated from the FIG. 15 data for non-demineralized bone, 1.66±0.02 and 1.64±0.03. 2. The powder X-ray diffraction (XRD) spectrum obtained for demineralized bone after one re-calcification cycle is comparable to the spectrum obtained for bone prior to demineralization (FIG. 16) and the diffraction peaks seen in both spectra are in the positions expected for synthetic hydroxyapatite crystals (Hamlin and Price (2004) Calcif. Tiss. Internat. 75: 231-242). 3. The fourier transform infrared (FTIR) absorbance spectra obtained for demineralized bone after one re-calcification cycle is comparable to the spectrum obtained for bone prior to demineralization (FIG. 16). In the re-calcified bone, the peak heights obtained for mineral components (phosphate and carbonate) are reduced relative to those for protein components (Amide I and II); this observation is consistent with the fact that, after a single re-calcification cycle, the partially re-mineralized bone has only about 40% of the mineral content of non-demineralized bone (FIG. 15).

Further Characterization of the Role of Fetuin in Collagen Calcification.

In the above experiments we have consistently used a 5 mg/ml fetuin concentration to inhibit mineral growth in the solution outside the collagen fibril. This fetuin concentration is lower than that found in fetal bovine serum (20 mg/ml) (Brown et al. (1992) BioEssays 14: 749-755) and substantially higher than the mean serum fetuin level found in adult human serum (about 0.9 mg/ml)(Ix et al. (2008) J Bone Min Res 2008: Epub November 18; PMID: 19016589). Additional experiments were therefore carried out to determine the dependence of collagen calcification on fetuin concentration in this model system.

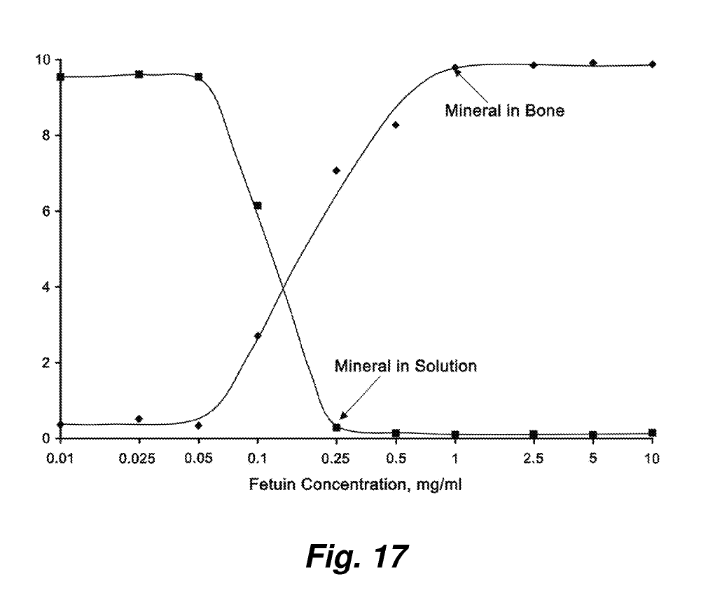

FIG. 17 shows that fetuin concentrations of 1 to 10 mg/ml are able to selectively calcify collagen in a solution that initially contains 5 mM calcium and phosphate, with no evidence for mineral deposition in the solution outside the collagen fibril. The location of mineral deposition shifts from the collagen fibril to the solution outside the fibril as fetuin concentrations are reduced below 1 mg/ml, with the cross over between 0.25 and 0.1 mg/ml fetuin.

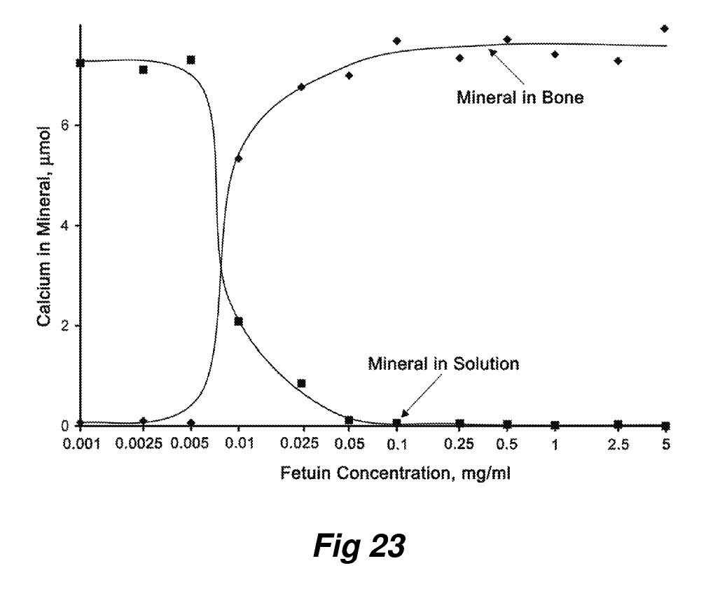

Since the dose of fetuin needed to selectively calcify collagen may depend on the rate of crystal formation, we carried out an additional experiment to determine the dose of fetuin required to calcify collagen when the concentrations of calcium and phosphate are reduced to 4 mM. As can be seen in FIG. 23, reducing the concentration of calcium and phosphate from 5 mM to 4 mM decreased the minimum amount of fetuin needed to achieve the selective calcification of collagen from 1 mg/ml to 0.1 mg/ml.

In all of the above experiments we have added the collagen matrix immediately after mixing to create the solution containing 5 mM calcium and phosphate. The prompt addition of collagen after mixing may not be necessary, since the data in FIG. 13 show that fetuin maintains a high concentration of calcium for at least 24 hours. To test this possibility, we examined the impact of delaying collagen addition on its calcification.

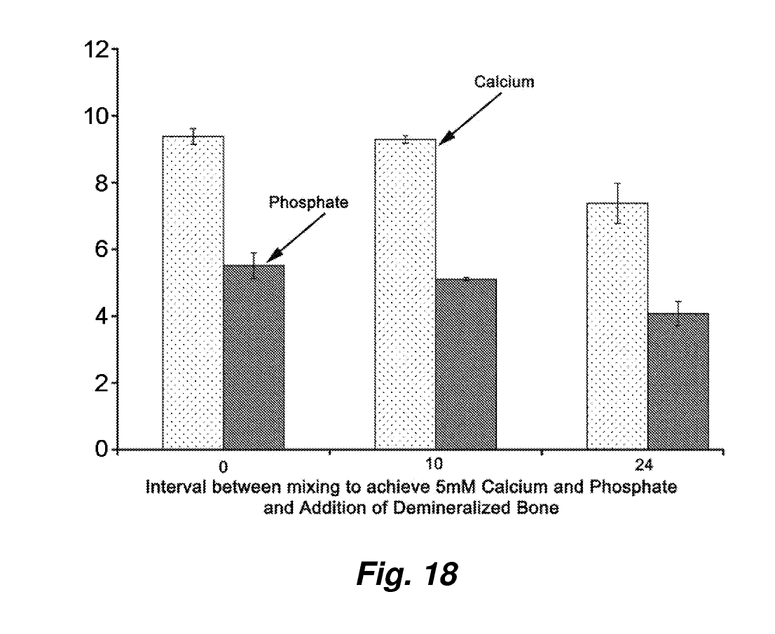

As shown in FIG. 18, collagen is still efficiently calcified even when it is added 10 hours after mixing to create the 5 mM calcium and phosphate. There is a significant reduction in calcium and phosphate incorporation when the collagen is added 24 hours after mixing (p<0.01; FIG. 18), and the total amount of mineral incorporated is reduced about 25%.

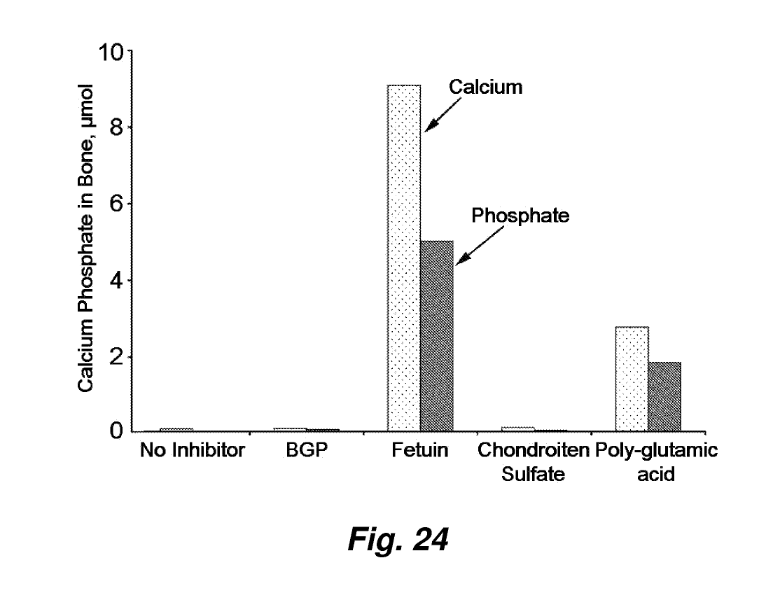

An experiment was carried out in order to determine whether other inhibitors of calcium phosphate mineral formation that are too large to penetrate the collagen fibril have a similar ability to selectively calcify collagen. As seen in FIG. 24, chondroitin sulfate (MW>100 kDa) is unable to drive the selective calcification of collagen, while poly-L-glutamic acid (MW>50 kDa) achieved about 25% of the calcification seen with the same concentration of fetuin. There was a mineral precipitate in the solution outside the collagen fibril with both chondroitin sulfate and poly-L-glutamate but not with fetuin (not shown), which indicates that failure of these inhibitors to selectively calcify collagen may be due to a reduced ability to retard mineral growth in the solution outside the collagen fibril.

We have previously hypothesized that calcification inhibitors that are small enough to penetrate the collagen fibril will prevent mineral growth inside the fibril, not selectively calcify the fibril (Toroian et al. (2007)J. Biol. Chem. 282: 22437-22447). We tested this hypothesis using bone Gla protein (BGP; osteocalcin), a 6 kDa inhibitor of apatite growth (Price et al. (1976) Proc. Natl. Acad. Sci. USA 73: 1447-1451) that is able to rapidly penetrate all of the water within the collagen fibril (Toroian et al. (2007)J. Biol. Chem. 282: 22437-22447). The results of this experiment show that BGP prevents mineral formation inside the collagen fibril (FIG. 24) and in the solution outside the fibril (not shown). The calcification of collagen in solutions containing fetuin is also prevented by BGP (not shown).

Tendon Collagen can be Calcified by Using Fetuin to Selectively Inhibit Mineral Growth Outside the Collagen Fibril.

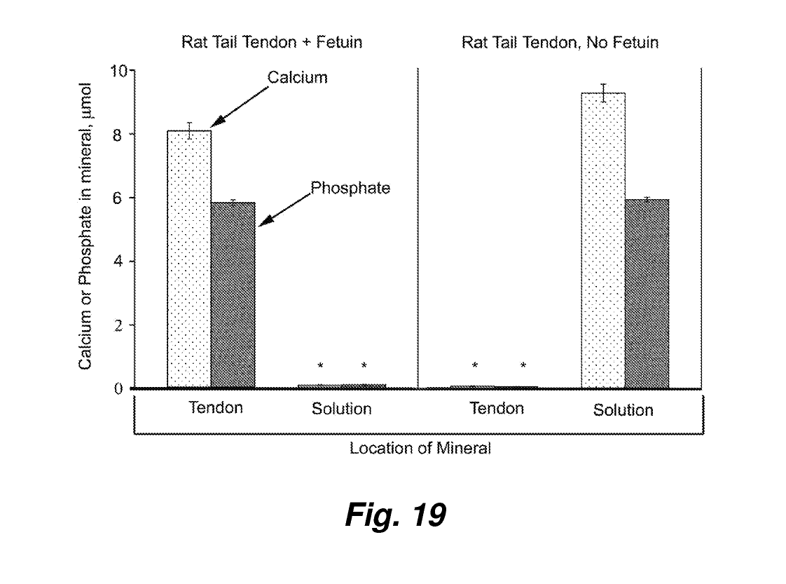

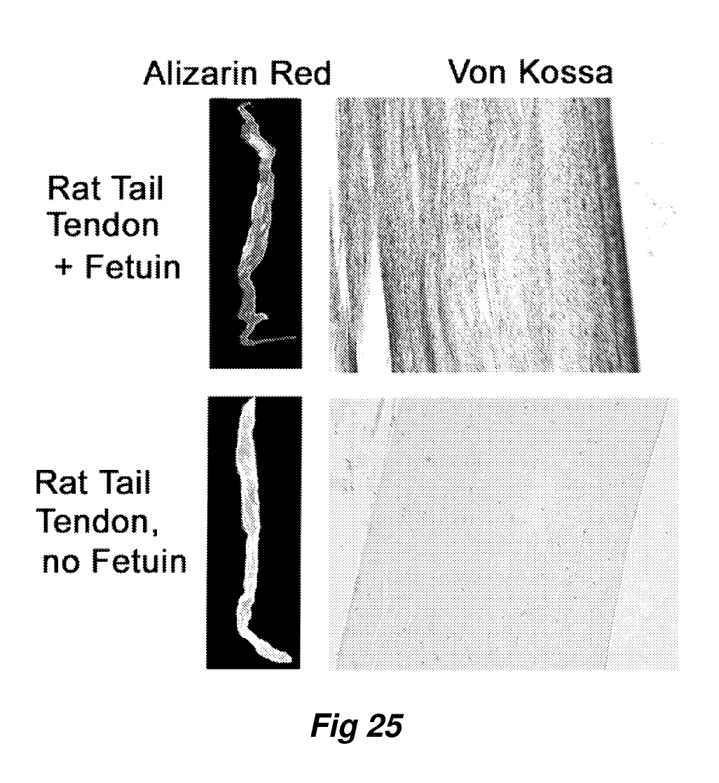

We next determined whether fetuin is also able to selectively favor calcification of the type I collagen fibrils of rat tail tendon, a tissue that does not normally calcify in vivo. Segments of tendon were added to calcification solutions identical to those used for the re-calcification of demineralized tibias, and tendon calcification was evaluated using the same procedures. There was again a decrease in solution calcium that began 5 hours after addition of the tendons, and solution calcium was reduced 4-fold by 8 hours (not shown). After 24 hours, chemical analysis showed that the amount of calcium and phosphate found within the tendons accounted for the decrease in solution calcium and phosphate, with no evidence for the precipitation of a calcium phosphate mineral in the solution outside the tendons (FIG. 19). The calcified tendons stained uniformly for calcification with Alizarin red, and von Kossa staining of tendon sections showed that the calcification consisted of numerous calcification foci scattered within the collagen matrix (FIG. 25).

These experiments were repeated using solutions of the same composition but lacking fetuin in order to confirm the essential role of fetuin in the calcification of tendon collagen. After 24 hours incubation, chemical analysis showed that all mineral was in a precipitate outside of the tendon collagen, not within the collagen (FIG. 19), and the tendons did not stain with Alizarin red or von Kossa (Supplemental FIG. 25).

Evidence that the Mineral in Calcified Tendon is Located within the Collagen Fibers.

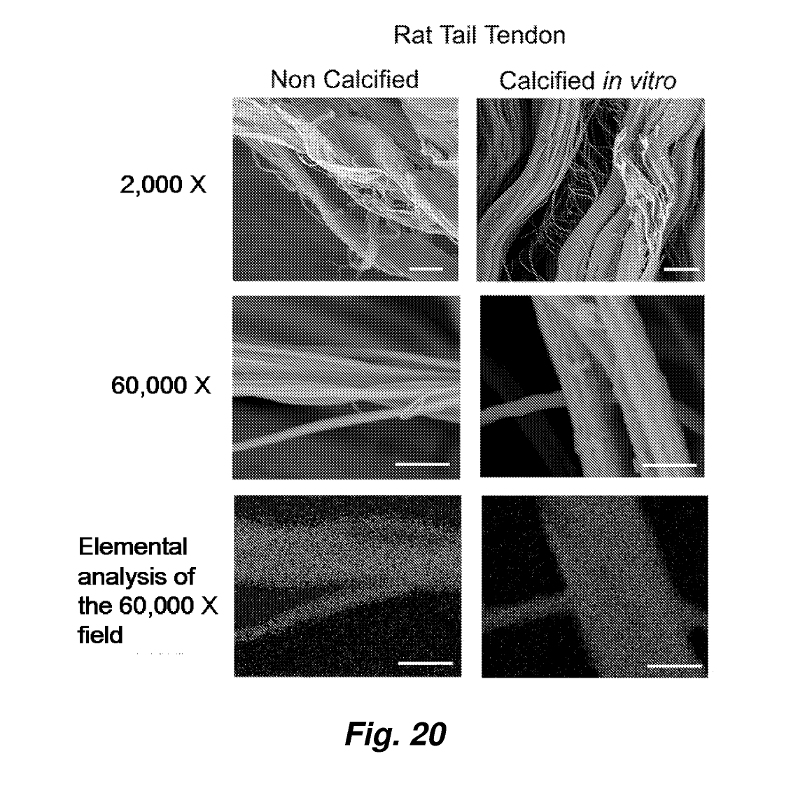

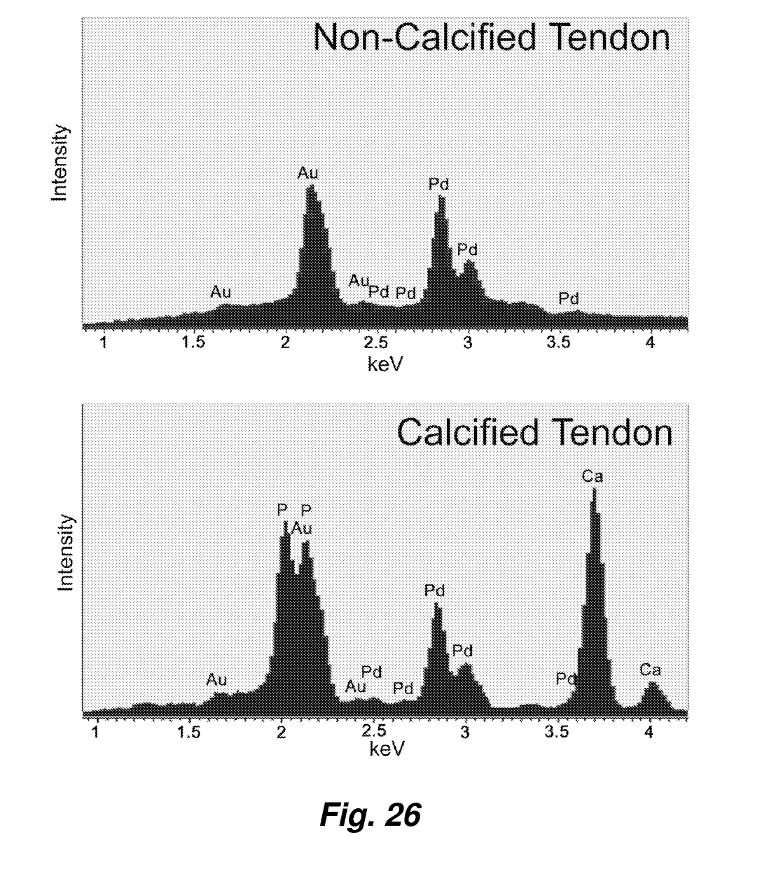

We used scanning electron microscopy to determine whether the mineral in tendon collagen that has been calcified by these procedures is indeed within collagen fibers. As seen in FIG. 20, the incorporation of mineral into tendon did not change the size of the collagen fibers, and there is no evidence for the precipitation of mineral on the fiber surfaces. Elemental analysis of calcified tendon (bottom panels of FIG. 8) demonstrated that calcium and phosphate co-localize with the collagen fibers. Electron Dispersive X-Ray (EDX) spectra confirm that calcified tendon collagen contains calcium and phosphate (FIG. 26).

Synthetic Matrices that have Size Exclusion Characteristics Similar to Type 1 Collagen can be Calcified by Using Fetuin to Selectively Inhibit Mineral Growth Outside the Matrix.

If the role of the type 1 collagen fibril in this calcification mechanism is merely to provide an aqueous compartment that excludes fetuin but not calcium and phosphate, then synthetic matrices that define an aqueous compartment with similar size exclusion characteristics should also calcify in solutions containing fetuin and 5 mM calcium and phosphate. Sephadex G25 was chosen for the first test, since the spherical beads of this gel filtration media contain an aqueous volume that excludes fetuin but not calcium and phosphate.

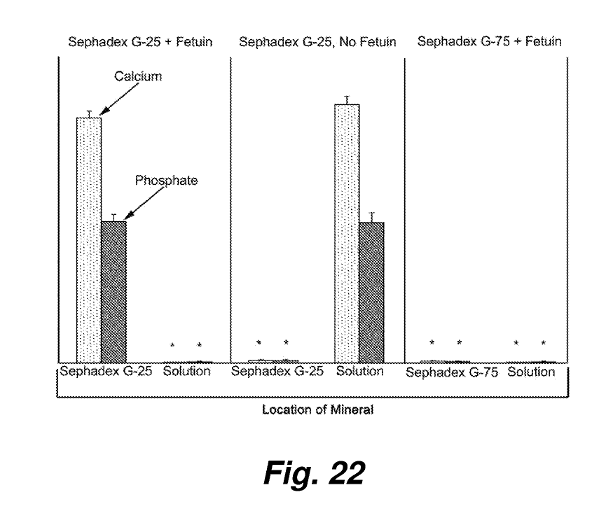

Sephadex G25 was added to calcification solutions identical to those used for the calcification of collagen matrices, and the calcification of Sephadex G25 was evaluated using the same procedures. The results of this experiment show that Sephadex G25 calcifies if fetuin is present: 1. There was a decrease in solution calcium that began 5 hours after addition of Sephadex G25, and solution calcium was reduced 5-fold by 8 hours (FIG. 9). 2. Chemical analysis showed that the amount of calcium and phosphate found within Sephadex G25 at 24 hours accounted for the decrease in solution calcium and phosphate, with no evidence for the precipitation of a calcium phosphate mineral in the solution outside the Sephadex G25 beads (FIG. 22). 3. Alizarin red staining showed that each bead had numerous mineral foci scattered uniformly throughout the interior of the gel particle (not shown). The results of this experiment also show that fetuin is required for Sephadex G25 calcification: In the absence of fetuin all mineral was in the solution outside of Sephadex G25, not within (FIG. 22), and the Sephadex G25 did not stain with Alizarin red (not shown).

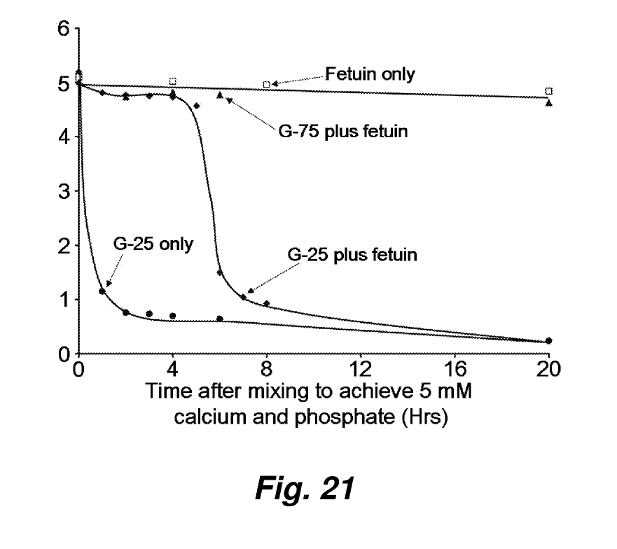

We carried out an additional experiment to directly test the hypothesis that fetuin must be excluded from the interior aqueous compartment of a matrix for the matrix to be calcified by these procedures. Sephadex G75 was used for this test, because the well-defined size exclusion characteristics of this matrix predict that fetuin should be able to freely penetrate the interior of the gel bead (a result confirmed here, see Experimental Procedures). The results of this experiment show that Sephadex G75 fails to calcify in the presence of fetuin: 1. There was no decrease in solution calcium over the 24-hour period of observation (FIG. 21). 2. Chemical analysis showed that there was no detectable mineral calcium and phosphate either within Sephadex G75 or in the solution outside of Sephadex (FIG. 22). 3. Alizarin red staining showed that none of the Sephadex G75 beads were calcified (not shown).

Essentially identical results were obtained when the above Sephadex experiments were repeated using polyacrylamide gels with different acrylamide concentrations (data not shown). Gels that excluded fetuin (such as 40% acrylamide gels) calcified in the pH 7.4 buffer containing 5 mM calcium and phosphate and 5 mg/ml fetuin, while gels that could not exclude fetuin (such as 4% acrylamide gels) were not calcified. If fetuin was omitted, the same amount of mineral again formed in solution and the gels were not calcified.

### Discussion

Our goal in the present experiments was to understand the role of fetuin in the calcification of type 1 collagen fibrils. To accomplish this goal, we developed a system in which crystal formation is driven by homogeneous nucleation at a high calcium phosphate ion product, and the only macromolecule in the solution is fetuin. This system allowed us to probe the impact of fetuin and only fetuin on the location and extent of collagen calcification. The results of these tests demonstrate that fetuin is all that is needed to determine the location of mineral growth: in the presence of fetuin mineral grows within the collagen fibril while in its absence mineral grows in the solution outside of collagen. The resulting calcification reaction is stunningly rapid and extensive: after incubation for just 8 hours the concentration of calcium in the tibia is over 2000-fold higher than the concentration of calcium remaining in solution.

Considering the chemical simplicity of this calcification mechanism, it is extraordinary that the initial, rapid phase of collagen calcification with fetuin achieves a total mineral content approximately 70% of that found in the original bone prior to demineralization after a total calcification interval of just 6 days at room temperature. This is comparable to the amount of mineral introduced into collagen during the primary phase of bone mineralization (Marotti et al. (1972)Calcif Tissue Res. 10: 67-81). It is also extraordinary that the mineral formed within the collagen has a comparable molar calcium to phosphate ratio, FTIR spectrum, and powder XRD spectrum as bone mineral. The same observations have been made using the chemically identical type 1 collagen fibrils of tendon: There is nothing about demineralized bone collagen that makes this matrix more ‘calcifiable’ than tendon collagen.

We also examined the role of the type 1 collagen fibril. We reasoned that, if the role of the type 1 collagen fibril in this calcification mechanism is merely to provide an aqueous compartment that excludes fetuin but not calcium and phosphate, than a synthetic matrix that contains an aqueous compartment with similar size exclusion characteristics should also be calcified in solutions containing fetuin and 5 mM calcium and phosphate.

The results of these tests show that synthetic matrices that exclude fetuin but not calcium and phosphate (e.g., Sephadex G25 beads) do calcify in solutions containing fetuin and 5 mM calcium and phosphate, while synthetic matrices that cannot exclude fetuin (e.g., Sephadex G75) do not calcify. These observations indicate that the role of the collagen fibril in this calcification is indeed to provide an aqueous compartment that excludes fetuin but not calcium and phosphate. Fetuin is able to direct calcification to the interior of any matrix with size exclusion characteristics similar to collagen by selectively inhibiting mineral growth outside of that matrix.

We have previously suggested that calcification inhibitors that are small enough to penetrate the collagen fibril will prevent mineral growth inside the fibril, not selectively calcify the fibril (Toroian et al. (2007)J. Biol. Chem. 282: 22437-22447). We have tested this hypothesis using BGP, a 6 kDa inhibitor of apatite growth (32) that is able to rapidly penetrate all of the water within the collagen fibril (Id.). The results of these experiments show that BGP prevents mineral formation inside the collagen fibril, and does not selectively calcify the fibril. We have also tested this hypothesis using matrix Gla protein (MGP), a potent mineralization inhibitor that is also small enough to penetrate the fibril (Id.). This test shows that just 20 μg MGP/ml is sufficient to prevent the fetuin-dependent calcification of collagen (Villa and Price, personal observations). These in vitro experiments may explain why the over expression of MGP in bone inhibits collagen calcification in vivo (Murshed et al. (2004) J. Cell. Biol. 165(5): 625-630), and does not promote it.

The Synthesis of New Mineralized Collagenous Materials by Using Fetuin to Selectively Inhibit Mineral Growth Outside Collagen.

The ability to replace the mineral phase of bone using only fetuin, calcium, and phosphate could have several applications in the bone and dental implant field. The mineral in bone could be replaced with a less soluble mineral phase, such as fluorapatite, in order to prolong implant life. Alternatively, agents that promote bone growth, such as strontium, could be incorporated into bone during re-calcification in order to stimulate local bone formation.

The ability to calcify purified type 1 collagen could also have uses. Metallic, plastic, and other non-collagenous devices could be coated with collagen, and the collagen coating could then be calcified by these procedures. This could enhance bonding of the device to bone and thereby increase the lifetime of the implant.

Mineralization by Inhibitor Exclusion: a Novel Method for the Creation of New Crystalline Materials.

It is possible that the principles of matrix mineralization described here are general, and that it may prove feasible to place crystals other than apatite into matrices other than collagen using crystal growth inhibitors other than fetuin. Our experiments indicate that only requirements are a macromolecular crystal growth inhibitor in a solution that would, in the absence of the inhibitor, spontaneously form the crystalline phase, and a matrix that excludes the inhibitor but allows the constituents of the crystal to enter the matrix. The liquid need not be water, the temperature need not be ambient, and the pressure need not be 1 atmosphere. Crystal formation can be directed into spaces defined at the nanometer scale, as shown by the efficient calcification of the 40 nm diameter fibrils of bone collagen, and in spaces pre-determined by the location of the matrix ‘mold’ into which the crystals are deposited. We suggest that this novel procedure for the formation of new crystal-matrix composites be termed ‘mineralization by inhibitor exclusion.’

Although derived from the study of biological systems, the principles of mineralization by inhibitor exclusion discovered here can form the basis for the fabrication of useful materials that have no direct relationship to biology.

### Summary and Perspective:

In the present study, we have used a solution in which mineral forms rapidly due to the high concentration of calcium and phosphate in order to test the hypothesis that fetuin, a macromolecular inhibitor of apatite growth, favors mineralization of the collagen fibril by selectively inhibiting crystal growth in the solution outside of the fibril. In this simplified model system, we demonstrate that fetuin is both necessary and sufficient for calcification of the type 1 collagen fibril.

We term this new calcification mechanism ‘mineralization by inhibitor exclusion’: the selective calcification of the type 1 collagen fibril using a macromolecular inhibitor of mineral growth that is excluded from the fibril. This is the first molecular mechanism of collagen calcification to be demonstrated in vitro and future studies will be needed in order to understand the possible relevance of this mechanism to normal bone mineralization. These include: studies to determine whether the first crystals are deposited in the hole region of the collagen fibril, as is the case in normal collagen calcification (Landis et al. (1996) Microsc. Res. and Technique 33: 192-202); investigations to compare the mechanical strength of bone that has been re-calcified by these procedures to that of normal bone; and experiments to determine whether the mineral initially deposited within the collagen fibril by the present mechanism eventually grows into the region between fibrils, resulting in the interfibrillar mineral that has been observed in normal collagen calcification (Nikolov and Raabe (2008) Biophysical J. 94: 4220-4232; Siperko and Landis (2001) J. Structural Biology 135: 313-320).

Fetuin is a serum protein that is made by liver, not bone (Mizuno et al. (1991) Bone and Mineral 13: 1-21; Wendel et al. (1993) Matrix 13: 331-339). If fetuin indeed promotes bone mineralization by the ‘mineralization by inhibitor exclusion’ mechanism, it seems likely that the activity of fetuin in bone mineralization is proportional to its serum concentration. It is therefore of interest to note the two observations that support a link between elevated serum fetuin and increased bone mineralization:

1. Serum fetuin levels are typically higher in early fetal life than in the adult; for example, fetuin levels are about 20 mg/ml in fetal calves (gestational age 90 d), 10 mg/ml at birth (gestational age 280 d), and 1 mg/ml in adult cows (Toroian and Price (2008) Calcified Tiss. Internat. 82: 116-126; Brown et al. (1992) BioEssays 14: 749-755). These developmental differences in serum fetuin may reflect the need to support a higher rate of bone mineralization in the fetus, since our present study shows that acceleration of mineral formation in vitro increases the amount of fetuin needed to support collagen calcification (FIG. 17 and FIG. 23).

2. We have recently shown that higher serum fetuin levels are significantly associated with higher total hip, lumbar spine, and whole body bone mineral density (BMD) among well-functioning community dwelling older women (Ix et al. (2008) J Bone Min Res 2008: Epub November 18; PMID: 19016589). For example, each standard deviation (0.38 mg/ml) higher level of fetuin above the 0.93 mg/ml mean is associated with 0.016 g/cm² higher total hip areal BMD. These observations areconsistent with our in vitro evidence that higher fetuin levels drive increased collagen calcification regardless of whether apatite crystals are generated by the serum nucleator (Toroian and Price (2008) Calcified Tiss. Internat. 82: 116-126) or by homogeneous nucleation at high calcium and phosphate (FIG. 17).

It is important to emphasize that the calcification of collagen that occurs during normal bone formation is a far more complex process than the simple model system described here, and that there is as yet no direct, in vivo evidence that large inhibitors of apatite crystal growth such as fetuin actually play a role in collagen calcification by selectively inhibiting crystal growth in the solution outside of the fibril. The major value of model systems such as the one described here is not to prove how collagen calcifies in bone, but to identify the mechanisms of collagen fibril calcification and so stimulate experiments that test these mechanisms in mineralizing bone.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A method of forming a crystalline phase within a defined liquid volume, said method comprising: combining a crystallization inhibitor; a solution that would, in the absence of the inhibitor, form the crystalline phase; and a semi-permeable barrier that excludes the inhibitor but allows the solution containing the constituents of the crystalline phase to enter, whereby a crystalline phase is formed within said liquid volume.

2. The method of claim 1, wherein said solution is an aqueous solution.

3. The method of claim 1, wherein said solution is a non-aqueous solution.

4. The method of claim 1, wherein said solution is supersaturated with respect to the constituents of the crystalline phase.

5. The method of claim 1, wherein the formation of the crystalline phase occurs spontaneously in the solution.

6. The method of claim 1, wherein the formation of the crystalline phase occurs because the solution contains a catalyst of crystal formation (a ‘nucleator’).

7. The method of claim 1, wherein the defined volume is a volume of said solution that lies within a semi-permeable matrix.

8. The method of claim 1, wherein the semi-permeable matrix comprises a material selected from the group consisting of a gel, a hydrogel, a fiber, a collection of particles, a fluidized bed of particles, a porous ceramic.

9-13. (canceled)

14. The method of claim 1, wherein the defined volume is a volume of said solution that lies within a semi-permeable membrane sack.

15. The method of claim 1, wherein said semi-permeable barrier excludes said crystallization inhibitor based on the size of the inhibitor.

16. The method of claim 1, wherein said crystalline phase is a conductor or semiconductor.

17-18. (canceled)

19. The method of claim 1, wherein said crystalline phase contains calcium and phosphate.

20. The method of claim 1, wherein said crystalline phase is an apatite.

21. The method of claim 1, wherein said inhibitor prevents crystal growth by forming a complex with crystals of the final crystal phase and/or by binding to precursors of the final crystal phase.

22. (canceled)

23. A method of mineralizing a matrix, said method comprising:
providing a modified matrix material comprising an interior aqueous compartment accessible to molecules of a size less than about 6 kDa and substantially inaccessible to molecules of a size greater than about 40 kDa;
contacting said matrix material with a solution that generates mineral crystals, where said solution also comprises an inhibitor of the growth of crystals in said solution, wherein said inhibitor is of a size that is substantially excluded from the interior aqueous compartment of said matrix material;
whereby crystals within said compartment grow resulting in the mineralization of said matrix material, while crystals outside said compartment are substantially inhibited from growth and crystal formation.

24. The method of claim 23, wherein said matrix material comprises one or more materials selected from the group consisting of type I collagen, type II collagen, synthetic collagen, and collagen containing poloxamine hydrogel.

25-31. (canceled)

32. The method of claim 23, wherein the formation of said crystal nuclei occurs spontaneously in said solution.

33. The method of claim 23, wherein said solution comprises a catalyst of crystal formation (a ‘nucleator’).

34. The method of claim 23, wherein said solution comprises serum.

35. The method of claim 23, wherein said solution comprises a high concentration of a mineral.

36. The method of claim 23, wherein said solution comprises mineral crystals that are small enough to penetrate into the interior of the matrix.

37. The method of claim 36, wherein said crystals are less than about 6,000 daltons in size.

38. The method of claim 23, wherein said solution comprises an apatite.

39. The method of claim 23, wherein said solution comprises calcium and said mineralizing comprises calcifying said matrix.

40. The method of claim 23, wherein said mineralizing comprises forming an apatite in said matrix.

41. (canceled)

42. The method of claim 23, wherein said inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, a matrix-GLA protein analogue, poly glutamic acid, and poly aspartic acid.

43. A method of preparing a bone graft, said method comprising
forming a template in the desired shape of said graft from a matrix material, wherein said matrix material comprises an interior aqueous compartment accessible to molecules of a size less than about 6 kDa and substantially inaccessible to molecules of a size greater than about 40 kDa;
contacting said template with a solution that generates mineral crystals, where said solution also comprises an inhibitor of the growth of crystals in said solution, wherein said inhibitor is of a size that is substantially excluded from said interior aqueous compartment;
whereby crystals within said compartment grow resulting in the mineralization of said template thereby forming a mineralized graft structure, while crystals outside said compartment are substantially inhibited from growth and crystal formation.

44. The method of claim 43, wherein said matrix material comprises type I collagen, type II collagen, synthetic collagen, and/or collagen-containing poloxamine hydrogel.

45-53. (canceled)

54. The method of claim 43, wherein said solution comprises serum.

55-57. (canceled)

58. The method of claim 43, wherein said solution comprises calcium and/or an apatite.

59-61. (canceled)

62. The method of claim 43, wherein said inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, and a matrix-GLA protein analogue.

63. A method of modifying a surface, said method comprising:
adsorbing or covalently linking a matrix material to said surface, wherein said matrix material comprises an interior aqueous compartment accessible to molecules of a size less than about 6 kDa and substantially inaccessible to molecules of a size greater than about 40 kDa;
contacting said matrix material with a solution that generates mineral crystals, where said solution also comprises an inhibitor of the growth of crystals in said solution, wherein said inhibitor is of a size that is substantially excluded from the interior aqueous compartment of said matrix material;
whereby crystals within said compartment grow resulting in the mineralization of said matrix material and the formation of a mineralized layer on said surface, while crystals outside said compartment are substantially inhibited from growth and crystal formation.

64. The method of claim 63, wherein said surface is a surface of component selected from the group consisting of a dental implant, a bond screw or pin, a bone fixation member, and an artificial joint implant.

65-67. (canceled)

68. The method of claim 63, wherein said matrix material comprises one or more materials selected from the group consisting of type I collagen, type II collagen, synthetic collagen, and collagen containing polaxamine hydrogel.

69-77. (canceled)

78. The method of claim 63, wherein said solution comprises serum.

79-85. (canceled)

86. The method of claim 63, wherein said inhibitor is selected from the group consisting of fetuin, a fetuin fragment or analogue, osteopontin, an osteopontin fragment or analogue, Tamm-Horsfall protein, Tam-Horsfall protein fragment or analogue, asprich mollusk shell protein, asprich mollusk shell protein or analogue, matrix-GLA protein, and a matrix-GLA protein analogue.

87. A method of forming a nanoscale structure, said method comprising:
forming a nanoscale feature from a matrix material, wherein said matrix material comprises an interior aqueous compartment accessible to small molecules and crystals, but substantially inaccessible to a larger crystallization inhibitor;
contacting said matrix material with a solution that generates mineral crystals, where said solution also comprises an inhibitor of the growth of crystals in said solution, wherein said inhibitor is of a size that is substantially excluded from the interior aqueous compartment of said matrix material;
whereby crystals within said compartment grow resulting in the mineralization of said matrix material and the formation of a mineralized nanostructure, while crystals outside said compartment are substantially inhibited from growth and crystal formation.

88-89. (canceled)

90. The method of claim 87, wherein said nanoscale structure comprises a structure selected from the group consisting of a nanowire, a nanocage, a nanocomposite, a nanofiber, a nanofoam, a nanomesh, a nanopillar, a nanopin, a nanoring, a nanorod, a nanoshell, a nanoceramic, and a quantum dot.

91-112. (canceled)

113. A kit for the controlled mineralization of a matrix, said kit comprising:
a container containing a matrix material;
a container containing a crystal growth solution wherein said crystal growth solution contains a crystal growth inhibitor or said kit comprises another container containing a crystal growth inhibitor.

114-132. (canceled)
